(19) United States
(12) Patent Application Publication
(10) Pub. No.: US 2004/0114913 A1
(43) Pub. Date: Jun. 17, 2004

(54) Optical recording an or reproducing apparatus optical reproducing apparatus optical recording and or reproducing medium optical recording and or reproducing method optical recording method optical reproducing method and optical layer detection method

(76) Inventor: Hidehiro Kume, Tokyo (JP)

Correspondence Address: David R Metzger, Sonnenschein Nath & Rosenthal, Wacker Drive Station, PO Box 061080, Chicago, IL, 60606-1080, US

(21) Appl. No.: 10/471,913

(22) PCT Filed: Mar. 14, 2002
(86) PCT No.: PCT/JP02/02438

(30) Foreign Application Priority Data
Mar. 14, 2001 (JP) 2001-71669
Jul. 31, 2001 (JP) 2001-231366
Jul. 31, 2001 (JP) 2001-231375
Jul. 31, 2001 (JP) 2001-231354
Nov. 30, 2001 (JP) 2001-367409
Nov. 30, 2001 (JP) 2001-367447
Mar. 11, 2002 (JP) 2002-65152

(51) Int. Cl. H04N 5/781

(52) U.S. Cl. 386/125; 386/126

(57) ABSTRACT

Signals are recorded as residual polarization in a recording and/or reproducing member, exhibiting ferroelectricity, and the difference in phase, dependent on the direction of residual polarization, of optical harmonics generated on illumination of a reproducing light beam, is detected by phase comparison with optical harmonics generated in a uniformly polarized reference member arranged in an optical path other than the optical path of the recording and/or reproducing member. Since the disclosed technique can use a conventional optical recording and/or reproducing technique, the disclosed technique is high in valuability as a multi-layered medium. The optical recording and/or reproducing layer can be readily implemented as a multi-layer structure to increase the recording capacity appreciably.

### TECHNICAL FIELD

This invention relates to, for example, an optical recording and/or reproducing apparatus, optical reproducing apparatus, an optical recording and/or reproducing medium, an optical recording and/or reproducing method, an optical recording method, an optical reproducing method and to an optical layer detection method.

### BACKGROUND ART

In meeting with the recent information-oriented society, attempts are being made to increase the capacity of the optical recording and/or reproducing medium relevant to optical recording and/or reproduction.

For increasing the capacity of the optical recording and/or reproducing medium, there is a technique of stacking plural optical recording and/or reproducing layers to provide a multi-layered optical recording and/or reproducing medium. By stacking the plural optical recording and/or reproducing layers, it is possible to increase the recording capacity of the optical recording and/or reproducing medium without increasing the recording capacity of each optical recording and/or reproducing layer.

For example, such a method has been proposed in which plural medium layers are realized by layering a non-linear optical material, such as a ferroelectric substance having a high ratio of transmission (transmittance) at a wavelength of a light source used, for use as a medium, and by detecting an optical non-linear phenomenon, demonstrated in an optional medium by a converging light beam.

### DISCLOSURE OF THE INVENTION

There is an ever-increasing demand for increasing the recording capacity of an optical recording and/or reproducing medium. Since the various conventional systems suffer from problems involved in forming plural layers of the optical recording and/or reproducing layers, it has been desired to develop a new technology which enables the recording capacity to be increased.

In view of the above-depicted status of the art, it is an object of the present invention to provide an optical recording and/or reproducing apparatus, an optical reproducing apparatus, an optical recording and/or reproducing medium, an optical recording and/or reproducing method, an optical recording method, an optical reproducing method and an optical layer detection method, whereby it is possible to accomplish multiple optical recording and/or reproducing layers to thereby increase the recording capacity drastically.

The present inventors have devised a technique in which optical harmonics generated on illuminating a reproducing light beam on signals recorded as residual polarization on a ferroelectric recording and/or reproducing member exhibit phase difference in dependence upon the direction of the residual polarization and in which this phase difference is detected by phase comparison with the optical harmonics generated in a uniformly polarized reference member arranged in an optical path other than the optical path of the recording and/or reproducing member. Since this technique is able to use a conventional optical recording and/or reproducing technique, the disclosed technique is high in valuability as a multi-layered medium. The optical recording and/or reproducing layer can be readily implemented as a multi-layer structure to increase the recording capacity appreciably.

(1) An optical recording and/or reproducing apparatus in one aspect of the present invention includes a stage for setting thereon an optical recording and/or reproducing medium, in which the optical recording and/or reproducing medium includes a layer of an electro-optical material in which the polarization can be changed in its direction and remnant on application of an electrical field and which generates optical harmonics on irradiation with light, and electrode layers arranged on front and back surfaces of the layer of the electro-optical material, a light source for illuminating light on the optical recording and/or reproducing medium set on the stage, voltage applying means for applying the voltage across the electrode layers of the optical recording and/or reproducing medium set on the stage, and detection means for detecting the phase of the optical harmonics generated from the optical recording and/or reproducing medium as set on the stage.

By applying a voltage to the layer of the electro-optical material and by causing the polarization to be left by controlling the direction of polarization, the information can be recorded on the optical information recording and/or reproducing medium. On the other hand, optical harmonics are generated on illumination of light on the layer of the electro-optical material, with the phase of the generated optical harmonics being changed depending on the direction of polarization. Thus, by detecting phase changes, it is possible to reproduce the information recorded on the optical recording and/or reproducing medium.

The optical recording and/or reproducing apparatus may also include means for outputting reference light, which interferes with the optical harmonics generated from the optical recording and/or reproducing medium, so that the reference light will be superposed on the optical harmonics. The detection means detects the intensity of the optical harmonics superposed on the reference light to detect the phase of the optical harmonics.

By the optical harmonics, generated by the optical recording and/or reproducing medium, interfering with the reference light, the phase of the optical harmonics can be converted into the higher or lower values of the light intensity.

The intensity of the reference light may be substantially equal to the intensity of the optical harmonics generated from the optical recording and/or reproducing medium.

The higher or lower values of the light intensity as converted may be of locally maximum or locally minimum values.

The optical recording and/or reproducing medium is made up by at least two layer sets each comprised of the layer of the electro-optical material and the electrode layers.

By stacking plural layers of the electro-optical material, each capable of recording the information, the quantity of the information that can be stored may be increased.

The detection means in the optical recording and/or reproducing apparatus outputs an intensity signal corresponding to the intensity of the harmonics generated from the optical recording and/or reproducing medium as set on the stage, in which the apparatus further includes voltage controlling means for controlling the output voltage of the voltage applying means based on the intensity signals output by the intensity detection means.

Since the illuminated light (light of excitation) and the optical harmonics differ in wavelength from each other, it is customary that the refractive index, that is the phase velocity, in the optical material differs from each other (wavelength dispersion of the refractive index). Due to this difference in phase velocity, the phase difference of two harmonics generated at different places from the light of excitation traveling on an optical path becomes larger with an increasing distance from the sites of generation, such that, at a distance greater than the so-called coherence length, phase inversion occurs, as a result of which the two harmonics cancel each other. Thus, in an optical recording and/or reproducing apparatus exploiting harmonics, it is felt to be necessary to accomplish phase matching to prohibit the harmonics from cancelling each other. In addition, the refractive index of the medium (optical material) is changed with both the wavelength and the temperature. Consequently, it may be effective to stabilize the wavelength of the light of excitation and the medium temperature to maintain the state of phase matching. However, if a mechanism of stabilizing the wavelength and the temperature is to be annexed to the optical recording and/or reproducing apparatus, the apparatus may be bulky in size or expensive. The present invention provides for simplified phase matching of harmonics. That is, by controlling the electrical field applied to the layer of the electro-optical material, based on the aforementioned intensity signal output by the intensity detection means, the refractive index of the layer of the electro-optical material is changed, as a result of which the refractive index of the fundamental wave radiated by the light source can be brought into coincidence with the refractive indexes of the harmonics generated by the layer of the electro-optical material to maintain phase matched state.

Here, the incident light from the light source to the optical recording and/or reproducing medium may be inclined relative to the direction of a normal line drawn to the planar surface of the optical recording and/or reproducing medium.

Here, birefringence may be afforded to the layer of the electro-optical material by applying an electrical field thereto (the layer of the electro-optical material may exhibit birefringence). The light propagated through the inside of a birefringent material is separated into ordinary light and extraordinary light. Since the refractive index in the extraordinary light is varied with the direction of propagation, phase matching can be accomplished by suitably tilting the incident light on the optical recording and/or reproducing medium relative to a normal line drawn to the planar surface of the optical recording and/or reproducing medium.

The layer of the electro-optical material may exhibit ferroelectricity in which the direction of polarization is changed on application of a preset electrical field.

The changes in the direction of polarization of the layer of the electrochemical material can be exploited to record the information on the optical recording and/or reproducing medium.

The voltage controlling means may control the output voltage of the voltage applying means so that the intensity of the harmonics associated with the intensity signal output from the detection means will be larger than a preset value.

Stable information reproduction becomes possible by having the intensity of the harmonics larger than the preset value.

The optical recording and/or reproducing medium may include plural layers of an electrochemical material and plural electrodes sandwiched between the plural layers of the electro-chemical material.

By employing the plural layers of the electrochemical material, it is possible to increase the quantity of the recordable information.

The optical recording and/or reproducing medium of the optical recording and/or reproducing apparatus according to the present invention includes a plurality of layers of the electro-optical material, each layer of the electro-optical material being formed of a ferroelectric non-linear optical material generating optical harmonics on incidence thereon of the light of excitation and being of a thickness not larger than the coherence length beyond which phase inversion of the optical harmonics occurs by the difference between the refractive index of the light of excitation and the refractive index of the optical harmonics. The electrode layers of the optical recording and/or reproducing medium are arranged between the plural layers of the electro-optical material. The voltage applying means applies an electrical field, alternately inverted in direction, to the layers of the electro-optical material of the optical recording and/or reproducing medium set on the stage.

Since the illuminated light (light of excitation) and the optical harmonics differ in wavelength from each other, it is customary that the refractive index, that is the phase velocity, in the optical material, differs from each other (wavelength dispersion of the refractive index). Due to this difference in phase velocity, the phase difference of two harmonics generated at different places from the light of excitation traveling on an optical path becomes larger with increasing distance from the sites of generation. Thus, in an optical recording and/or reproducing apparatus exploiting harmonics, it is felt to be necessary to achieve phase matching to prohibit the harmonics from cancelling each other. The present invention, exploiting the technique of optical harmonics, renders it possible to achieve sufficient harmonics intensity. That is, by applying the voltage to the electrodes, the direction of polarization of the respective layers of the ferroelectric non-linear optical material can be controlled to record the information. Since the thickness of the layers of the ferroelectric non-linear optical material is less than the coherence length, there is no fear that the optical harmonics, generated in the inside of the respective layers of the ferroelectric non-linear optical material, weaken one another, so that optical harmonics can be generated efficiently from the respective layers of the ferroelectric non-linear optical material to accomplish information reproduction.

Here, the optical recording and/or reproducing apparatus may further include reference light generating means for generating the reference light interfering with the optical harmonics from the light illuminated from the light source, light mixing means for mixing the optical harmonics generated from the optical recording and/or reproducing medium and the reference light to output interference light resulting from interference between the optical harmonics and the reference light, and detection means for detecting the intensity of the interference light output from the mixing means.

By detecting the intensity of the interference light, generated on mixing the reproducing optical harmonics, generated from the optical recording and/or reproducing medium, with the optical harmonics for reference, the information can be reproduced from the optical recording and/or reproducing medium.

The ‘means for generating optical harmonics for reference’ may be provided on an optical path from the light source to the optical recording and/or reproducing medium, or may be provided on a branched optical path of the light illuminated by the light source. If the ‘means for generating optical harmonics for reference’ is provided on the optical path from the light source to the optical recording and/or reproducing medium, such optical path itself operates as ‘light mixing means’.

The optical recording and/or reproducing medium of the optical recording and/or reproducing apparatus according to the present invention includes a plurality of layers of the electro-optical material, in which the layers of the electro-optical material are changed in refractive index on application of an electrical field, and in which the voltage applying means applies an electrical field to an optional one of the layers of the electro-optical material of the optical recording and/or reproducing medium as set on the stage. The apparatus further includes layer detection means for detecting the layer of the electro-optical material the refractive index of which has been changed by the application of the electrical field by the voltage applying means.

In accomplishing optical recording and/or reproduction by a multi-layered recording and/or reproducing medium, it is necessary to discriminate the optical recording and/or reproducing layer relevant to recording or reproduction. For example, in the case of a DVD having two recording and/or reproducing layers, transmittance is distributed to the respective recording and/or reproducing layers to permit light reflection from the respective recording and/or reproducing layers. As a result, so-called focussing error signals are enabled to be generated, based on the reflected light, from one recording and/or reproducing layer to the next, to discriminate the respective recording and/or reproducing layers. However, with this method of distributing the transmittance, if the number of the recording and/or reproducing layers to be stacked is increased, the intensity of light reaching the lower layer is decreased. Moreover, there is raised an inconvenience due to reciprocal light interference between neighboring recording and/or reproducing layers. The result is that limitations are imposed on increasing the number of the recording and/or reproducing layers.

The present invention enables facilitated discrimination of the recording and/or reproducing layers in the optical recording and/or reproducing medium having plural recording and/or reproducing layers.

By applying an electrical field to the layer of the electro-optical material to change the refractive indexes thereof, and by detecting the layer of the electro-optical material, the refractive index of which has been changed, it becomes possible to discriminate the plural layers of the electro-optical material.

Here, the optical recording and/or reproducing medium may be provided with electrode layers arranged between adjacent ones of the plural layers of the electro-optical material, and are of substantially equal refractive index as that of the layers of the electro-optical material at a wavelength of light illuminated from the light source.

By changing the refractive index of each of the layers of the electro-optical material by the application of an electrical field thereto, the refractive index between the layers of the electro-optical material and the electrode may be differentiated to cause the reflection at the boundary layers. This reflected light at the boundary may be detected to detect the layer of the electro-optical material.

Meanwhile, the optical recording and/or reproducing medium may be provided with paired electrodes arranged between adjacent ones of the plural layers of the electro-optical material and which are of substantially equal refractive index as that of the layers of the electro-optical material at a wavelength of light illuminated from the light source, and an intermediate layer arranged between the paired electrodes and being of the refractive index substantially equal to the refractive index of the layers of the electro-optical material at a wavelength of the light illuminated from the light source.

By applying an electrical field to change the refractive index values of the respective layers of the electro-chemical material, boundary reflection may be produced to permit detection of the layers of the electro-optical material. By further providing the intermediate layer, the distance between the layers of the electro-optical material may be increased, so that, if the layers of the electro-optical material are of a reduced thickness, the respective layers of the electro-optical material may be discriminated extremely readily.

The optical recording and/or reproducing apparatus may further be provided with polarization means for polarizing the light incident on the optical recording and/or reproducing medium.

By employing the polarization, it is possible to detect changes in the refractive index of the layer of the electro-optical material. This polarization means may be provided separately from the light source, or may be unified with the light source, that is the light source itself may exhibit polarization characteristics.

The optical recording and/or reproducing medium may further include a polarized light reflecting layer arranged between the layers of the electro-optical material for reflecting at least a portion of a preset polarized light component.

The polarized light reflecting layer reflects the polarized light component, which has been changed by passage through the layer of the electro-optical material, the refractive index of which has been changed, to permit discrimination of the layer of the electro-optical material the refractive index of which has been changed.

The optical recording and/or reproducing apparatus may further be provided with light converging means arranged between the light source and the stage for converging the light radiated from the light source to an optional one of the layers of the electro-optical material. The layer detection means may further include converged position signal outputting means for outputting a converged position signal corresponding to a converged position along the layering direction of the light converged by the light converging means.

By the converged position signal, it is possible to discriminate plural layers of the electro-optical material.

The polarized light reflecting layer may have a plurality of areas having respective different reflectances. The optical recording and/or reproducing apparatus may further include converged position detection means for detecting the in-plane converged position of light converged on the optical recording and/or reproducing medium based on the difference in reflectance of the plural areas.

By the plural areas of respective different reflectances of the polarized light reflecting layer, it is possible to detect in-plane converging positions of the converged light.

The electro-optical material of the layer of the electro-optical material may be a non-linear optical material generating secondary harmonics of light radiated from the light source and may also be a ferroelectric material the direction of residual polarization of which is changed by the application of an electrical field.

By applying of the electrical field to change the direction of residual polarization, it is possible to record the information and to reproduce the information using the secondary harmonics.

The optical recording and/or reproducing apparatus may further include reproducing signal outputting means for outputting a reproducing signal which is based on the phase of the secondary harmonics generated by the layer of the electro-optical material.

Based on the phase of the secondary harmonics, which has been changed by the direction the residual polarization, it is possible to reproduce the recorded information.

The optical recording and/or reproducing apparatus may further include reference light generating means for generating reference light that can interfere with the optical harmonics generated by the layer of the electro-optical material.

By causing the harmonics to interfere with the reference wave, generated by reference light generating means, the phase of the harmonics can be converted into high light intensity and low light intensity.

The different transmittances are allocated to the respective recording and/or reproducing layers so that light will be reflected from the respective recording and/or reproducing layers. The result is that generation of the so-called focussing error signals derived from the reflected light may be achieved from one recording and/or reproducing layer to another to permit discrimination of the respective recording and/or reproducing layers.

The optical recording and/or reproducing medium in the optical recording and/or reproducing apparatus further includes a reference light generating layer arranged together with the layer of the electro-optical material within the depth of focus of light radiated from the light source, the light radiated from the light source falling on the reference light generating layer to generate reference light that can interfere with the optical harmonics generated from the layer of the electro-optical material.

For example, the reference light generating layer may be arranged adjacent to the layer of the electro-optical material.

For optical recording and/or reproduction, with the use of the residual polarization of the ferroelectric material, reference light generating means, which performs phase comparison, for example, is required. It is also necessary that the optical harmonics generated in the recording and/or reproducing member (layer of the electro-optical material) and those generated in the reference light generating means be of approximately the same light intensity and be respectively immune from phase changes applied from outside. However, if, in order to achieve this, the reference light generating means is arranged independently of the layered recording and/or reproducing member, it has been difficult to achieve matching of the intensity of the optical harmonics generated in the reference light generating means and in the recording and/or reproducing member or to equate the phase changes applied from outside to the respective layers. According to the present invention, stable phase comparison can be achieved by matching the light intensity of the reference light to that of the optical harmonics of the layer of the electro-optical material and by substantially equating the effect of phase changes incidentally applied from outside to the reference light to that incidentally applied from outside to the optical harmonics of the layer of the electro-optical material.

By comparing and detecting the phase of the optical harmonics generated on illumination of light from a light source on the layer of the electro-optical material to the phase of the reference light generated on illuminating the light from the light source on the reference light generating layer arranged adjacent to the layer of the electro-optical material, it is possible to discriminate the direction of residual polarization to detect it as recording signals.

It should be noted that the sum of the thickness of the layer of the electro-optical material and that of the reference light generating layer along the light beam traversing direction may be equal to a length within which the phase interference caused by the refractive index differential at the wavelength of light from the light source (λ) and at the wavelength of optical harmonics generated at each layer (λ/2) is not considerable, that is a to so-called interference length, or less.

Supposing that the layer of the electro-optical material and the reference light generating layer are of the same material, the coherence length Lc may be defined by the following equation (1):

Lc=λ/[4Δn]=λ/[4(n^{(2ω)}−n^{(ω)})] (1)

where λ is the wavelength of the light source and n^{(ω)}, n^{(2ω)} are the refractive index of the fundamental wave radiated from the light source and the refractive index of the harmonics generated in each layer, respectively.

By setting the combined thickness of the layer of the electro-optical material and the reference light generating layer so as to be equal to the coherence length or less, or by setting each of the respective thicknesses of the layer of the electro-optical material and the reference light generating layer so as to be equal to the coherence length, it is possible to omit the means for reducing the phase interference ascribable to the refractive index differential, or so-called phase matching.

The optical recording and/or reproducing medium as set on the stage may include an intermediate layer having a refractive index substantially equal to the refractive index of at least one of the layer of the electro-optical material and the reference light generating layer at a wavelength of light illuminated between the layer of the electro-optical material and the reference light generating layer.

The optical recording and/or reproducing medium set on the stage may include at least two layer sets, each comprised of the layer of the electro-optical material and the reference light generating layer, alternately layered together, and a plurality of cut-outs for exposing the electrode layers at end faces along the layering direction, in which the apparatus further includes movement means for causing movement of the stage together with the optical recording and/or reproducing medium and a plurality of electrode terminals mounted on the stage and which is configured for being electrically connected to the plural electrode layers exposed at end faces along the layering direction of the optical recording and/or reproducing medium as set on the stage. The voltage applying means selectively applies the voltage to the plural electrode terminals.

If the optical recording and/or reproducing medium is removable from the recording and/or reproducing apparatus, it is necessary to provide contacts for supplying the current to the respective electrode layers on for example the lateral surfaces of the optical recording and/or reproducing medium. If however the number of layers is to be increased to improve the recording density of the recording and/or reproducing medium and notwithstanding the overall thickness of the medium is to be reduced, the thickness of each medium layer needs to be reduced, thus narrowing the lateral surface of the medium to render it difficult to provide contacts of the electrode layers thereon.

Although it may be contemplated to provide electrode layers on the lateral surface extending along the layering direction, there is presented a problem that the medium layer as a transparent insulating member acts as a wall thus complicating the medium structure. If recording and/or reproduction is made as the optical recording and/or reproducing medium is moved or rotated relative to the recording and/or reproducing apparatus, it is necessary to provide means for supplying the current from the light source to the electrode layers of the optical recording and/or reproducing medium, thus complicating the structure of the current conducting means. The present invention provides for stabilized current conduction to the electrodes of the respective layers of the removable multi-layered recording and/or reproducing medium. That is, by exposing the plural electrode layers of the layered medium at end faces along the layering direction, it is possible to conduct current to the respective electrode layers of the layered moving or rotating medium extremely readily from the end faces along the layering direction of the layered medium.

The voltage applying means may include a circuit unit provided on the stage, an external circuit unit, provided outside the stage, and transmission means for non-contact transmission of power from the external circuit unit to the stage circuit unit. The external circuit unit includes means for superposing a layer identification signal to the power to transmit the resulting signal to the stage circuit unit through the transmission means. The stage circuit unit includes means for generating a voltage applied to the electrodes of the optical recording and/or reproducing medium from the power transmitted in a non-contact fashion from the external circuit unit, means for separating the layer identification signal from the power transmitted in a non-contact fashion from the external circuit unit, and means for switching the electrode terminals applying the voltage based on the so separated layer identification signal.

By this structure, the power for applying an electrical field to the medium layer and the layer identification signal may be transmitted to the circuit unit of the medium holder, using a common transmission system, to simplify the circuit structure.

(2) An optical reproducing apparatus in another aspect of the present invention includes a stage for setting thereon an optical recording and/or reproducing medium including a layer of an electro-optical material in which the polarization can be changed in its direction and remnant on application of an electrical field and which generates optical harmonics on irradiation with light, a light source for illuminating light on the optical recording and/or reproducing medium set on the stage, and detection means for detecting the phase of optical harmonics generated from the optical recording and/or reproducing medium as set on the stage.

If light is illuminated on the layer of the electro-optical material, optical harmonics are produced. Since the phase of the so generated optical harmonics is changed depending on the application of the electrical field, this phase change may be detected to reproduce the information recorded on the optical recording and/or reproducing medium.

(3) The optical recording and/or reproducing medium in still another aspect of the present invention also includes a layer of an electro-optical material in which the polarization can be changed in its direction and remnant on application of an electrical field and which generates optical harmonics on irradiation with light.

By applying the voltage to the layer of the electro-optical material and by causing the polarization to be remnant, under controlling its direction, the information can be recorded on the optical recording and/or reproducing medium. On the other hand, optical harmonics are produced on illuminating light on the layer of the electro-optical material, with the phase of the optical harmonics produced changing with the direction of polarization. This phase change may be detected to reproduce the information recorded on the optical recording and/or reproducing medium.

It is also possible to provide electrode layers on the front and back surfaces of the layer of the electro-optical material.

Although the optical recording and/or reproducing medium according to the present invention may be used as a read-only device, the optical recording and/or reproducing medium itself may be provided with an electrode layer, in which case the optical recording and/or reproducing medium proves an optimum medium for a recording and/or reproducing apparatus.

The layer of the electro-optical material may be comprised of plural layers stacked together.

By stacking the plural layers of the electro-optical material, each capable of recording the information, it is possible to increase the volume of the information that can be stored.

There may also be provided electrode layers sandwiched between the stacked electrode layers and which are provided on the surfaces of the uppermost and lowermost layers of the electro-optical material.

By suitably selecting these electrode layers to apply the voltage thereto, an electrical field can be applied to a desired one of the layers of the electro-optical material. The respective layers of the electro-optical material can be identified by the changes in the refractive index of the layers of the electro-optical material to which the electrical field is applied. The information can be recorded by applying the electrical field for thereby changing the direction of residual polarization, while the information can be reproduced using optical harmonics.

Each layer of the electro-optical material may be of a thickness not larger than the coherence length.

There may also be provided a plurality of layers of the electro-optical material, each layer of the electro-optical material being a ferroelectric non-linear optical material generating optical harmonics on incidence thereon of the light of excitation, and being of a thickness not larger than the coherence length beyond which the phase of the optical harmonics is inverted due to the difference between the refractive index of the light of excitation and that of the optical harmonics, in which the medium further includes a plurality of electrode layers arranged between the plural layers of the ferroelectric non-linear optical material.

By applying the voltage across the electrodes, it is possible to control the direction of polarization of the respective layers of the ferroelectric non-linear optical material to record the information. Since the thickness of the ferroelectric non-linear optical material is not larger than the coherence length, there is no fear of the optical harmonics generated within the layers of the ferroelectric non-linear optical material weakening one another. As a result, the optical harmonics may be efficiently generated from the respective layers of the ferroelectric non-linear optical material to reproduce the information.

The directions of polarization of the respective layers of the ferroelectric non-linear optical material may be alternately reversed along the layering direction of the plural layers of the ferroelectric non-linear optical material.

Since the direction of polarization is reversed between the neighboring layers of the ferroelectric non-linear optical material (inverted polarization distribution), the respective optical harmonics generated by the respective neighboring layers of the ferroelectric non-linear optical material strengthen one another to enable optical harmonics to be generated efficiently from the stacked medium layers.

The optical recording and/or reproducing medium may further be provided with electrical wiring for electrically interconnecting every two electrodes.

By applying the voltage to the electrical wiring, it is possible to form electrical fields inverted in direction from one layer of the ferroelectric non-linear optical material to the next (inverted electrical field). These inverted electrical fields can be identified by the sign of the voltage applied to the electrical wiring. The result is that, by applying the positive or negative voltage to the electrical wiring, as the layers of the ferroelectric non-linear optical material are locally heated with for example the laser light, inverted polarization distribution associated with the positive or negative sign of the voltage can be formed in the stacked medium layers to achieve information recording.

As the optical recording and/or reproducing mediums, plural sets may be provided, each comprised of the aforementioned layered mediums.

By stacking the layered mediums, each capable of recording the information, it is possible to increase the volume of the information that can be stored.

The respective layers of the electro-optical material may have the refractive index changed as a result of application of the electrical field.

By suitably selecting the plural electrode layers and by applying the voltage thereto, an electrical field can be applied to the optional layer of the electro-optical material. The respective layers of the electro-optical material, can be identified by changes in the refractive index of the layer of the electro-optical material to which the electrical field has been applied. Moreover, by changing the direction of residual polarization by application of the electrical field, the information can be recorded, while the information recorded can be reproduced using secondary harmonics.

Here, the optical recording and/or reproducing medium may further be provided with electrode layers arranged between the plural layers of the electro-optical material and which are of substantially the same refractive index as that of the layers of the electro-optical material at a preset light wavelength.

By changing the refractive index of each layer of the electro-optical material as a result of application of the electrical field, the refractive index between the layer of the electro-optical material and the electrode layer may be differentiated to produce boundary reflection. The layer of the electro-optical material can be detected by detecting the light of boundary reflection.

Meanwhile, the optical recording and/or reproducing medium may include a pair of electrode layers arranged between the plural layers of the electro-optical material and which are of a refractive index substantially equal to the refractive index of the layer of the electro-optical material at a preset light wavelength, and an intermediate layer arranged between the paired electrode layers and which are of a light transmittance and a refractive index substantially equal to the refractive index of the layer of the electro-optical material at the preset light wavelength.

By changing the refractive index of each of the layers of the electro-optical material, as a result of application of the electrical field, boundary reflection may be produced to detect the layer of the electro-optical material. By further providing the intermediate layer, the distance between the layers of the electro-optical material can be increased, so that, even in case the layers of the electro-optical material are of reduced thickness, the respective layers of the electro-optical material can be discriminated extremely readily.

The optical recording and/or reproducing medium may also be provided with a polarized light reflecting layer arranged between the neighboring layers of the electro-optical material and which is adapted for reflecting at least a portion of the preset polarized light component.

The polarized light reflecting layer operates to reflect the polarized light component, changed by passing through the layer of the polarized light reflecting layer, the refractive index of which has been changed, to allow to identify the layer of the electro-optical material, the refractive index of which has been changed.

The optical recording and/or reproducing medium may be provided with plural areas having respective different reflectances.

The in-plane converging positions of the converged light can be detected by the plural areas having differential reflectances of the polarized light reflecting layer.

The reference light generating layer may be arranged within the depth of focus of the illuminated light, together with the layer of the of the electro-optical material, and adapted for generating the reference light interfering with the optical harmonics generated on the light illumination from the layer of the electro-optical material.

The reference light generating layer may be arranged adjacent to the layer of the electro-optical material.

By comparing and detecting the phase of the optical harmonics, generated on light illumination from a light source to a layer of an electro-optical material, and the phase of the reference light, generated on illuminating the light from the light source to the reference light generating layer, it is possible to discriminate the direction of residual polarization for detection as recording signal.

It should be noted that the sum of the thickness of the layer of the electro-optical material and that of the reference light generating layer along the light beam traversing direction may be equal to a length within which the phase interference caused by the refractive index differential at the wavelength of light from the light source (λ) and at the wavelength of optical harmonics generated at each layer (λ/2) is not considerable, that is a so-called interference length, or less. Alternatively, the thickness of the layer of the electro-optical material and that of the reference light generating layer may respectively be the thickness equal to the coherence length Lc.

Supposing that the layer of the electro-optical material and the reference light generating layer are of the same material, λ is the wavelength of the light source and n^{(ω)}, n^{(2ω)} are the refractive index of the fundamental wave radiated from the light source and the refractive index of the harmonics generated in each layer, respectively the coherence length Lc may be defined by the equation (1) above.

By setting the combined thickness of the layer of the electro-optical material and the reference light generating layer so as to be equal to the coherence length or less, or by setting each of the respective thicknesses of the layer of the electro-optical material and the reference light generating layer so as to be equal to the coherence length, it is possible to omit the means for reducing the phase interference ascribable to the refractive index differential, or so-called phase matching.

The optical recording and/or reproducing medium as set on the stage may further include an intermediate layer arranged between the stacked layers and having a refractive index approximately equal to the refractive index of at least one of the electro-optical material and the reference light generating layer at a wavelength of the illuminated light.

There may also be provided at least two of layered sets each comprised of the layer of the electro-optical material and the reference light generating layer, together with a plurality of cut-outs for exposing the plural electrode layers at end faces along the layering direction.

By exposing the plural electrodes of the layered medium at end faces of the layered medium along the layering direction, current conduction to the respective electrodes can be achieved readily from the end face of the layered medium along the layering direction.

(4) The optical recording and/or reproducing method in still another aspect of the present invention includes a step of illuminating light on a layer of an electrochemical material, in which the polarization can be changed in its direction and remnant on application of an electrical field and which generates optical harmonics on illumination of light, as an electrical field is applied to the layer of the electro-chemical material, a step of illuminating light on the layer of the electro-chemical material to detect the phase of the optical harmonics generated from the layer of the electro-chemical material, and a step of detecting the phase of the optical harmonics generated from the layer of the electro-chemical material on illumination of light on the layer of the electro-chemical material.

By applying the voltage to the layers of the electro-optical material to control the direction of polarization to cause the polarization remnant, the information can be recorded on the optical recording and/or reproducing medium. On the other hand, since optical harmonics are generated on illuminating light on the layers of the electro-optical material, and the optical harmonics so generated is changed in phase depending on the direction of polarization, these changes in the phase may be detected to reproduce the information recorded on the optical recording and/or reproducing medium.

In the above detection step, the reference light interfering with the optical harmonics generated from the optical recording and/or reproducing medium may be output so as to be superposed on the optical harmonics to detect the intensity of the optical harmonics superposed on the reference light to detect the phase fo the optical harmonics.

By interference of the optical harmonics, generated from the optical recording and/or reproducing medium, with the reference light, the phase of the optical harmonics can be converted into high light intensity and low light intensity.

The light intensity of the reference light may be approximately equal to the light intensity of optical harmonics generated from the optical recording and/or reproducing medium.

The so converted high or low light intensity may be locally maximized or locally minimized.

An optical recording and/or reproducing method in still another aspect of the present invention includes an illuminating step of illuminating light on a layer of an electro-optical material, which generates harmonics on illumination of light and which has its refractive index changed by application of an electrical field, as an electrical field is applied to the layer of the electro-optical material, a detecting step of detecting harmonics generated from the layer of the electro-optical material, by light illumination at the illuminating step to obtain an intensity signal corresponding to the intensity of the harmonics, and a controlling step of controlling the electrical field applied to the layer of the electro-optical material based on the intensity signal obtained at the detection step.

By controlling the electrical field applied to the layer of the electro-optical material based on the intensity signal, the refractive index of the layer of the electro-chemical material can be changed to maintain the phase matching state.

(5) A method for optical recording in still another aspect of the present invention includes a step of locally heating a plurality of layers of a ferroelectric non-linear optical material, in which the directions of polarization are changed on application of an electrical field and in which optical harmonics are generated on incidence thereon of the light of excitation, each layer being of a thickness not larger than the coherence length beyond which phase inversion of the optical harmonics occurs by the refractive index differential between the light of excitation and the optical harmonics, under application of an electrical field alternately reversed in direction to the layers.

By this local heating of plural layers of the ferroelectric non-linear optical material, under application of an electrical field, the direction of which is reversed alternately, the information can be recorded by polarization inversion.

(6) An optical reproducing method in still another aspect of the present invention includes a step of setting, on a stage, a layer of an electro-optical material, in which the polarization can be changed in direction and remnant on application of an electrical field, and which generates harmonics on illumination of light, and a step of illuminating light on the layer of the electro-optical material as set on the stage to detect the phase of optical harmonics generated from the layer of the electro-optical material.

The optical harmonics, generated on illuminating the light on the layer of the electro-chemical material, are changed in phase depending on the direction of polarization. So, the changes in phase may be detected to reproduce the information recorded on the optical recording and/or reproducing medium.

(7) An optical layer detection method in yet another aspect of the present invention includes applying an electrical field to one of a plurality of layers of an electro-optical material, the refractive index of which is changed on application of an electrical field, and detecting the layer of the electro-optical material, the refractive index of which has been changed.

The plural layers of the electro-optical material can be discriminated by applying an electrical field to the layers of the electro-optical material to vary the refractive index, and by detecting the layer of the electro-optical material, the refractive index of which has been changed.

### BRIEF DESCRIPTION OF THE DRAWINGS

FIG. 1 is a cross-sectional view for illustrating the principle of signal recording in the optical recording and/or reproducing method in a first embodiment of the present invention.

FIG. 2 is a cross-sectional view for illustrating the principle of reproducing recorded signals.

FIG. 3 is a cross-sectional view for illustrating a recording medium of a multi-layered structure.

FIG. 4 is a cross-sectional view showing the structure of an optical recording and/or reproducing apparatus according to a first embodiment of the present invention.

FIG. 5 is a schematic view showing an optical recording and/or reproducing apparatus according to a second embodiment of the present invention.

FIG. 6 is a partial enlarged cross-sectional view showing the state of initializing the optical recording medium.

FIG. 7 is a partial enlarged cross-sectional view showing the state of recording the information on an optical recording and/or reproducing medium.

FIG. 8 is a partial enlarged side view showing the state of reproducing the information from an optical recording and/or reproducing medium.

FIG. 9 is again a partial enlarged side view showing the state of reproducing the information from an optical recording and/or reproducing medium.

FIG. 10 is a schematic view showing a refractive index ellipsoid in a layer of a ferroelectric recording medium.

FIG. 11 is a schematic view showing a refractive index ellipsoid in case an electrical field is applied along the direction of crystal axis of the ferroelectric recording medium.

FIG. 12 is a schematic view showing a refractive index ellipsoid in case an electrical field is applied along the direction different from the direction of the crystal axis of the ferroelectric recording medium.

FIG. 13 is a schematic view showing an optical recording and/or reproducing apparatus according to a third embodiment of the present invention.

FIG. 14 is a schematic view showing details of an optical recording and/or reproducing medium shown in FIG. 13 and its vicinity.

FIG. 15 is a cross-sectional view showing the state of recording the information on an optical recording and/or reproducing medium.

FIG. 16 is a cross-sectional view showing the state of recording the information on an optical recording and/or reproducing medium.

FIG. 17 is schematic view showing the state of reproducing the information from an optical recording and/or reproducing medium.

FIG. 18 is again a schematic view showing the state of reproducing the information from an optical recording and/or reproducing medium.

FIG. 19 is a schematic view showing the structure of an optical recording and/or reproducing apparatus according to a fourth embodiment of the present invention.

FIG. 20 is a schematic view showing the structure of an optical recording and/or reproducing medium, a power supply and a layer switching device according to a fourth embodiment of the present invention.

FIG. 21 is a side view showing a modification of an optical recording and/or reproducing medium of the fourth embodiment of the present invention.

FIG. 22 is a side view showing the state of reproducing an optical recording and/or reproducing medium of the fourth embodiment of the present invention using a reference wave.

FIG. 23 is a side view showing the state of initializing the optical recording and/or reproducing medium according to the fourth the present invention.

FIG. 24 is a side view showing the state of recording on the optical recording and/or reproducing medium of the fourth embodiment of the present invention.

FIG. 25 is a schematic view showing the structure of an optical recording and/or reproducing medium of a fifth embodiment of the present invention.

FIG. 26 is a schematic view showing an optical recording and/or reproducing medium, a power supply and a layer switching device of the fifth embodiment of the present invention.

FIG. 27 is a schematic view showing the structure of an optical recording and/or reproducing medium according to a sixth embodiment of the present invention.

FIG. 28 is an explanatory view for illustrating the optical recording system according to the sixth embodiment of the present invention.

FIG. 29 is an explanatory view for illustrating the optical reproducing system according to the sixth embodiment of the present invention.

FIG. 30 is again an explanatory view for illustrating the optical reproducing system according to the sixth embodiment of the present invention.

FIG. 31 is a schematic view showing the structure comprised of plural layers according to the sixth embodiment of the present invention.

FIG. 32 is a schematic view showing the structure of an optical recording and/or reproducing apparatus according to a sixth embodiment of the present invention.

FIG. 33 is a schematic view of an optical recording and/or reproducing medium.

FIG. 34 is a perspective view showing an optical recording and/or reproducing apparatus according to a seventh embodiment of the present invention.

FIG. 35 is a cross-sectional view showing the structure of a multi-layered recording and/or reproducing medium according to the present invention.

FIG. 36 is a schematic view showing a structure of an optical recording and/or reproducing unit in an optical recording and/or reproducing apparatus of FIG. 34.

FIG. 37 is a cross-sectional view showing the state in which a multi-layered recording and/or reproducing medium is held by a medium holder of FIG. 35.

FIG. 38 is a plan view of the multi-layered recording and/or reproducing medium, as held by a medium holder, looking from its one side.

FIG. 39 is a plan view showing a cut-out provided in each layer of the multi-layered recording and/or reproducing medium of FIG. 35.

FIG. 40 is a cross-sectional view showing details of connection between an electrode layer of a multi-layered recording and/or reproducing medium and an electrode terminal.

FIG. 41 is a circuit diagram showing the structure of means for selectively applying an electrical voltage to each electrode layer of a multi-layered recording and/or reproducing medium.

FIG. 42 is a schematic view showing an alternative structure of an optical recording and/or reproducing medium.

### BEST MODE FOR CARRYING OUT THE INVENTION

Referring to the drawings, preferred embodiments of the present invention will be explained in detail.

[First Embodiment]

(Principle of Optical Recording and/or Reproduction)

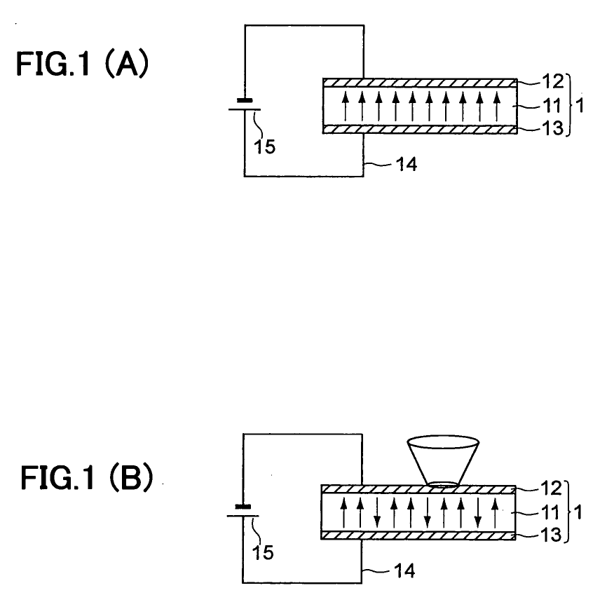

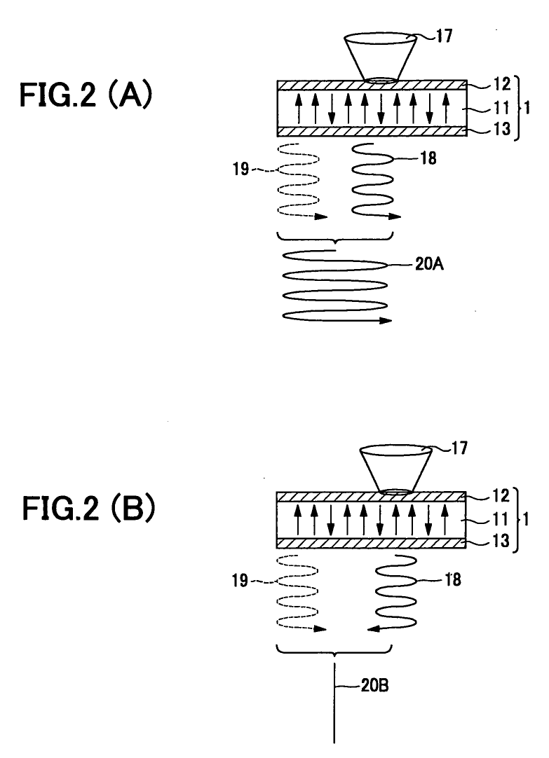

FIGS. 1(A), (B) and FIGS. 2(A), (B) show an optical recording and/or reproducing method embodying the present invention. Specifically, FIGS. 1(A), (B) shows a signal recording process and FIGS. 2(A), (B) show a signal reproducing process.

A. Structure of an Optical Recording and/or Reproducing Medium 1

An optical recording and/or reproducing medium 1 is comprised of a recording and/or reproducing layer 11, as a layer of an electro-optical material, on both surfaces of which are formed electrodes 12, 13, as respective electrode layers.

The recording and/or reproducing layer 11 is formed of an optical material having an optically sufficient ratio of transmission (transmittance) to a light beam of a wavelength λ from an illuminating light source and a light beam of a wavelength λ/2 (second harmonics of light). This optical material is a non-linear optical material generating optical harmonics of an electro-optical material, the refractive index of which is changed on application of an electrical field thereto, or a ferroelectric material, the direction of residual polarization of which is changed on application of an electrical field thereto. Examples of the materials include a thin sheet or a thin film of ferroelectric crystals, such as lithium niobate (LiNbO₃), barium titanate (BaTiO₃), or KPT (KTiOPO₄), films of ferroelectric polymer materials, such as polyvinylidene fluoride (PVDF), vinylidene fluoride (VDF) or triethylene fluoride TrFE), and thin sheets or films of organic non-linear materials, such as methylcyanine complex salts, nitroaniline or nitropyridine based organic crystals or a polymer of an azo dyestuff and a monomer. The optical material preferably exhibits phase matching and angular matching as to generation of optical harmonics (second harmonics). The optical material does not have to be provided in the entire area thereof used for recording and/or reproduction, such that another recording medium may be provided as a read-only area in a portion of the area of the optical material used for recording and/or reproduction.

The electrodes 12, 13 are thin films of, for example, ITO (indium tin oxide), and may be formed by methods such as vapor deposition and sputtering.

B. Recording of the Information on the Optical Recording and/or Reproducing Medium 1

In recording the information on the optical recording and/or reproducing medium 1, an electrical field exceeding an anti-electrical field is applied by an power supply 15 across electrodes 12 and 13, as shown in FIG. 1(A). This equates the direction of polarization of the recording and/or reproducing layer 11 to establish a pre-recording state.

The positive and negative terminals of the power supply 15 are then reversed, as shown in FIG. 1(B). As an electrical field not exceeding the anti-electric field is applied across the electrodes 12 and 13 in a direction of reversing the direction of the residual polarization, a light source, such as a recording light beam 16, as a laser light beam, is converged and illuminated to locally heat the recording and/or reproducing layer 11. This reverses the direction of polarization of the heated portion to establish the recording state. By setting the recording light beam 16 at a preset position, and by managing control between illumination and non-illumination, it is possible to form and store bi-value signals as the direction of the residual polarization.

C. Reproduction of the Information from the Optical Recording and/or Reproducing Medium 1

In reproducing signals recorded with the direction of the residual polarization, a reproducing light beam 17, such as a laser light beam, is converged and illuminated on the recording and/or reproducing layer 11, as shown in FIG. 2(A). In the portion of the recording and/or reproducing layer, illuminated by the reproducing light beam 17, there is generated second optical harmonics 18. If there is residual polarization in the portion illuminated by the light beam, the phase of the second optical harmonics 18 generated is changed in known manner depending on the direction of polarization. If the phase difference is discriminated, the direction of residual polarization recorded can be detected to reproduce the signal matched to this direction.

In the present embodiment, light interference employing optical second harmonics for reference 19, for example, is used for converting phase changes into changes in light intensity which can be discriminated more readily. This optical second harmonics for reference 19 may be produced in a ferroelectric layer different from the recording and/or reproducing layer 11 but which is provided on the same optical path of the optical recording and/or reproducing apparatus as the recording and/or reproducing layer 11. It is also possible to generate the second optical harmonics for reference on an optical path which is not the same optical path and to guide the so generated second optical harmonics for reference to the recording and/or reproducing layer 11 using a light mixing device.

In an embodiment shown in FIG. 2(A), the optical second harmonics generated by the reproducing light beam 17 is of the same phase as the optical second harmonics for reference 19 generated form another source, so that there is generated a detection light beam 20A having a light intensity corresponding to the sum by interference of the two light beams. On the other hand, in the embodiment of FIG. 2(B), the second optical harmonics 18, produced by the reproducing light beam 14, is 180° out of phase with the optical second harmonics for reference 19, so that the light intensity is deducted by interference to give a light beam for detection 20B.

The conversion efficiency of the second optical harmonics 18 generated from the reproducing light beam 17 is not of a large value, so that, if the optical second harmonics for reference 19 is generated as reference light in the reproducing optical path, such optical second harmonics scarcely affect the second optical harmonics 18 generated in the reproducing optical path as reference light. That is, by simply generating a reference light beam having a preset phase and a preset light intensity in the optical path for reproduction, and mixing the optical second harmonics for reference 19 with the second optical harmonics 18 generated in the recording and/or reproducing layer 11 formed of the ferroelectric material, phase changes prove to be a change in light intensity by phase interference. This means that the optical system for signal detection can be simplified in its structure significantly. Meanwhile, the reproducing light beam 14 can directly be used for position setting and control as required for signal recording and/or reproduction.

(Multi-Layering the Optical Recording and/or Reproducing Medium)

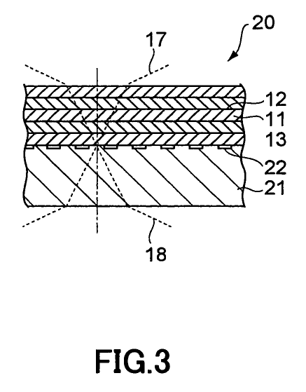

FIG. 3 shows a multi-layered structure obtained on layering plural optical recording and/or reproducing mediums, explained with reference to FIGS. 1 and 2. Specifically, a plural number, herein five, layers of each of the recording and/or reproducing layers 11, formed of the ferroelectric material, and the electrodes 12, 13, are stacked together on a substrate 21. The recording on each recording and/or reproducing layer 11 of the multi-layered optical recording and/or reproducing medium 20 is by inverting the residual polarization which is brought about by converging and illuminating the recording light beam, such as laser light beam, as a preset electrical field is applied across the two electrodes 12, 13 neighboring to the layer destined for recording. In reproduction, the reproducing light beam including the second harmonics for reference, generated elsewhere, or by another source, is converged and illuminated on a layer for reproduction, and the light intensity of the interference light of the generated optical second harmonics and the optical second harmonics for reference is detected.

As for a signal used for position setting and control as required for signal recording and/or reproduction in this multi-layered optical recording and/or reproducing medium 20, it is sufficient if projections and recesses 22 are formed on the substrate 21 as shown in FIG. 3 and to read out the signal as a control signal by exploiting the diffraction of the reproducing light beam.

(Optical Recording and/or Reproducing Apparatus)

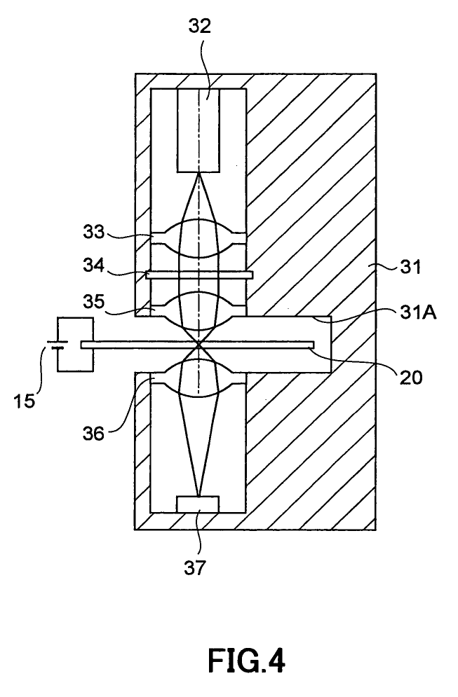

FIG. 4 shows a specified structure of an optical recording and/or reproducing apparatus employing the aforementioned optical recording and/or reproducing method.

This optical recording and/or reproducing apparatus has a housing 31 including a recording medium accommodating portion 31A, in which portion 31A is accommodated the optical recording and/or reproducing medium 20. Above the recording medium accommodating portion 31A, there are mounted, at the locations facing the optical recording and/or reproducing medium 20, a light source 32 for generating the laser light, a lens 33 for collimating the laser light produced by the light source 32, a reference light generating plate 34 for generating second optical harmonics, part of which proves the reference light, by the light beam transmitted through the lens 33, and a lens 35 for converging the second optical harmonics, generated in the reference light generating plate 34 on the optical recording and/or reproducing medium 20, looking from above in the drawing. On the other hand, there are mounted, below the recording medium accommodating portion 31A, at the locations facing the optical recording and/or reproducing medium 20, a lens 36 for converging the second optical harmonics generated in the optical recording and/or reproducing medium 20, and a photodetector 37 for detecting the converged second harmonics.

In the present optical recording and/or reproducing apparatus, the laser light outgoing from the light source 32 is collimated by lens 33 to a substantially parallel beam, which is guided to the reference light generating plate 34. The light beam, transmitted through the reference light generating plate 34, is partially turned into second optical harmonics for reference which are converged by the lens 35 so as to be focussed on the optical recording and/or reproducing medium 20 formed of a ferroelectric material. This generates second optical harmonics, differing in phase depending on the direction of residual polarization at the focal point of the optical recording and/or reproducing medium 20, these second optical harmonics undergoing phase interference with the second harmonics for reference light generated by the reference light generating plate 34 to produce lightness and darkness dependent upon the direction of residual polarization, that is light beams 20A, 20B for detection. These light beams are re-converged by the lens 36 to reach the photodetector 37 so as to be detected as lightness and darkness. This permits detection of signals recorded as the direction of polarization on the optical recording and/or reproducing medium 20.

Thus, in the optical recording and/or reproducing apparatus of the instant embodiment, in which the inversion of polarization in the recording and/or reproducing layer 11, formed of the ferroelectric material, may be discriminated using the optical second harmonics, high recording density and highly reliable stable readout characteristics can be achieved in distinction from the conventional methods of detecting the intensity of the reflected light in the polarization inversion or of detecting the focussed current.

(Other Forms)

The optical recording and/or reproducing medium of the present invention may, of course, be a disc or a card, only by way of illustration. Although the electrodes for applying the electrical field for signal recording are provided in the above-described embodiment, the direction of residual polarization may also be saved in dependence upon the signal by a method different from that described above. The structure described in the foregoing is not given by way of limitation provided that the function achieved is pursuant to the purpose of the present invention. In the above-described embodiment, such a method has been explained in which the second optical harmonics transmitted through the optical recording and/or reproducing medium is detected. Alternatively, the second optical harmonics, produced on transmission, may be reflected to detect the reflected light. The detection method is also not limited to this method on the condition that the method used gives meritorious effects comparable to that of the above-described embodiment.

[Second Embodiment]

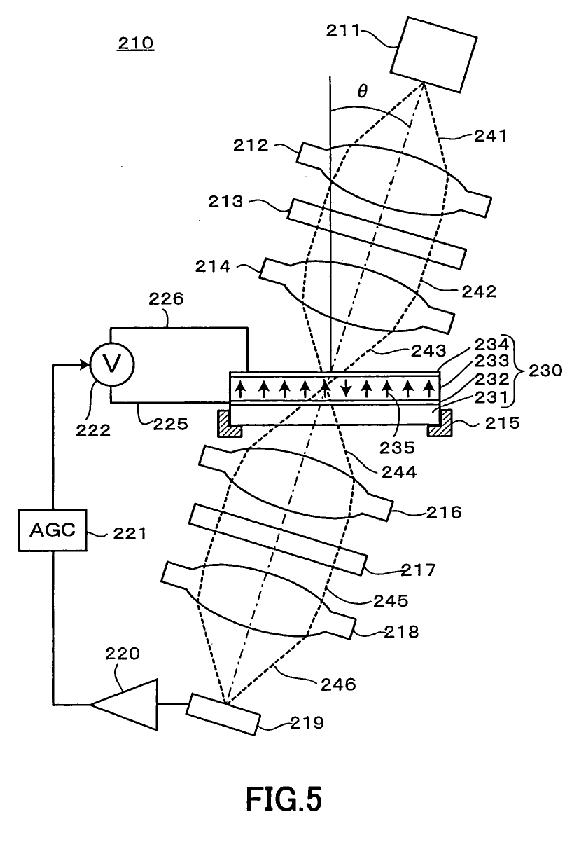

FIG. 5 is a schematic view showing an optical recording and/or reproducing apparatus 210 according to the present invention.

Referring to FIG. 5, the optical recording and/or reproducing apparatus 210 is made up by a light source 211, collimator lenses 212, 216, an optical component 213, converging lenses 212, 218, a state 215 for setting an optical recording and/or reproducing medium 230 thereon, a wavelength filter 217, a detector 219, a signal amplifier 220, an automatic power controller 221 and a power supply unit 222.

(Detailed Structure of the Optical Recording and/or Reproducing Medium)

An optical recording and/or reproducing medium 230 is made up by a substrate 231, electrodes 232, 234 and a layer of a ferroelectric recording medium 233. The layer of the ferroelectric recording medium 233 has residual polarization 235. It should be noted that the electrodes 232, 234 are electrically connected to an output of the power supply unit 222 by electrical routes 25, 226 (wiring).

As in the first embodiment, described above, the material that makes up the layer of the ferroelectric recording medium 233 is the ferroelectric material, the direction of residual polarization 235 of which is changed on application of an electrical field. In addition, the material is a non-linear optical material for generating harmonics, having the illuminated light as the fundamental wave, on illumination of a light beam from the light source 211, and an electro-optical material the refractive index of which is changed on application of an electrical field. The constituent materials of the layer of the ferroelectric recording medium 233 exhibit a sufficient ratio of transmission (transmittance) to both a light beam 241 for reproduction illuminated from the light source 211 and optical harmonics generated within the layer of the ferroelectric recording medium 233.

The electrodes 232, 234 are provided for sandwiching the layer of the ferroelectric recording medium 233 from its front and back sides, to apply an electrical field for recording the information on the layer of the ferroelectric recording medium 233 (controlling the direction of residual polarization 235) and for accomplishing phase matching (controlling the refractive index) as will be explained subsequently.

For the electrodes 232,234, electrically conductive transparent electrodes, such as ITO (indium tin oxide), may be used. Moreover, a thin dielectric film may be deposited as an antireflection film on the surfaces of the electrodes 232, 234 for use as an optical multi-layered film, whereby the ratio of light transmission may be improved within an extent that does not deteriorate electrical characteristics of the electrodes 232, 234.

(Detailed Structure of the Optical Recording and/or Reproducing Apparatus)

The light source 211 is e.g., a semiconductor laser and radiates a light beam 241 with a wavelength e for reproducing the optical recording and/or reproducing medium 230.

The collimator lenses 212, 216 collimate the light beams 241, 244 to generate a parallel light beam.

The converging lenses 214, 218 converge the light beams 242, 245 on the layer of the ferroelectric recording medium 233 and on the detector 219, respectively.

The optical component 213 generates optical harmonics for reference for converting the phase information of the optical harmonics for reproduction, generated by the optical recording and/or reproducing medium 230, into light intensity. As a result, the light beam 243, illuminated on the layer of the ferroelectric recording medium 233, contains both the fundamental component for reproduction (wavelength: ë) radiated from the light source 211 and the harmonics component for reference (wavelength: ë/2) generated by the optical component 213. It should be noted that, although the third or higher harmonics may be contained in the harmonics, in addition to second harmonics, with the wavelength equal to one half the wavelength of the fundamental wave, the third or higher harmonics are generally lower in strength than the second harmonics and hence it is unnecessary to make much of the presence of the third or higher harmonics.

The stage 215 is used for setting and securing the optical recording and/or reproducing medium 230 thereon, and is provided with a center through-hole for passage of light therethrough.

The wavelength filter 217 absorbs the fundamental wave component, illuminated from the light source 211, for separating the harmonics components, produced in the optical recording and/or reproducing medium 230, for signal detection. As a result, the light beam 244, which has passed through the wavelength filter 217, contains both the harmonics component for reproduction and the harmonics component for reference, while being free of the fundamental component for reproduction.

The detector 219 detects the light beam 246 for signal detection and outputs a light intensity signal corresponding to the intensity of the detected light beam 246.

The signal amplifier 220 amplifies the light intensity signals output from the detector 219.

The automatic power controller 221 controls the light intensity signal, input from the signal amplifier 220, so that the light intensity signal will be of a preset intensity.

The power supply unit 222 applies a voltage (potential difference) across the electrodes 232 and 234 to apply an electrical field to the layer of the ferroelectric recording medium 233.

The axis interconnecting the light source 211 and the detector 219 is inclined an angle è with respect to a normal line drawn to the surface of the optical recording and/or reproducing medium 230. This structure is used to achieve angle matching which is a sort of phase matching. This angle matching will be explained subsequently.

(Operation of Optical Recording and/or Reproducing Apparatus)

The operation of the optical recording and/or reproducing apparatus 210 is hereinafter explained.

The optical recording and/or reproducing apparatus 210 records and/or reproduces the information on or from the optical recording and/or reproducing medium 230 and effects phase matching in reproducing the information. The method of recording and/or reproducing the information and of effecting the phase matching for the optical recording and/or reproducing medium 230 is hereinafter explained.

A. Recording of the Information on the Optical Recording and/or Reproducing Medium 230.

The information recording on the optical recording and/or reproducing medium 230 is achieved by light illumination and application of an electrical field. Before recording the information, the optical recording and/or reproducing medium 230 is initialized.

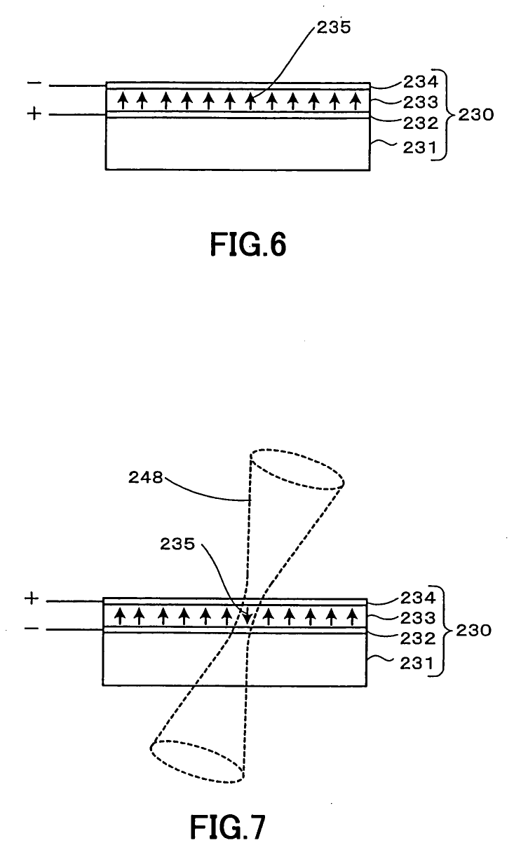

FIGS. 6 and 7 are cross-sectional views showing the state of initializing the optical recording and/or reproducing medium 230 and the state of information recording, respectively.

(1) Before recording the information, the direction of residual polarization of the layer of the ferroelectric recording medium 233 is brought into alignment. Using the power supply unit 222, a voltage (potential difference) is applied to the electrodes 232, 234 to apply an electrical field larger than the anti-electrical field which allows for inversion of the residual polarization to the layer of the ferroelectric recording medium 233 (FIG. 6).

As a result, residual polarization aligned to the direction of the electrical field is produced. This uniformed direction of residual polarization means a sort of initialization of the optical recording and/or reproducing medium 230.

(2) For recording (writing) on the initialized optical recording and/or reproducing medium 230, a light beam 248 from a light source is converged to a location within the layer of the ferroelectric recording medium 233, where recording is desired to be made, as an electrical field is applied in a direction corresponding to the bit desired to be recorded on the layer of the ferroelectric recording medium 233 (FIG. 7). It should be noted that the electrical field applied is smaller than the anti-electric field.

Since the electrical field applied is smaller than the anti-electric field, the direction of residual polarization 235 is not changed in a location where the light beam 248 is not converged. That is, from the perspective of the information, no bit inversion is produced.

Conversely, local temperature rise is produced in a location where the light beam 248 has been converged, so that the anti-electrical field is lowered to change the direction of the residual polarization 235.

The direction of the residual polarization 235 of the heated location can be controlled in this manner by performing local heating under application of an electrical field smaller than the anti-electrical field at ambient temperature (information recording).

Although the light beam 248 is inclined in FIG. 7, in agreement with FIG. 5, with respect to the normal line to the planar surface of the optical recording and/or reproducing medium 230, the light beam 248 may also be illuminated from the direction of the normal line to the planar surface.

B. Reproduction of the Information from the Optical Recording and/or Reproducing Medium 230

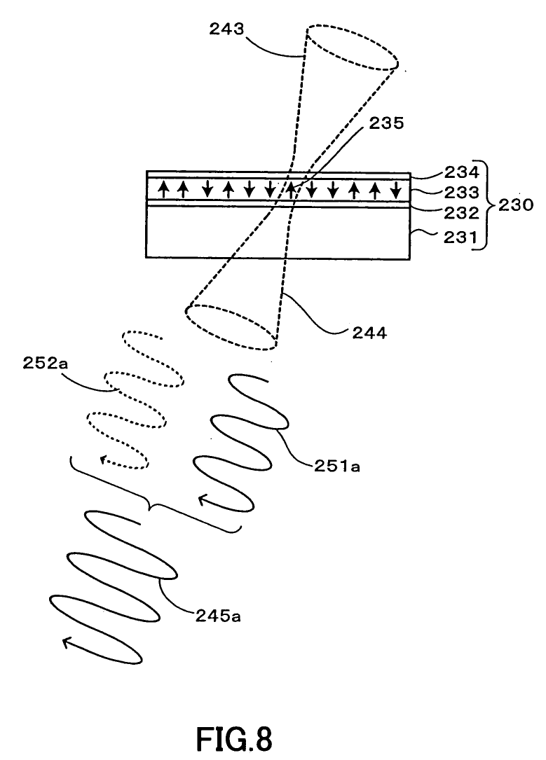

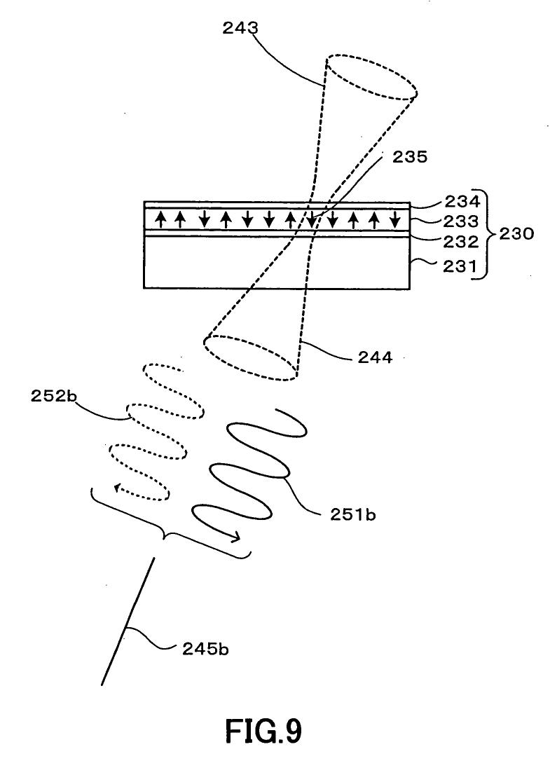

(1) In FIGS. 8 and 9, which are partial enlarged side views showing the state of information reproduction from the optical recording and/or reproducing medium 230, the light beam 243 is converged in a different location within the layer of the ferroelectric recording medium 233 having a different direction of the residual polarization 235. The light beam 243 contains both the fundamental wave component for reproduction and the harmonic component for reference, as explained previously.

(2) By the fundamental wave component for reproduction in the light beam 243 being converged on the layer of the ferroelectric recording medium 233, optical harmonics for reproduction are generated from the layer of the ferroelectric recording medium 233. These optical harmonics for reproduction are of different phase in association with the direction of the residual polarization 235 of the layer of the ferroelectric recording medium 233.

The result is that not only the fundamental wave components for reproduction but also the harmonics component for reproduction 251 (251a, 251b) and the harmonics components for reference 252 (252a, 252b) are contained in the light beam 244 radiated from the layer of the ferroelectric recording medium 233.

(3) As the light beam 244 traverses the wavelength filter 217, the fundamental wave component, contained in the light beam 244, is removed. The result is that only the harmonics component for reproduction 251 and the harmonics component for reference 252 are contained in the light beam 245 (245a, 245b) which has traversed the wavelength filter 217. In the light beam 245, the phase information of the harmonics component for reproduction 251 is converted into the light intensity information by the interference of the harmonics component for reproduction 251 and the harmonics component for reference 252.

In FIG. 8, the harmonic component for reproduction 251a is in phase with the harmonic component for reference 252a, so that the light beam 244a represents a light beam in which the harmonic component for reproduction 251a and the harmonic component for reference 252a strengthen each other.

Conversely, in FIG. 9, in which the harmonic component for reproduction 251b is anti-phase with the harmonic component for reference 252b, the light beam 244b represents a light beam in which the harmonic component for reproduction 251b and the harmonic component for reference 252b weaken each other.

This light beam 244 is converged by the converging lens 218 to fall as light beam 246 on the detector 219 where its intensity is detected. The result is that the light intensity signal output from the detector 219 can be used as a reproducing signal for reproducing the recording on the optical recording and/or reproducing medium 230.

The information may be reproduced from the optical recording and/or reproducing medium 230 based on the intensity of the light beam 246 being changed in association with the direction of the residual polarization 235 of the layer of the ferroelectric recording medium 233.

C. Phase Matching

For generating harmonics of a sufficient strength from the optical recording and/or reproducing medium 230, phase matching is crucial.

That is, due to the difference in wavelength between the fundamental wave and harmonics, it is customary that the fundamental wave and harmonics differ from each other in the refractive index in the layer of the ferroelectric recording medium 233, that is in the phase velocity (wavelength dispersion of the refractive index). Due to this difference in the phase velocity, the two harmonics produced from respective different sites of the fundamental wave traversing the layer of the ferroelectric recording medium 233 become larger in phase difference with increasing distance, such that, when the distance becomes larger than the so-called coherent length, the respective phases are inverted, with the two harmonics cancelling each other.

The technique of achieving phase matching between the fundamental wave and the harmonics to realize harmonics of a sufficient intensity is now explained. There are two sorts of phase matching, namely the angular matching of inputting the fundamental wave with an offset by a preset angle from the crystal axis of the layer of the ferroelectric recording medium layer 233 and the phase matching control for preventing the angular matching state from being annulled due to variations in temperature or in wavelength of the light source 211.

(1) Angular Matching

In the angular matching, the refractive index of the light of excitation (fundamental wave) is brought into coincidence with that of the optical harmonics, using double refraction proper to the layer of the ferroelectric recording medium 233.

The light beam incident on a medium exhibiting double refraction is propagated as it is separated into the ordinary light and the extraordinary light. While the ordinary light is not changed in refractive index with its direction of propagation, that is the angle of incidence, the extraordinary light is changed in its refractive index with its direction of propagation. In the angular matching, the angle of incidence dependency of the refractive index of the extraordinary light is exploited to bring the refractive index of the light of excitation into coincidence with that of the harmonics.

Meanwhile, the relationship between the refractive index and the direction of propagation of the ordinary light and the extraordinary light is reproduced by so-called refractive index ellipsoids.

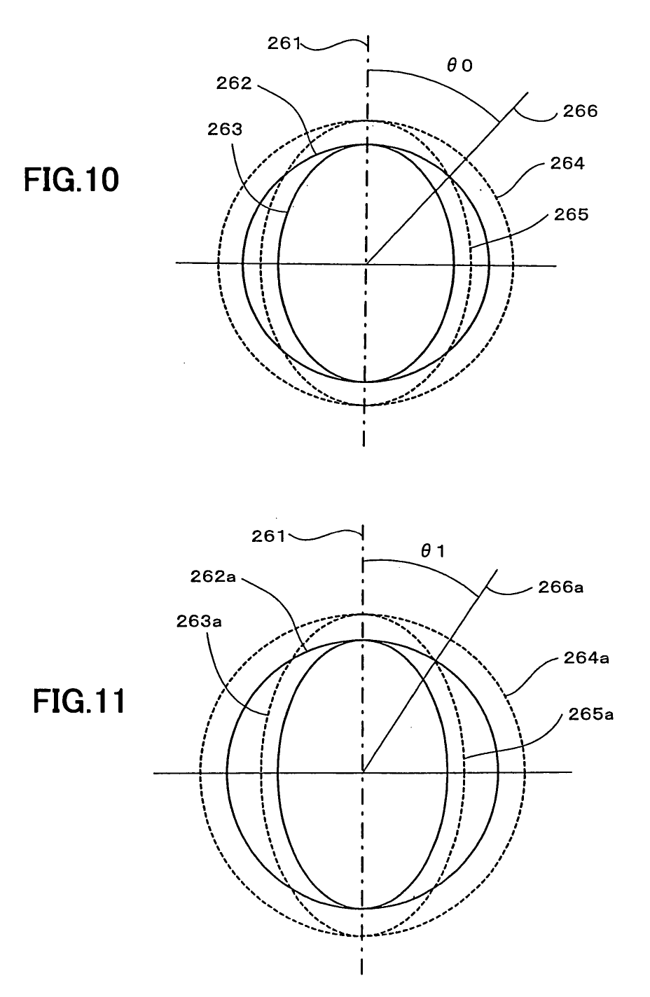

FIG. 10 schematically shows such refractive index ellipsoid in the layer of the ferroelectric recording medium 233. An ordinary light refractive index ellipsoid 262, an extraordinary light refractive index ellipsoid 263 for the light of excitation, an ordinary light refractive index ellipsoid 264 and an extraordinary light refractive index ellipsoid 265 for optical harmonics, are shown with respect to a crystal axis 261. FIG. 10 shows, in a plan view containing the optical axis, the refractive indices for the angle (direction of propagation) of the ordinary light and the extraordinary light of the light of excitation for reproduction and optical harmonics, on the assumption that the layer of the ferroelectric recording medium 233 is a negative uniaxial crystal. Meanwhile, since the layer of the ferroelectric recording medium 233 is a uniaxial crystal, the refractive index ellipsoids are rotation-symmetrical with respect to the crystal axis 261.

A phase matching direction 266 is the direction of the azimuthal angle è from the crystal axis 261, and denotes the direction of intersection of the ordinary light refractive index ellipsoid 262 of the light of excitation and the extraordinary light refractive index ellipsoid 265 of the optical harmonics, that is the direction in which the refractive index of the ordinary light of light of excitation coincides with that of the extraordinary light of the optical harmonics.

That is, the light of excitation propagated in the phase matching direction 266 (extraordinary light) has the same refractive index as that of the optical harmonics (ordinary light) generated on the basis of this light of excitation. So, the ordinary light components of the optical harmonics generated in respective portions in the layer of the ferroelectric recording medium 233 by the extraordinary light components of the light of excitation being propagated are phase-matched relative to one another, such that there is no risk of attenuation by phase interference.

Thus, the extraordinary light component of the light of excitation and the ordinary light component of the optical harmonics are used, and the angle of incidence of the light of excitation is controlled, in order to achieve phase matching between the light of excitation and the harmonics (angular matching).

For example, if the crystal axis 261 of the layer of the ferroelectric recording medium 233 coincides with the direction of a normal line to the surface of the layer of the ferroelectric recording medium 233, the angle θ shown in FIG. 5 is adjusted so that the extraordinary light component will be propagated from the light of excitation in the azimuthal angle θ₀.

In the foregoing, the extraordinary light component of the light of excitation and the ordinary light component of the optical harmonics are used. However, which of the ordinary light component and the extraordinary light component of the light of excitation and the optical harmonics is to be used may be varied depending on the sign of the optical characteristics of the crystal or on the sign of the wavelength dispersion of the refractive index.

(2) Control of the Phase Matching State

When the light of excitation and the optical harmonics are phase-matched by angular matching, it may be an occurrence that the wavelength of the light of excitation be changed in the light source 21 or the refractive index of the layer of the ferroelectric recording medium 233 be changed with temperature.

In this case, the direction of phase matching 266, for which the refractive index of the extraordinary light component of the light of excitation is coincident with that of the ordinary light component of the optical harmonics, is changed. As a result, the optical harmonics are attenuated by phase interference of harmonics generated at different locations (cancellation of the phase matching state).

For preventing the matched state from being annulled by changes in the wavelength or in the refractive index, the phase matched state is detected and controlled. The phase matched state is controlled by controlling the refractive index by application of the electrical field to the layer of the ferroelectric recording medium 233.

The phase matched state is detected using intensity signals obtained by the detector 219. This intensity signal is varied depending not only on the intensity of the harmonic components for reproduction 251 but also on the phase thereof, that is on the direction of the residual polarization 235 of the layer of the ferroelectric recording medium 233, as mentioned above. However, since it is common to scan the layer of the ferroelectric recording medium 233 to reproduce the information, it may be conjectured that the intensity of the reproduction signal, represented by an intensity signal, obtained on averaging over a preset time period, depends on the good or bad state of the phase matching.

It is also possible to obtain intensity signals, representing the intensity of the harmonic components for reproduction 251, using a light beam containing only the harmonic components for reproduction 251 (not containing the harmonic component for reference 252). For example, except if the light beam 241 traverses the optical component 213 of FIG. 5, the harmonic component for reference 252 is not produced, such that the intensity of the harmonic components for reproduction 251 can be detected by the detector 219.

The phase matching state can also be detected based on the degree of variations in the intensity signals caused by changes in the phase of the harmonic component for reference 252. That is, if the intensity signals are not changed despite changes in the phase of the harmonic component for reference 252, it may be surmised that the harmonic components for reproduction 251 are low in intensity, that is that the phase matching state has been annulled. Conversely, if the latitude of variations of the intensity signals from the detector 219 responsive to phase changes in the harmonic component for reference 252, is of a large value, it may be surmised that the phase matching state is optimum.

A signal generated in the layer of the ferroelectric recording medium 233 for representing the intensity of the optical harmonics, such as intensity signals output from the detector 219 (the signal indicating the degree of the phase matching state), is amplified by a signal amplifier 220 and input to an automatic power controller 221. This automatic power controller 221 controls the voltage applied to the electrodes 232, 234, that is the electrical field applied to the layer of the ferroelectric recording medium 233, based on the signal representing the degree of the phase matching state. If the phase matching state is varied due to this application of the electrical field, the variations in the phase matching state are again reflected in the intensity signals from the detector 219 and input to the automatic power controller 221. That is, this control is a sort of feedback control.

When the electrical field is applied to the layer of the ferroelectric recording medium 233, the refractive index of the layer is changed under the electro-optical effect, as a result of which the phase matching state is controlled as will be explained subsequently.

The direction of phase matching 266 cathode active material may be maintained constant by suitably setting the relationship between the intensity signal input to the automatic power controller 221 and an output voltage, that is a sort of feedback coefficient. The result is the stabilized intensity of the harmonic components for reproduction 251.

In the following, it is shown that the phase matching state can be controlled by applying an electrical field to the layer of the ferroelectric recording medium 233. To this end, it is only necessary to indicate that the direction of phase matching 266 is changed by applying the electrical field to the layer of the ferroelectric recording medium 233.

a. Application of an Electrical Field in the Direction of the Crystal Axis 261

FIG. 11 shows a refractive index ellipsoid in case the electrical field is applied in a direction parallel to the crystal axis 261 of the layer of the ferroelectric recording medium 233, as an example. If the crystal axis of the layer of the ferroelectric recording medium 233 is parallel to the direction of a normal line to the planar surface of the layer of the ferroelectric recording medium 233, an electric field can be applied along the crystal axis 261 by application of a voltage to the electrodes 232, 234 formed on the front and back sides of the layer of the ferroelectric recording medium 233, as shown in FIG. 5.

In FIG. 11, the ellipticity of each of the extraordinary light refractive index ellipsoids 263a, 265a of the light of excitation and the optical harmonics is changed as a result of application of the electrical field in a direction parallel to the crystal axis 261. Since the direction of the crystal axis 261 at this time coincides with the direction of application of the electrical field, optical uniaxial properties are maintained unchanged.

It may be seen that, as a result of such changes in the refractive index, caused by the application of an electrical field, the direction of phase matching 266a (with the azimuthal angle of è0), in which the refractive index of the ordinary light of the light of excitation for reproduction coincides with that of the extraordinary light of the optical harmonics, is changed from the direction of phase matching 266 of FIG. 10 (with the azimuthal angle of è0).

The refractive index ellipsoids, shown in FIGS. 10 and 11, are rotation-symmetrical with respect to the crystal axis 261, such that the phase matching directions 266 and 266a are prescribed by solely the azimuthal angles è0 and è1 with respect to the crystal axis 261. That is, the state of phase matching is maintained even if the ellipsoids are rotated freely about the crystal axis 261 as the axis of rotation.

That is, if the crystal axis 261 is coincident with the direction of the normal line to the surface of the optical recording and/or reproducing medium 230, the recordings may be reproduced as the optical recording and/or reproducing medium 230 is rotated in FIG. 1.

b. Application of an Electrical Field in a Direction Different from the Direction of the crystal Axis 261

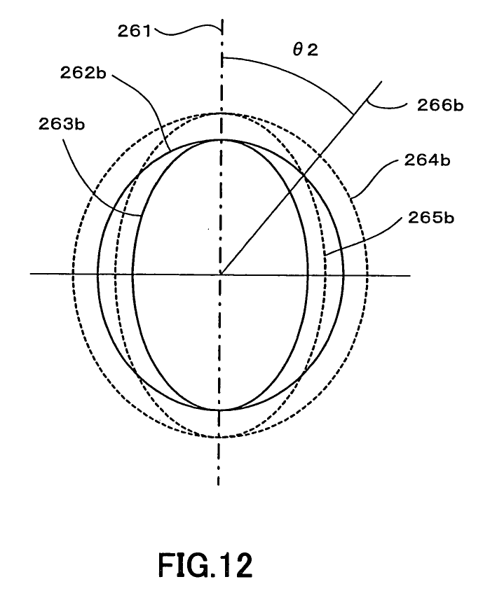

FIG. 12 is a schematic view showing a refractive index ellipsoid in case an electrical field of an optional direction is applied to the uniaxial crystal shown in FIG. 10. By applying an electrical field to a uniaxial crystal in an optional direction, optical biaxial properties are afforded, that is uniaxial symmetry of the refractive index ellipsoid is collapsed, thus producing birefringence within the plane perpendicular to the crystal axis, as in the case of a biaxial crystal. FIG. 12 illustrates the relationship between the direction of light propagation and the refractive index in a plane including the crystal axis 261 and a preset axial direction within a plane perpendicular to the crystal axis 261.

There are shown, with respect to the crystal axis 261, an ordinary light refractive index ellipsoid 262b and an extraordinary light refractive index ellipsoid 263b of the light of excitation and an ordinary light refractive index ellipsoid 264b and an extraordinary light refractive index ellipsoid 265b of the optical harmonics. It should be noted that the phase matching direction 266b represents the direction of the azimuthal angle è2 of intersection of the plane of the ordinary light refractive index ellipsoid 262b of the light of excitation and that of the extraordinary light refractive index ellipsoid 265b of the optical harmonics, that is the direction of coincidence of the refractive index of the ordinary light of the light of excitation for reproduction and the refractive index of the extraordinary light of the optical harmonics, and is different from the phase matching direction 266 in FIG. 10.

Meanwhile, with the ordinary light refractive index ellipsoids 262b and 264b in FIG. 12, the refractive index is changed with the direction of propagation, and hence these ellipsoids denote extraordinary light refractive index ellipsoids. However, these ellipsoids are termed ordinary light refractive index ellipsoids in consideration of contrast with FIGS. 10 and 11. That is, in a crystal afforded with optical biaxial properties, the incident light is propagated as it is separated into two extraordinary light rays, there being no ordinary light exhibiting constant refractive index without dependency upon the direction of propagation.

With the refractive index ellipsoid, shown in FIG. 12, rotation symmetry about the crystal axis 261 is not assured. Thus, in phase matching and its control, the direction of propagation of optical harmonics is prescribed as both the direction of the crystal axis 261 and the direction of applying the electrical field are taken into consideration. That is, the angle of light incidence is preferably determined with respect to these two axial directions.

(Other Configurations)

In the above embodiment, an electrical field is applied to the layer of the ferroelectric recording medium to change its refractive index to control the phase matching state, under the presupposition that the angular matching has been achieved. That is, the angular matching and application of an electrical field play the role of rough adjustment and fine adjustment of the phase matching, respectively.

Alternatively, the phase matching may be realized by solely applying the electrical field to the layer of the ferroelectric recording medium without undertaking the angular matching.

Although the intensity of the detection light is made constant in the above embodiment, the detection light intensity may also be changed arbitrarily.

Plural layers of the ferroelectric recording medium may be provided on the optical recording and/or reproducing medium to achieve information recording in multiple layers. In such case, it is desirable to provide electrodes between respective layers of the ferroelectric recording medium to apply an electrical field across the respective layers.

The optical recording and/or reproducing mediums, explained in the above embodiment, may be an optical disc or an optical card, only by way of illustration.

[Third Embodiment]

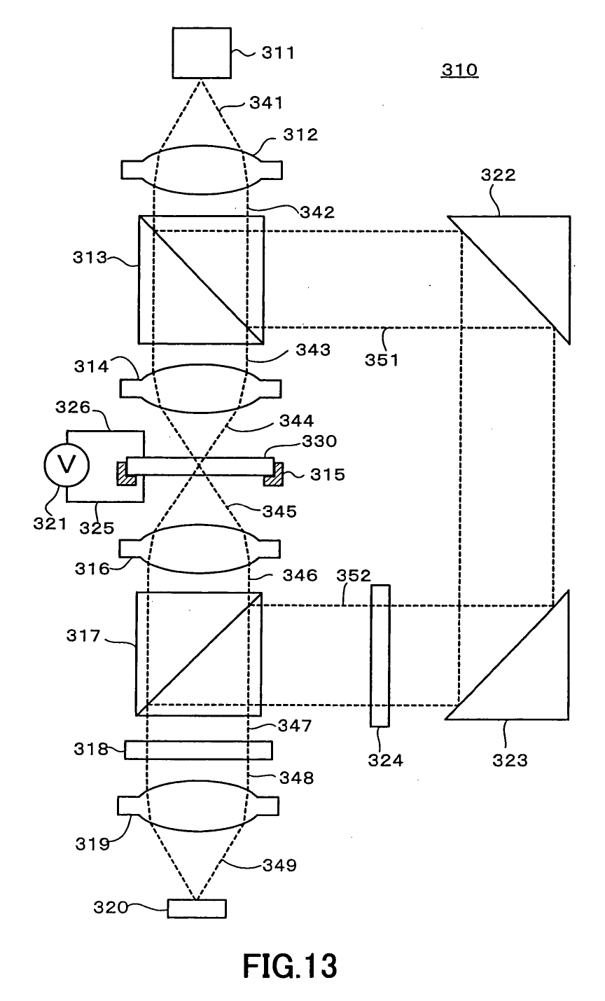

FIG. 13 is a schematic view showing an optical recording and/or reproducing apparatus 310 according to the present invention.

Referring to FIG. 13, the optical recording and/or reproducing apparatus 310 is made up by a light source 311, collimator lenses 312, 316, deflection components 313, 317, converging lenses 314, 319, a stage 315 on which to set an optical recording and/or reproducing medium 330, a wavelength filter 318, a photodetector 320, a power supply 321, light beam deflection mirrors 322, 323 and a harmonics generating member 324. The power supply 321 is electrically connected to the optical recording and/or reproducing medium 330 through electrical paths (electrical lines) 325, 326.

(Detailed Structure of the Optical Recording and/or Reproducing Medium)

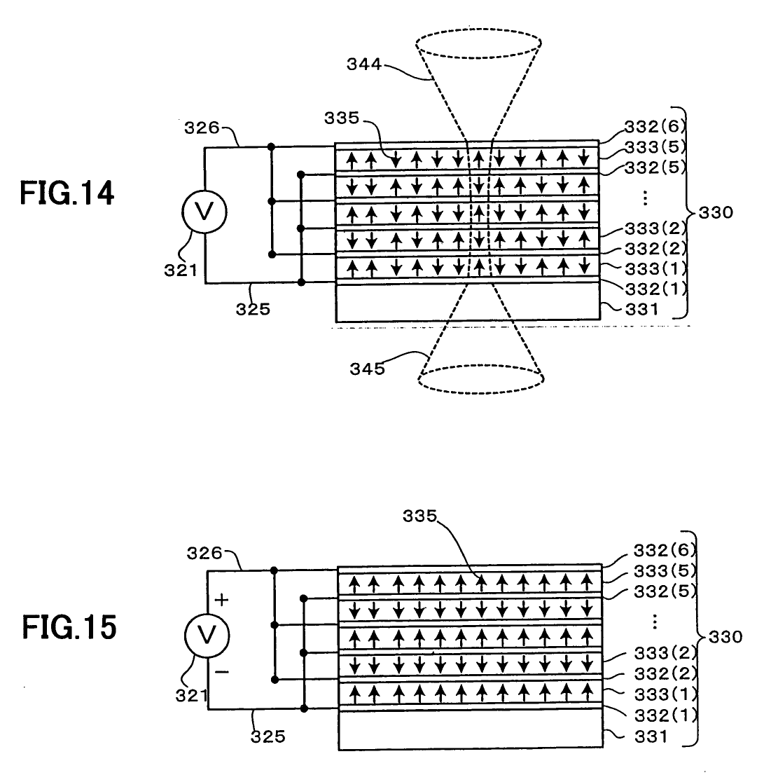

FIG. 14 is a schematic view showing details of the optical recording and/or reproducing medium 330, the power supply 321 and the vicinity.

Referring to FIG. 14, the optical recording and/or reproducing medium 330 is made up by a substrate 331, plural electrodes 332 (332(1) to 332(6)) and plural layers of the ferroelectric recording medium 333 (333(1) to 333(5)). Each layer of the ferroelectric recording medium 333 includes residual polarizations 335, the directions of polarization of which are inverted from one layer to the next in the vertical direction and has its both surfaces sandwiched by the electrodes 332.

The electrodes 332(1), 332(3) and 332(5) and the electrodes 332(2), 332(4) and 332(6) are interconnected and electrically connected to the power supply 321 through electrical lines 325 and 326.

The material forming the layer of the ferroelectric recording medium 333 is the same as that of the above-described embodiments.

For preventing phase interference between optical harmonics produced from various locations in the inside of each layer of the ferroelectric recording medium 333, the thicknesses of the respective layer of the ferroelectric recording medium 333 are preferably equal to or less than the coherence length Lc. This coherence length Lc is determined by the wavelength λ of the light source 311 and by the refractive indices n^{(ω)} and n^{(2ω)} of the layer of the ferroelectric recording medium 333 for the fundamental wave and the Lc harmonics, respectively, in accordance with the following equation (1):

Lc=λ/[4Δn]=λ/[4(n^{(2ω)}−n^{(ω)}]

By stacking plural layers of the ferroelectric recording medium 333, each being not larger than the coherent length Lc in thickness, and by inverting the residual polarizations 335 alternately from one layer to the next (structure of polarization inversion), phase matching can be achieved to produce harmonics of sufficient intensity, as will be explained subsequently in detail.

The electrode 332 applies an electrical field for initialization and signal recording to the layers of the ferroelectric recording medium 333.

For the electrode 332, an electrically conductive transparent electrode of, for example, ITO (indium tin oxide) may be used. A thin dielectric film, as an anti-reflection film, may be formed on the surface of the electrode 332, for use as an optical multi-layered film, to improve the light transmittance within such an extent as not to deteriorate electrical performance of the electrode 332.

(Detailed Structure of the Optical Recording and/or Reproducing Apparatus)

The light source 311 is e.g., a semiconductor laser and radiates a light beam 341 (wavelength: λ) for optical recording and/or reproduction to the optical recording and/or reproducing medium 330.

The collimator lenses 312, 316 collimate the light beams 341, 345 to form collimated light beams 342, 346.

The deflection components 313, 317 separate the light beam 342 into light beams 343, 351, while combining the light beams 342, 346 into a light beam 347.

The converging lenses 314, 319 converge the light beams 343, 348 to generate light beams 344, 349.

The optical recording and/or reproducing medium 330 is set on the stage 315 and is thereby rotated as necessary.

The wavelength filter 318 absorbs the light of excitation emanating from the light source 311 to separate optical harmonics.

The photodetector 320 outputs an intensity signal corresponding to the intensity of the optical harmonics separated by the wavelength filter 318.

The power supply 321 generates a voltage for applying an electrical field for initialization and recording to the layer of the ferroelectric recording medium 333.

The light beam deflection mirrors 322, 323 change the direction of the light beam 351.

The harmonics generating member 324 generates the harmonics for reference, from a light beam 351, incident thereon, to radiate a light beam 352 containing this harmonics for reference.

(Operation of Optical Recording and/or Reproducing Apparatus)

The operation of the optical recording and/or reproducing apparatus 310 is now explained. The optical recording and/or reproducing apparatus 310 initializes the optical recording and/or reproducing medium 330 and records and/or reproduces the information.

The method of initializing the optical recording and/or reproducing medium 330 and of recording and/or reproducing the information is hereinafter explained.

A. Initialization of Optical Recording and/or Reproducing Medium 330

Before recording the information on the optical recording and/or reproducing medium 330, the optical recording and/or reproducing medium 330 is initialized.

FIG. 15 is a cross-sectional view showing the state of initializing the optical recording and/or reproducing medium 330.

By the power supply 321, an electrical field larger than the anti-electric field necessary for inverting the residual polarization 335 is applied to each of the layers of the ferroelectric recording medium 333. As a result, the residual polarization 335 of each of the stacked layers of the ferroelectric recording medium 333 is aligned in keeping with the direction of the electrical field. This aligned state of the dielectric polarization is maintained unchanged even after cessation of application of the electrical field.

Since an electrical field having its direction inverted alternately from one layer of the ferroelectric recording medium 333 to the next in the vertical direction, there is produced a polarization inverting structure of the residual polarizations 335.

B. Recording the Information on the Optical Recording and/or Reproducing Medium 330

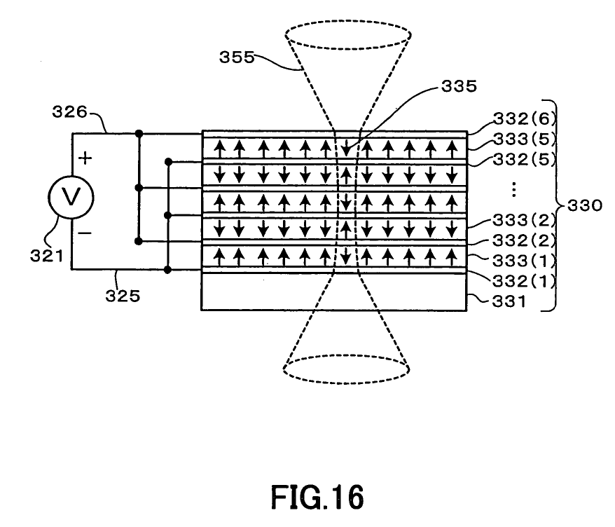

FIG. 16 shows a cross-sectional view illustrating the state of recording the information on the optical recording and/or reproducing medium 330.

To the layer of the ferroelectric recording medium 333, there is applied, by the power supply 321, an electrical field inverted in its direction from one layer to the next in the vertical direction and which is smaller than the anti-electrical field. In FIG. 16, positive and negative voltages are supplied to the electrical lines 325, 326 to apply an electrical field in a direction which reverses the residual polarization 335 from the initialized state of FIG. 15. The direction of applying this voltage or the electrical field is changed depending on the ‘0’ or ‘1’ of the information bit to be recorded.

A light beam 351 for information recording is converged on the optical recording and/or reproducing medium 330. The light beam 351 is locally illuminated on corresponding sites (recording sites) of the layers of the ferroelectric recording medium layers 333(1) to 333(5). Meanwhile, the light beam 351 may be illuminated using a light source 311 or a light source for information recording different from the light source 311.

By the light beam 351 being converged on a recording site of the layer of the ferroelectric recording medium 333, the recording site is locally heated, as a result of which the anti-electric field is lowered at the recording site to invert the residual polarization 335.

If, as the residual polarization 335 has been inverted, the illumination of the light beam 351 is halted, the temperature of the recording site is lowered, with the residual polarization 335 thereat remaining inverted.

The information is recorded in this manner on the optical recording and/or reproducing medium 330 in the form of the direction of the residual polarization 335.

C. Reproduction of the Information from the Optical Recording and/or Reproducing Medium 330

Referring to the drawings, reproduction of the information from the optical recording and/or reproducing medium 330 is hereinafter explained.

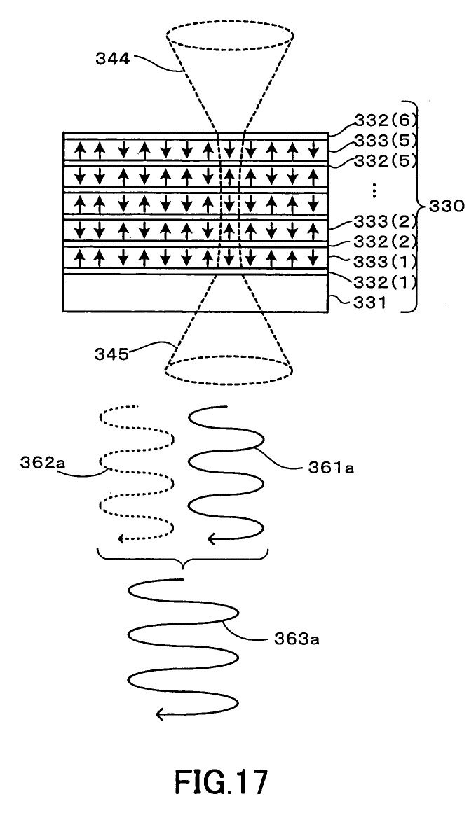

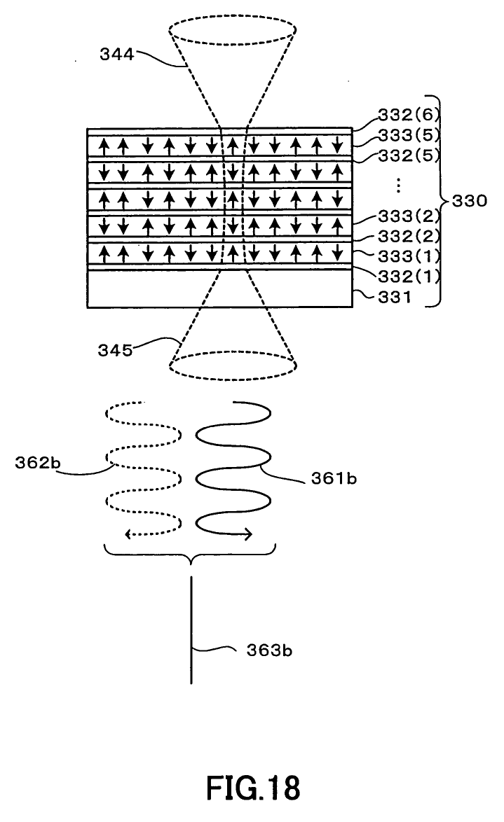

FIGS. 17 and 18 are schematic views showing the state of reproducing the information from the optical recording and/or reproducing medium 330, and illustrate states in which the light beam 344 for reproduction has been converged in the recording sites where the direction of the residual polarization 335 in the layer of the ferroelectric recording medium 333 has been reversed from one state to the next.

(1) In each of the layers of the ferroelectric recording medium 333, stacked together, optical harmonics are excited by the reproducing light beam 344.

Since the thickness of the layer of the ferroelectric recording medium 333 is equal to or smaller than the coherence length Lc, the optical harmonics generated in the inside of the respective layers of the ferroelectric recording medium 333 do not weaken one another. As a result, individual optical harmonics are radiated from the respective layers of the ferroelectric recording medium 333.

(2) These respective individual harmonics have been generated by the light of excitation for reproduction being propagated through the respective stacked layers of the ferroelectric recording medium 333. It may be an occurrence that the phase difference is produced due to difference between the refractive index of the light of excitation and that of the harmonics.

On the other hand, the optical harmonics are reversed in phase due to the direction of polarization of the residual polarization 335.

The result is that the phase difference of the individual optical harmonics produced by the difference in the refractive index is cancelled by the inversion of the residual polarizations 335 in the layers of the ferroelectric recording medium 333, such that the individual optical harmonics strengthen one another and summed together to form optical harmonics 361a, 361b for reproduction.

The phases of the optical harmonics 361a, 361b for reproduction are determined by the state of the residual polarization 335 of the layers of the ferroelectric recording medium 333. In the sites where the light beams have been converged in FIGS. 17 and 18, the direction of the residual polarization 335 is reversed in FIGS. 17 and 18. Consequently, the optical harmonics 361a, 361b for reproduction are reversed in phase relative to each other and radiated in this state from the optical recording and/or reproducing medium 330.

By this polarization reversed structure of the layers of the ferroelectric recording medium 333, the optical harmonics 361a, 361b for reproduction, having the phase corresponding to the directions of the residual polarizations 335 of the layers of the ferroelectric recording medium 333, may be produced.

(3) The optical harmonics 361a, 361b for reproduction are combined by the deflection component 317 with the harmonics for reference 362a, 362b contained in the light beam 352 to form interference light beams 363a, 363b, respectively. As a result, the phases of the optical harmonics for reproduction 361a, 361b can be detected based on the intensity of the interference light beams 363a, 363b.

That is, the light beam 347, containing the interference light beams 363a, 363b along with the light of excitation for reproduction, is transmitted through the wavelength filter 318 to remove the light of excitation for reproduction, and the resulting light beam is caused to fall on the photodetector 220 by the converging lens 319, to produce intensity signals proportionate to the intensity of the interference light beams 363a, 363b.

In this manner, the information recorded as the direction of polarization of the layers of the ferroelectric recording medium 333 may be reproduced as intensity signals from the photodetector 320.

Thus, by using polarization inversion, the optical harmonics can be increased in intensity, without causing the excitation light beam to fall obliquely relative to the optical axis of the layers of the ferroelectric recording medium 333 by way of performing so-called angular matching.

The information can be recorded by controlling the residual polarizations 335 in the layers of the ferroelectric recording medium 333, while the information can be reproduced by comparing the phase of the optical harmonics for reproduction generated from the layers of the ferroelectric recording medium 333 to the optical harmonics for reference.

The recording and reproduction of the information are performed in this case with stacked medium layers, corresponding to the stacked layers of the ferroelectric recording medium 333, as a compact unit.

(Other Configurations)

In the above-described embodiment, the optical path generated by the optical harmonics for reference 362 for phase comparison is separated from the optical path generated by the optical harmonics for reproduction 361. Alternatively, the optical harmonics for reference 362 and the optical harmonics for reproduction 361 may be generated on the same optical path. It is sufficient in this case if the harmonics generating member 324 is arranged in place of, for example, the deflection component 313, with the deflection component 317 being then omitted.

In the above embodiment, the optical path from the light source 311 to the photodetector 320 is formed in its entirety by a light transmitting optical path. Alternatively, a reflection optical path may also be provided for reflecting the harmonics generated from the layers of the ferroelectric recording medium 333.

In the above embodiment, five layers of the ferroelectric recording medium 333 are used. Alternatively, two or more layers or a sole layer may be used.

It is also possible to stack more layers as the stacked medium layers, as units of information recording and reproduction, with the respective layers then being responsible for information recording and reproduction to increase the recording capacity of the optical recording and/or reproducing medium 330.

Meanwhile, the optical recording and/or reproducing mediums, explained in the above embodiment, may be an optical disc or an optical card, only by way of illustration.

[Fourth Embodiment]

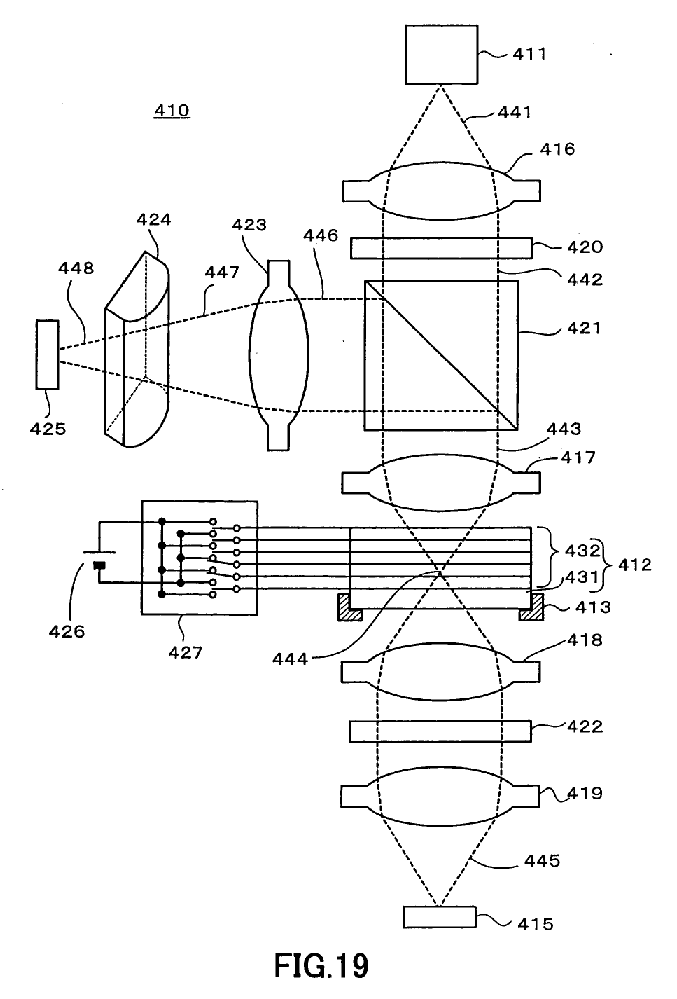

FIG. 19 is a schematic view showing an optical recording and/or reproducing apparatus 410 according to the present invention.

Referring to FIG. 19, the optical recording and/or reproducing apparatus 410, embodying the present invention, includes a light source 411, a stage 413, on which to set an optical recording and/or reproducing medium 412, responsible for optical recording and/or reproduction, a photodetector 415, collimator lenses 416, 418, converging lenses 417, 419, a polarizer 420, an optical path branching optical component 421, a color separation filter 422, a focal point detecting converging lens 423, a cylindrical lens 424, a focal point detecting photodetector 425, a power supply 426 and a layer switching device 427.

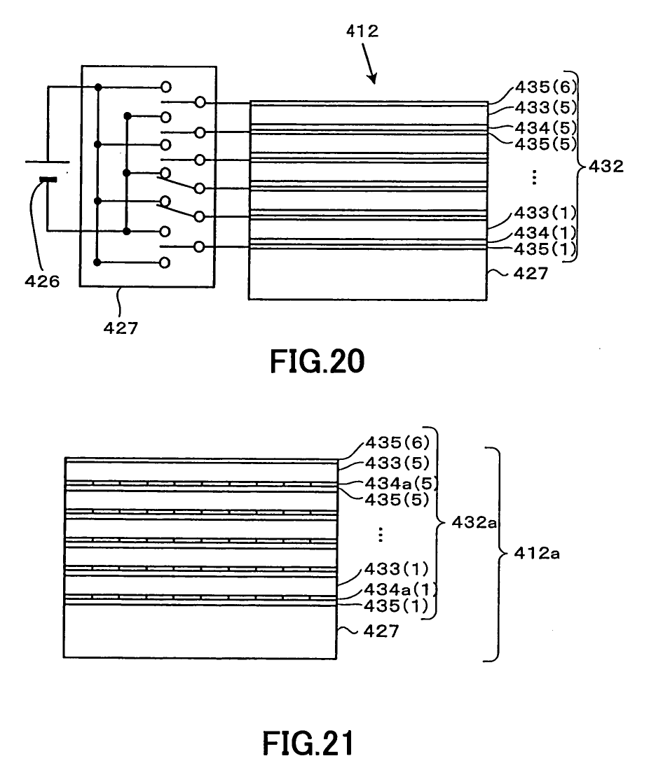

FIG. 20 is a cross-sectional view showing the optical recording and/or reproducing medium 412, a power supply 426 and the layer switching device 427. Referring to FIGS. 19 and 20, the optical recording and/or reproducing medium 412 is made up by a substrate 431 and an optical recording and/or reproducing medium 432 formed on the substrate 431. On the optical recording and/or reproducing medium 432 are further formed medium layers 433(1) to 433(5), light polarizing semi-transmitting layers 434(1) to 434(5) and electrodes for application of an electrical field 435(1) to 435(6).

(Details of Structure of Optical Recording and/or Reproducing Apparatus)

The light source 411 is e.g., a semiconductor laser and radiates a light beam 441 (with a wavelength of λ) for optical recording and/or reproduction of the optical recording and/or reproducing medium 412.

The stage 413 may be rotated along with the optical recording and/or reproducing medium 412 set thereon.

The photodetector 415 operates as reproducing means which, by detecting the volume of an incident light beam 445, outputs reproducing signals from the optical recording and/or reproducing medium 412.

The collimator lenses 416, 418 collimate the light beam to a parallel light beam. The converging lenses 417, 419 operate as light beam converging means. The light beam 441, radiated from the light source 411, is converged by the converging lens 417 on the medium layer 433(i) to form a converged light beam 444. By a movement mechanism, not shown, causing the movement of the converging lens 417, the converged position (focussed position) of the converged light beam 444 can be suitably swept along the layering direction and along the planar direction of the medium layer 433.

The polarizer 420 operates as polarizing means for aligning the direction of polarization of the light beam 441. Meanwhile, if the light source 411 is the semiconductor laser, the polarizer 420 can be omitted, because the light beam 441 from the light source 411 is already of characteristics close to those of the linear polarization.

The optical path branching optical component 421 is a so-called beam splitter and branches the light beam reflected from the light polarizing semi-transmitting layer 434 towards the focal point detecting photodetector 425 to form a light beam 446 as will be explained subsequently.

The color separation filter 422 absorbs the light of the wavelength λ (fundamental wave) radiated from the light source 411 to separate harmonics with a wavelength λ/2.

The focal point detecting converging lens 423, cylindrical lens 424 and the focal point detecting converging lens 425 are constituent elements that make up layer detection means adapted for discriminating the respective medium layers 433(i).

The focal point detecting converging lens 423 is converging means for converging the light beam 445 on the focal point detecting converging lens 425.

The cylindrical lens 424 affords astigmatism to the light beam 446 which has traversed the focal point detecting converging lens 423. This astigmatism is brought about by the cylindrical lens 424 converging the light only in a direction perpendicular to the cylinder axis without converging the light along the cylinder axis. The result is that the shape of the light beam 448 incident on the focal point detecting converging lens 425 is elliptical or circular. This shape is changed in keeping with the converging position of a converged light beam 443.

The focal point detecting converging lens 425 is a set of, for example, four photodetectors. By addition and subtraction of the outputs of these photodetectors, a signal corresponding to the shape of the light beam 448, that is a focussing error signal corresponding to the focal point position of the light beam 444 along the layered direction is output. The respective medium layers 433(i) can be discriminated based on this focussing error signal.

A power supply 426 applies an electrical field across electrodes for application of the electrical field 435. The layer switching device 427 is a changeover switch for selecting the medium layer 433, to which an electrical field is applied, responsive to a current supply command signal from outside. In FIG. 20, an electrical field is applied to the medium layer 433(2) by selecting the electrodes for application of the electrical field 435(2) and 435(3) and by applying the electrical field to the so selected electrodes.

(Detailed Structure of the Optical Recording and/or Reproducing Medium)

The substrate 431 is an optically transparent substrate for holding the layered recording and/or reproducing medium 432.

The medium layers 433 is formed of an optical material having optically sufficient ratio of light transmission (transmittance) with respect to the light beams from the light source 411 with wavelengths λ and λ/2.

Meanwhile, each medium layer 433 is preferably of a thickness equal to or less than the coherence length Lc, in order to prevent phase interference of respective optical harmonics emanating from the respective sites within the interior of the medium layer 433 to maintain the intensity of the harmonics.

If the electrical field is applied to the medium layer 433(i) in the layered recording and/or reproducing medium 432, using the electrodes for application of the electrical field 435(i) and 435(i+1), the refractive index is changed in the medium layer 435(i) under the electro-optical effects. Among the electro-optical effects, the Pockels effect is such an effect which brings about changes in the refractive index in proportion to the electrical field applied. The Pockels effect occurs in a so-called piezo-electric material exhibiting no point symmetry, and is applied to, for example, a Pockels cell which controls the ratio of light transmission (light transmittance).

There is no necessity for providing the medium layer 433 in the entire area of the substrate 431 used for recording and/or reproduction. For example, a portion of the area may be used for providing another recording medium for operation as a read-only memory area.

The electrode for application of an electrical field 435 is provided on each of the front and back surfaces of the medium layers 433. An electrical field is applied to the stacked medium layers 433 on application of the potential difference across these electrodes.

The light beam for detection may be utilized effectively by employing a thin film of an optically transparent electrically conductive material, such as ITO (indium tin oxide). The thin film of the transparent electrically conductive material may be formed by for example vapor deposition and sputtering. By providing a dielectric film on the surface of the electrodes for application of the electrical field 435, it is possible to reduce the reflection occurring on the boundary thereof with the medium layers 433 or with air (anti-reflection film).

The polarizing semi-transmitting layer 434, provided on the lower surface of each medium layer 433, is an optical film which reflects a portion of an optionally set polarized light component, transmits the remaining portion thereof and also transmits the polarized light component other than the optionally set polarized light component. Consequently, the reflectance and transmittance are changed depending on the state of polarization of the light beam incident on the polarizing semi-transmitting layer 434.

The polarizing semi-transmitting layer 434 is comprised of a sort of a diffraction grating made up by a large number of thin metal wires arranged parallel to one another on a planar surface. The reflection and transmission characteristics of polarized light components in the directions of polarization parallel to the thin metal wires differ from those in the directions of polarization parallel to the thin metal wires.

The polarizing semi-transmitting layer 434 may be provided with for example a portion having different semi-transmitting characteristics for specifying the signal recording and/or reproducing portion. The signal recording and/or reproducing portion may also be discriminated using the focal point detecting converging lens 425. This is shown in FIG. 21, in which a polarizing semi-transmitting layer 434a includes two alternately arranged areas exhibiting different semi-transmitting characteristics. When viewed in a plan, plural areas having different semi-transmitting characteristics can be arranged in for example a lattice-like pattern.

(Operation of an Optical Recording and/or Reproducing Apparatus)

Referring to the drawings, the operation of the optical recording and/or reproducing apparatus 410 is explained.

A. Detection of the Reproducing Layer and Light Converging Control for the Reproducing Layer

(1) The light beam 441, outgoing from the light source 11, is collimated by the collimator lens 416 into a parallel light beam, which then is passed through the polarizer 420 so as to be thereby turned into linear polarized light. The light beam 442, now in the linear polarized state, is transmitted through the optical path branching optical component 421 and converged by the converging lens 417 to reach the layered recording and/or reproducing medium 432.

An electrical field is applied in this case to an optional one of the medium layers 433 through the power supply 426 and through the layer switching device 427. The light beam transmitted through the medium layer 433(i), to which the electrical field has been applied, is changed in its polarized state, specifically, in the ratio of the polarized light components thereof, under the electro-optical effect.

(2) The polarized light semi-transmitting layer 434(i) is arranged at back of the medium layer 433(i), through which the light beam 444 has traversed, and is set to polarization characteristics such that its reflectance is increased to cope with changes in the polarized component produced due to electrical field application. As a result, part of the light beam 444 is reflected by the polarized light semi-transmitting layer 434(i) provided to the medium layer 433(i), to which the electrical field has been applied.

It is preferred in this case that the component of the reflected light component, ascribable to changes in the polarized state, is made sufficiently larger in quantity than the reflected light component ascribable to the refractive index difference between an other medium layer 433 and an electrode or the polarized light semi-transmitting layer 434, while it is also preferred that the lowering of the intensity of the light transmitted through the polarized light semi-transmitting layer 434 is made small enough not to obstruct information reproduction. This may be realized by suitably setting polarization characteristics of the polarized light semi-transmitting layer 434(i).

(3) The light beam reflected by the polarized light semi-transmitting layer 434(i), to which the electrical field has been applied, is returned through the inside of the medium layer 433(i) in a reverse direction to the direction of the forward optical route, that is in a direction towards the light source 411. At this time, there are produced changes in the polarized state opposite to that produced on the forward optical path. Consequently, re-reflection of the of the light beam reflected by the polarized light semi-transmitting layer 434(i) by the polarized light semi-transmitting layers 434 other than the polarized light semi-transmitting layer 434(i) may be substantially disregarded. That is, the light beam reflected by the polarized light semi-transmitting layer 434(i) undergoes only small lowering in intensity when the reflected light beam is transmitted through the other polarized light semi-transmitting layers 434.

(4) The light beam reflected by the polarized light semi-transmitting layer 434(i) is transmitted through the converging lens 417 and the optical path branching optical component 421 to reach the focal point detecting converging lens 423 to form a converged light beam 447.

By the cylindrical lens 424, arranged in the optical path of the converged light beam 447, astigmatic aberration is produced in the converged light. The focal point detecting converging lens 425, arranged in the vicinity of the focal point of the converged light 447, suffering from the astigmatism, outputs a focussing error signal corresponding to the focal point position of the converged light 444 (detection of the focussing error by an astigmatic method). Using this focussing error signal, the focal point position can be controlled so that the light beam 444 from the light source 411 will be converged on or near the polarized light semi-transmitting layer 434(i), provided to the medium layer 433(i), to which the electrical field has been applied.

By applying the electrical field to an optional medium layer 433(i), the medium layer 433(i) can be discriminated and controlled as being a subject of recording or reproduction.

It should be noted that the ratio of the polarized components in the light beam transmitted through the polarized light semi-transmitting layer 434(i), provided to the medium layer 433(i), to which the electrical field has been applied, may occasionally be changed. The light beam, the ratio of the polarized components of which has been changed, is partially reflected when it has reaches the polarized light semi-transmitting layer 434(i−1) provided to the medium layer 433(i−1) lying below the polarized light semi-transmitting layer 434(i). Moreover, the reflectance of this partial reflection may be of the same order of magnitude as the reflectance by the polarized light semi-transmitting layer 434(i). The result is that the light volume of the light beam 445 reaching the photodetector 415 is lowered to pose a problem when the transmitted light is used for detecting the information signals.

In order to combat this, an electrical field equal in magnitude and opposite in direction to the electrical field applied to the medium layer 433(i) may be applied to the medium layer 433(i−1) lying directly below the medium layer 433(i) to be discriminated or set as a focal point to revert the change in the ratio of the polarized light components to an original value. This allows to suppress reflection at the lower one of the polarized light semi-transmitting layers 434.

However, if the polarized light semi-transmitting layers 434 in their entirety totally reflect the preset polarized light component, the polarized component is not changed in its ratio of the polarized components, so that it is unnecessary to apply to the medium layer 433(i−1) the electrical field equal in magnitude and opposite in direction to the adjacent medium layer 433(i).

By providing a portion different in semi-transmission characteristics in the polarized light semi-transmitting layer 434, and by detecting the difference in the sem-transmission characteristics proper to the light beam 448, reflected by the polarized light semi-transmitting layer 434 so as to be incident on the focal point detecting converging lens 425, it is possible to identify the location of signal recording and/or reproduction on the medium layers 433 used for recording and/or reproduction.

B. Information Reproduction

Information reproduction from the layered recording and/or reproducing medium 432 is carried out using second harmonics (wavelength: λ/2) produced from the light beam of the wavelength λ from the light source 411 as a fundamental wave.

(1) The light beam 41 radiated from the light source 411 is converged by the converging lens 417 on the medium layer 433(i) of the layered recording and/or reproducing medium 432. It is assumed that the information has been recorded in the respective medium layers 433 depending on whether the directions of the residual polarizations of the ferroelectric material are upward or downward.

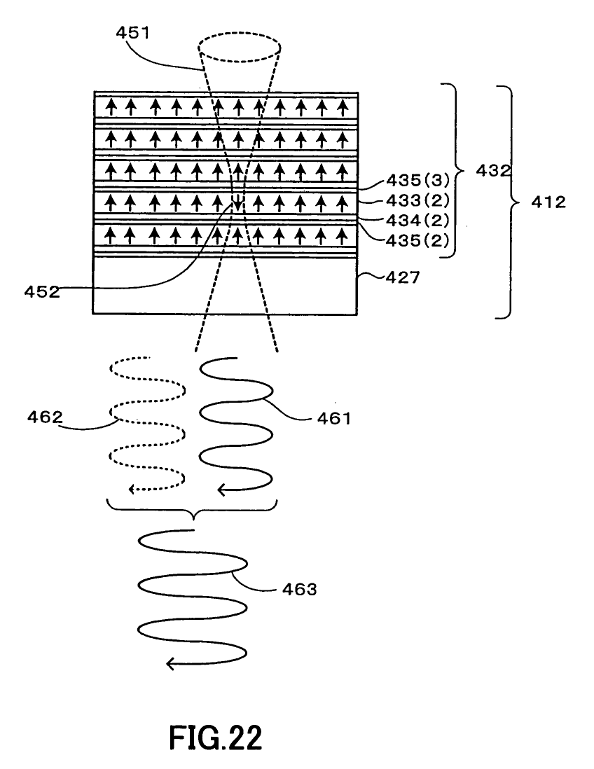

FIG. 22 is a side view showing the state in which a light beam 451 has been converged on the medium layer 433(i) to generate second harmonics 461.

Since the light is converged on the medium layer 433(i), second harmonics 461 are generated in the medium layer 433(i). Since the intensity of the second harmonics 461 depends on the light energy density, occurrence of second harmonics from the medium layers 433 other than the medium layer 433(i) can be discounted, provided that a sufficient amount of light is converged on the medium layer 433(i). The second harmonics 461 are different in phase depending on whether the residual polarization of the converged position is upward or downward. Thus, by detecting the phase of the second harmonics 461, the information optically recorded on the layered recording and/or reproducing medium 432 can be reproduced.

(2) The second harmonics 451, thus produced, are collimated by the collimator lens 418 to traverse the color separation filter 422. This color separation filter 422 absorbs the fundamental wave (light with a wavelength λ illuminated from the light source 411) to separate harmonics 461. The result is that only the harmonics 461 are contained in the light beam 448 converged by the converging lens 419 to reach the photodetector 415.

For detecting the phase of the harmonics 461, it is sufficient if a reference wave 462 of the same wavelength as the harmonics 451 is caused to interfere with the harmonics 461 to generate an interference wave 463, with the light volume of the interference wave 463 then being detected by the photodetector 415. For generating the reference wave 462, it is sufficient if a harmonics generating element, generating harmonics on incidence of a light beam from the light source 411, is inserted on an optical path from the light source 411 to the color separation filter 422, for example, an optical path between the collimator lens 416 and the polarizer 420.

C. Information Recording

The information recording on the layered recording and/or reproducing medium 432 is by light illumination and by application of an electrical field.

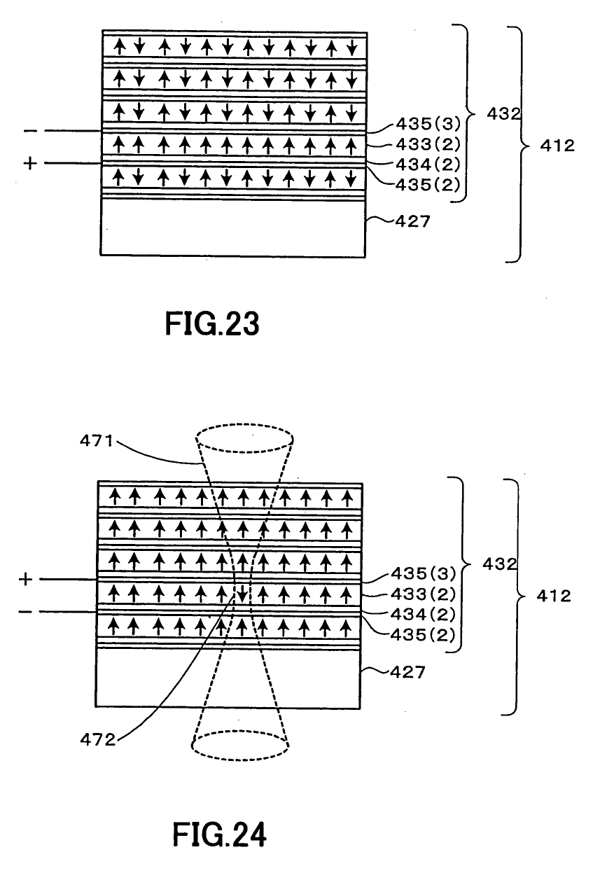

FIGS. 23 and 24 are cross-sectional views showing the state of initializing the layered recording and/or reproducing medium 432 and the state of information recording, respectively.

(1) Before proceeding to information recording, the directions of the residual polarization of the medium layers 433 are aligned. If for example the directions of the residual polarization in the medium layer 433(20 are aligned, a voltage is applied to the electrodes for application of the electrical field 435(2) and 435(3), using the power supply 426 and the layer switching device 427, to apply an electrical field larger than the anti-electric field capable of inverting the residual polarization to the medium layer 433(2).

The result is that the residual polarization aligned to the direction of the applied electrical field is formed. This alignment of the directions of the residual polarization means a sort of initialization of the layered recording and/or reproducing medium 432 and is performed for each of the medium layers 433 as necessary.

For recording (writing) on the initialized medium layer 433(2), the light beam of the light source 411 is converged to a site on which recording is to be made (a preset site in the medium layer 433(2)) as an electrical field in a direction corresponding to the bit desired to be recorded is applied to the medium layer 433(2). The electrical field applied is smaller than the anti-electric field.

Since the electrical field as applied is smaller than the anti-electric field, the direction of the residual polarization is not changed on a site where the light beam is not converged. That is, from the perspective of the information, no bit inversion is produced.

Conversely, on a site where the light beam has been converged, local rise in temperature occurs to lower the anti-electric field, so that the direction of the residual polarization is changed.

Thus, by applying an electrical field smaller than the anti-electric field at ambient temperature, and by effecting local heating, the direction of the residual polarization can be determined.

This converging of the electrical field and the light beam is apparently similar to the operation for layer detection. However, since these two operations are performed for totally different objectives, the electrical filed or the intensity of the light beams suited for these objectives are employed. For writing, as an example, a light source of a wavelength suited to the heating of the medium layers 433 may separately be used.

[Fifth Embodiment]

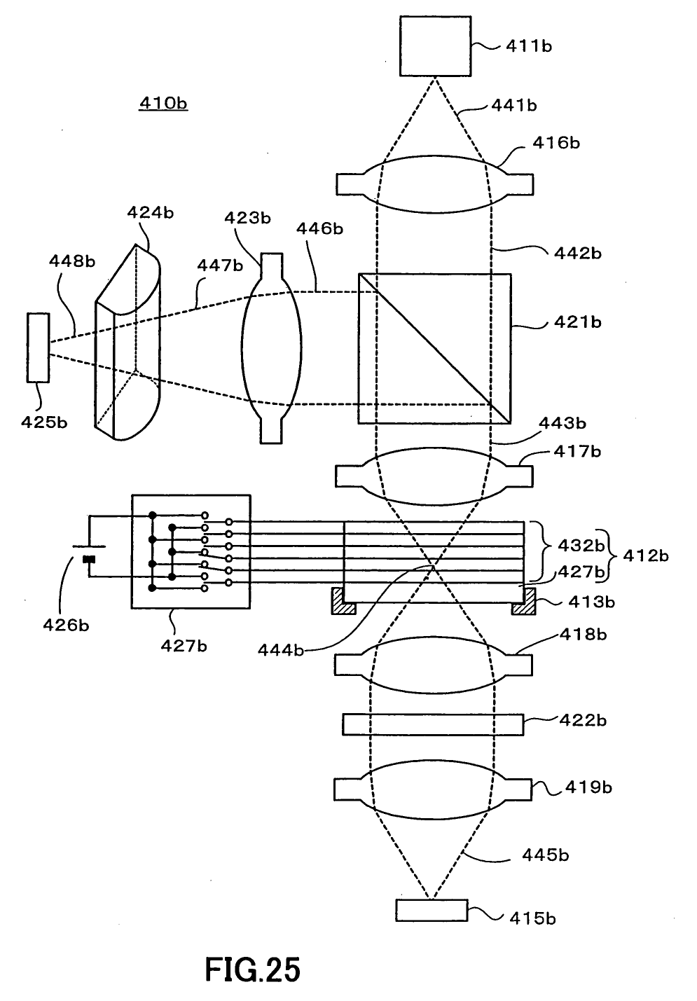

FIG. 25 is a schematic view showing the structure of an optical recording and/or reproducing apparatus 410b according to an embodiment of the present invention.

An optical recording and/or reproducing apparatus 410b, shown in FIG. 25, is made up by a light source 411b, a stage 413b, on which to set an optical recording and/or reproducing medium 412b, a photodetector 415b, collimator lenses 416b, 418b, converging lenses 417b, 419b, an optical path branching optical component 421b, a color separation filter 422b, a focal point detecting converging lens 423b, a cylindrical lens 424b, a focal point detecting converging lens 425b, a power supply 426 and a layer switching device 427b.

The optical recording and/or reproducing apparatus 410b does not have to be provided with polarization means, such as polarizer 420, as in the optical recording and/or reproducing apparatus 410.

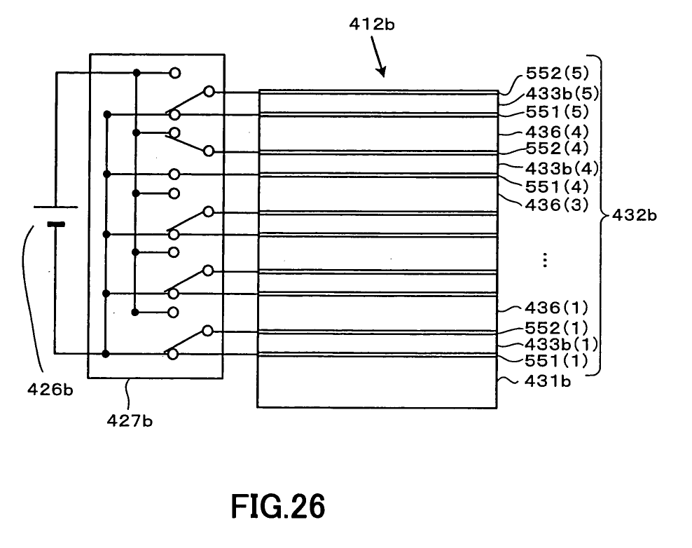

FIG. 26 is an enlarged cross-sectional view showing the optical recording and/or reproducing apparatus 412b, power supply 426b and the layer switching device 427b. Referring to FIGS. 25 and 26, the optical recording and/or reproducing medium 412b is made up by a substrate 431b and a layered recording and/or reproducing medium 432b, provided on the substrate 431b. The layered recording and/or reproducing medium 432b, in turn, is made up by medium layers 433b(1) to 433b(5), electrodes 551(1) to 551(4) and 552(1) to 552(4) and intermediate layers 436(1) to 436(4).

It should be noted that electrodes for electrical field application 551(1) to 551(5) and 552(1) to 552(5) are formed on both sides of the medium layers 433b(1) to 433b(5), while the intermediate layers 436(1) to 436(4) are provided between the electrodes for electrical field application 552(1) to 552(4) and the electrodes for electrical field application 551(2) to 552(5).

The optical recording and/or reproducing apparatus 412b does not have to be configured such as to change the reflectance depending on the polarized state, as is the polarized light semi-transmitting layer 434. This is in meeting with the situation in which the optical recording and/or reproducing apparatus 410b does not have to be provided with polarization means, as will be explained subsequently.

(Detailed Structure of the Optical Recording and/or Reproducing Apparatus 410b)

The optical recording and/or reproducing apparatus 410b is not in need of polarization means (polarizer 420) as is the optical recording and/or reproducing apparatus 410, and hence the light source 11b itself may be a non-polarizing light source.

The power supply 426b applies an electrical field across electrodes for application of an electrical field 551, 552. The layer switching device 427b is a changeover switch for selecting the electrical field responsive to a current supply command signal from outside. In FIG. 26, an electrical field is applied to the medium layer 433b(4) by applying a voltage across the electrodes for electrical field application 551(4) and 552(4).

(Detailed Structure of the Optical Recording and/or Reproducing Apparatus)

The medium layer 433b is formed of an optical material having an optically sufficient transmittance with respect to the light beams from the light source 411b with the wavelengths of λ and λ/2. This optical material is an electro-optical material, the refractive index of which is changed on application of an electrical field, a non-linear optical material, generating second harmonics of the illuminated light, and a ferroelectric material, the direction of polarization of which is changed on application of an electrical field.

Meanwhile, each medium layer 433b is preferably of a thickness equal to or less than the coherence length Lc, in order to maintain the intensity of the harmonics, as is the medium layer 433 of the first embodiment.

If an electrical field is applied to the medium layer 433b(i) of the layered recording and/or reproducing medium 432b, from which the recordings are to be reproduced, using the electrodes for electrical field application 551(i) and 552(i), changes in the refractive index are produced in the medium layer 433b(i) under electro-optical effects, such as Pockels effect. The result is that the difference in the refractive index between the medium layer 433b(i) and the electrodes for electrical field application 551(i) and that between the medium layer 433b(i) and the electrodes for electrical field application 552(i) is changed to cause changes in the light reflectance at the upper and lower boundaries of the medium layer 433b(i). The respective medium layers 433b may be selected (discriminated) by these changes in the reflectance.

The electrodes for electrical field application 551, 552 are mounted on both the front and back sides of the medium layer 433b. An electrical field is applied to the medium layer 433b on application of the potential difference across these electrodes.

The electrodes for electrical field application 551, 552 are each formed of a transparent electrically conductive material which is optically transparent at the wavelength of the light illuminated from the light source 411b.

Preferably, this transparent electrically conductive material is approximately equal in refractive index to the medium layer 433b prior to application of the electrical field in the wavelength of the light illuminated from the light source 11b. The reason is that, prior to application of the electrical field to the medium layer 433b, a smaller amount of light reflection on the layer boundary between the medium layer 433b and the electrode for electrical field application 551 and the on the layer boundary between the medium layer 433b and the electrode for electrical field application 552 is desirable from the perspective of improving the S/N ratio.

For this reason, the combination of component materials of the electrodes for electrical field application 551, 552 and the medium layer 433b is to be judiciously selected so that the two sorts of the materials will be of substantially equal refractive index values.

As an example of such combination, it may be recommendable to use ITO (indium tin oxide) for the electrodes for electrical field application 551,552 and to use lithium niobate (LiNbO₃) as the medium layer 433b.

The intermediate layers 436 is used to enlarge the distance between the respective medium layers 433b to facilitate discrimination of the medium layers 433b from one another. The provision of the intermediate layers 436 facilitates the detection of focussing errors by the astigmatic method and the converging of light on the respective medium layers 433b.

It is desirable for the intermediate layers 436 to be optically transparent at the wavelength of light illuminated from the light source 411b and to be approximately equal in refractive index to the electrodes for electrical field application 551, 552, in order to reduce the reflection at the layer boundary between the intermediate layers 436 and the electrodes for electrical field application 551, 552 to improve the S/N ratio.

(Operation of the Optical Recording and/or Reproducing Apparatus 410b)

Referring to the drawings, the operation of the optical recording and/or reproducing apparatus 410b is explained.

A. Detection of the Reproducing Layer and Light Converging Control to the Reproducing Layer

(1) A light beam 441b, outgoing from the light source 411b, is collimated by the collimator lens 416b into a parallel light beam. The light beam 442b, as a parallel light beam, is transmitted through the optical path branching optical component 421b and converged by the converging lens 417b to reach the layered recording and/or reproducing medium 432b.

An electrical field is applied by the power supply 426b and by the layer switching device 427b to an arbitrary medium layer 433b(i). By this voltage application, the refractive index of the medium layer 433b(i) is changed.

(2) As the refractive index of the medium layer 433b(i) is changed in this manner, there is induced a change in the refractive index between the medium layer 433b(i) and the electrodes for electrical field application 551(i), 552(i). Due to this difference in the refractive index, part of the light beam 444b is reflected at a boundary between the medium layer 433b(i), to which the electrical field has been applied, and the electrodes for electrical field application 551(i), 552(i).

As discussed previously, the reflection at a boundary between the medium layer 433(j), to which the electrical field has not been applied, and the electrodes for electrical field application 551(j), 552(j), where i≠j, is desirably small (reduction of the reflected light which proves the noise), that is, in the absence of the electrical field, the refractive index of the medium layer, to which the electrical field has not been applied, and that of the electrodes for electrical field application, is desirably approximately equal to each other.

Additionally, the electrodes for electrical field application 551, 552 and the intermediate layers 436 are also desirably formed of a material of approximately equal refractive index, in order to reduce the light reflected from the boundary.

(3) The light beam reflected at the boundary between the medium layer 433b(i), to which the electrical field has been applied, and the electrodes for electrical field application 551(i) and 552(i), is returned along a path followed in the forward route in the medium layer 433b(i), that is towards the light source 411b.

(4) The reflected light beam at the boundary between the medium layer 433b(i), to which the electrical field has been applied, and the electrodes for electrical field application 551(i) and 552(i), travels through the converging lens 417b to reach the focal point detecting converging lens 423b at the optical path branching optical component 421b to prove a converged light beam 447b. Astigmatism is produced in the converged light by the cylindrical lens 424b, such that a photodetector 425 for focal point detection outputs a focussing error signal corresponding to the converging point of the converged light beam 444b (detection of the focussing error by the astigmatic method). Using this focussing error signal output, the focal point position can be controlled so that the light beam 444b from the light source 411b will be converged on the medium layer 433(i), to which the electrical field has been applied, as described above.

By applying an electrical field to an optional medium layer 433(i), the medium layer 433(i) can be discriminated and controlled as being a subject of recording or reproduction.

The information recording and reproduction are not appreciably changed as to principle from those of the first embodiment and the hence are not explained specifically.

(Other Configurations)

(1) In the above-described embodiment, the reflected light beam is used for detecting the focussing error for discriminating or setting the medium layer to be recorded and/or reproduced, while the transmitted light beam is used for detecting the information signals (information reproduction). It is however possible to use the reflected light beam for both the focussing error detection and information signal detection.

Meanwhile, the layered recording and/or reproducing mediums, explained in the above embodiment, may be an optical disc or an optical card, only by way of illustration.

(2) Although no intermediate layer is used in the present embodiment, such intermediate layer may also be used even in case of employing a layer the reflectance of which is changed by the state of polarization as in the embodiment (polarized semi-transmitting layer). For example, a combination of the intermediate layer and paired electrodes for electrical field application, formed on the upper and lower sides of the intermediate layer, may be used in place of the polarized light semi-transmitting layer and the medium layer as its underlying layer.

That is, the intermediate layer may be provided to facilitate discrimination of the respective medium layers, by the provision of the intermediate layer when light reflection occurs on the boundary layer between the polarized light semi-transmitting layer and whichever one of the paired electrodes for electrical field application.

[Sixth Embodiment]

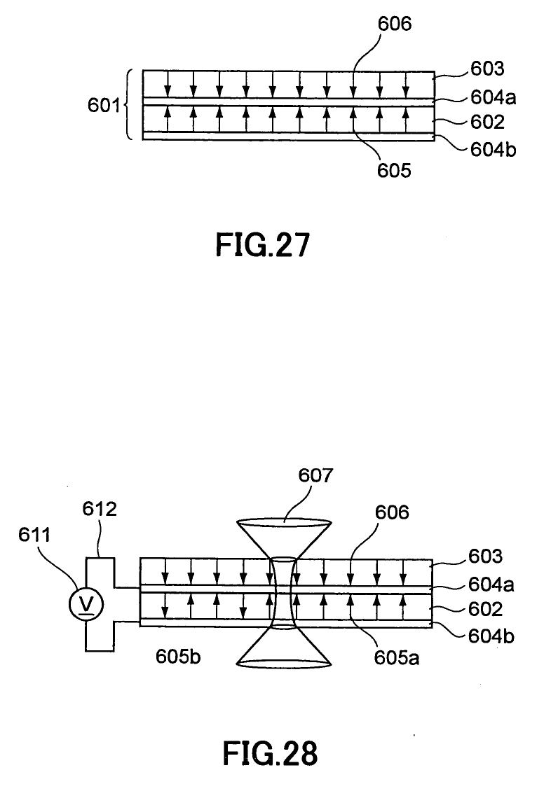

FIG. 27 is a cross-sectional view showing the structure of an optical recording and/or reproducing medium 601 according to a preferred embodiment of the present invention.

Referring to FIG. 27, an optical recording and/or reproducing medium 601 includes a recording and/or reproducing member 602, as an electro-optical layer, a pair of electrodes 604a, 604b, arranged on the front and back sides of the recording and/or reproducing member 602 and a reference member 603, as a reference light generating layer, lying adjacent to one surface of the resulting assembly.

In the drawing, arrows 605, 606, entered in the recording and/or reproducing member 602 and in the reference member 603, respectively, schematically denote the direction of spontaneous polarization remaining in the respective members. The directions of the spontaneous polarization 605, 606 are determined depending on whether the intensity of the optical harmonics generated in a portion where the signals of the recording and/or reproducing member 602 have been recorded and which have been phase-compared with the reference light is higher or lower than the intensity of the optical harmonics generated in the non-recorded portion and which have equally been phase-compared with the reference light.

(Recording of Signals on the Optical Recording and/or Reproducing Medium 601)

FIG. 28 illustrates the signal recording on the optical recording and/or reproducing medium 601.

Referring to FIG. 28, a light source 611 is connected via line 612 to the respective electrodes 604a, 604b of the above-described optical recording and/or reproducing medium 601. An electrical field may be applied to the recording and/or reproducing member 602 by applying voltage across the electrodes 604a, 604b.

It should be noted that, if an electrical field of a field intensity smaller than the so-called anti-electric field which is opposite in direction to the polarization 605 in the recording and/or reproducing member 602 and which is sufficient in magnitude to invert the polarization is applied, the polarization 605 is not inverted.

If the light beam from a light source is concentrated at an optional location in the recording and/or reproducing member 602, the temperature of the light beam converging portion is elevated to lower the value of the anti-electrical field to invert the polarizations 605. If the light beam then ceases to be converged, the inverted polarization is retained as residual polarization 605b, shown in FIG. 28, by way of recording the signals.

Meanwhile, since no electrical field is applied to the reference member 603, the value of the anti-electrical field is not changed, and hence the polarization 6 is not inverted even on concentration of the light beam from the light source.

(Reproduction of Signals from the Optical Recording and/or Reproducing Medium 601)

A. The Case where the Reference Member 603 and the Recording and/or Reproducing Member 602 are Each of a Thickness Approximately Equal to the Coherence Length

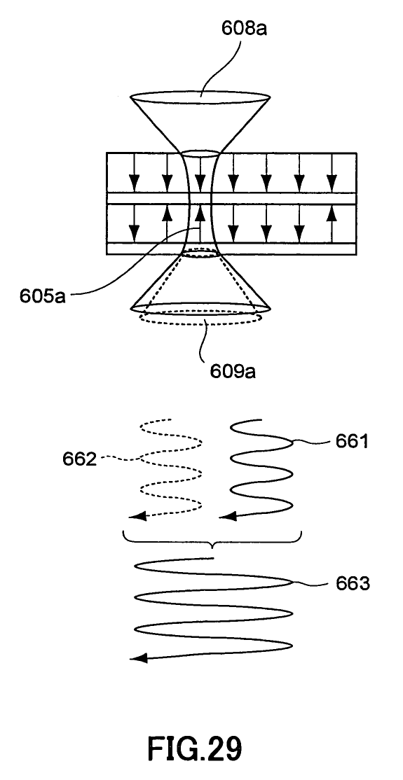

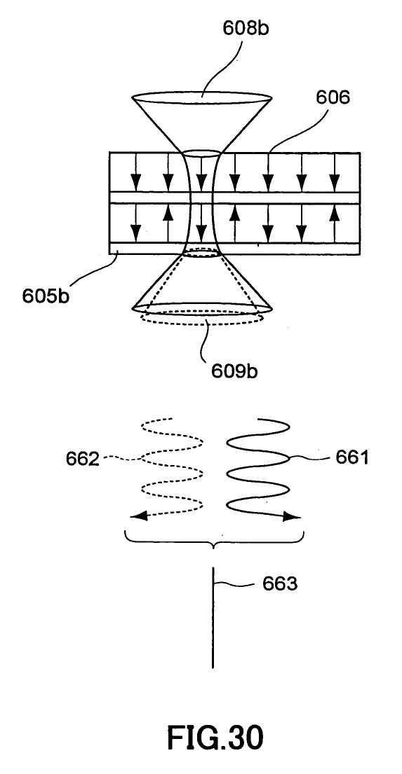

FIGS. 29 and 30 illustrate the signal reproduction from the optical recording and/or reproducing medium 601.

Referring to FIG. 29, when a reproducing light beam 608a is illuminated on a location of the reference member 603 and the vicinity of the inverted polarization 605a of the recording and/or reproducing member 602, optical harmonics 662 are generated from the recording and/or reproducing member 602, at the same time as optical harmonics 661 are also emanated from the reference member 603.

It is assumed that the reference member 603 and the recording and/or reproducing member 602 are each of a thickness substantially equal to the coherence length. Then, optical harmonics 661, generated in the reference member 603, are inverted in phase by 180° before reaching the recording and/or reproducing member 602. The direction of polarization at a location of the polarization 605a of the recording and/or reproducing member 602 is opposite to the direction of polarization 606 of the reference member 603, such that the optical harmonics 662 generated at this location is inverted in phase by 180°. The result is that, at the location of the inverted polarization 605a, the optical harmonics 661 generated in the reference member 603 is in phase with the optical harmonics 662 generated in the recording and/or reproducing member 602, thus producing a detected light beam 663 of a light intensity resulting from superposition in the intensity enhancing direction.

If conversely the reproducing light beam 608a is illuminated on a location of the reference member 603 and the recording and/or reproducing member 602 where the polarization 605b is not inverted, with the direction of polarization of the reference member 603 then being coincident with that of the recording and/or reproducing member 602, optical harmonics 662 are similarly generated from the recording and/or reproducing member 602, at the same time as optical harmonics 661 are also generated from the reference member 603. The optical harmonics 661, generated in the reference member 603, phase-inverted by 180° before reaching the recording and/or reproducing member 602. On the other hand, the direction of polarization at the location of the polarization 605b of the recording and/or reproducing member 602 is the same as the direction of polarization 606 of the reference member 603, such that the optical harmonics 662 produced at this location is not inverted in phase. The result is that, in this location of the non-inverted polarization 605b, the optical harmonics 661 generated in the reference member 603 are opposite in phase to the optical harmonics 662 emanating from the recording and/or reproducing member 602, with the light intensity cancelling each other, so that no detection light can be produced.

B. The Case where the Summed Thickness of the Recording and/or Reproducing Member 602 and the Reference Member 603 is not Larger than Coherence Length

On the other hand, if the summed thickness of the recording and/or reproducing member 602 and the reference member 603 is not larger than the coherence length, the optical harmonics generated in the reference member 603 are not inverted in phase by 180° until it traverses the recording and/or reproducing member 602, while the direction of polarization 605a in the reproducing light beam 608a is opposite in direction to the direction of polarization 606 of the reference member 603, so that the optical harmonics generated in the members 602, 603 are opposite in phase, with the light intensity of the optical harmonics then cancelling each other. Thus, no detection light can be produced.

Conversely, with reproducing light beam 608b, the direction of polarization 606 of the reference member 603 is the same as the direction of polarization 605b of the recording and/or reproducing member 602, in the similar generation of optical harmonics. So, the optical harmonics generated in the respective members are in phase with each other, thus producing a detected light beam 663 of the light intensity resulting from superposition in the light intensity enhancing direction.

In FIGS. 29 and 30, the reproducing light beam 608a and 608b are shown as different light beams converged at different locations of polarization 605a, 605b of the recording and/or reproducing member 602. Alternatively, a sole light beam for reproduction may be used, with the optical recording and/or reproducing medium 601 then being moved.

(Stacking of Optical Recording and/or Reproducing Mediums 601)

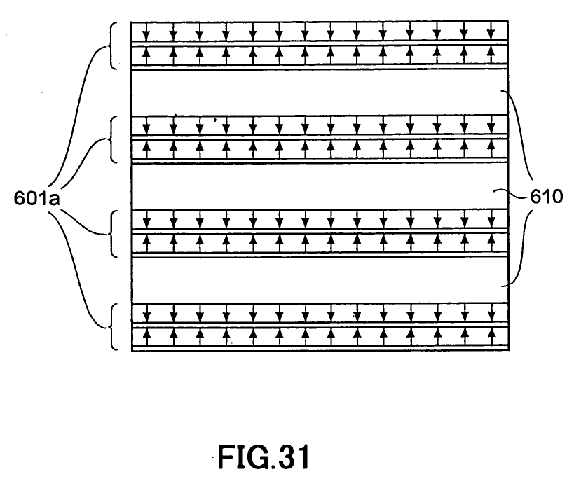

FIG. 31 is a schematic view showing a structure of plural layers of the optical recording and/or reproducing medium 601 of the present invention.

The optical recording and/or reproducing medium 601 may be comprised of a plural number of sets of layers 601a, each set 601a being made up by a recording and/or reproducing member 602, paired electrodes 604a, 604b arranged on the upper and lower surfaces of the recording and/or reproducing member 602, and a reference member 603 lying adjacent to one surface of the resulting layered assembly, as shown for example in FIG. 31.

Between the neighboring sets of layers 601a, it is possible to arrange intermediate layers 610 having sufficiently high transmittance at the light wavelength of the light from a light source and the wavelength of the optical harmonics generated in the respective members. The role of the intermediate layers 610 is to increase the distance between the layered sets 601a to facilitate discrimination of the layered sets 601 from one another. For example, detection of focussing errors by the astigmatic method or the converging of light to a space between the layered sets 601a may be facilitated.

The intermediate layer 610 is preferably optically transparent, as described above, while being approximately equal in refractive index to the electrodes 604a, 604b, in order to reduce the reflection at the layer boundary between the intermediate layer 610 and the electrodes 604a, 604b to improve the S/N ratio.

It is not mandatory to provide the intermediate layers. While the recording capacity can be increased by layering optical recording and/or reproducing mediums 601, the number of layers may further be increased by eliminating the intermediate layers.

(Details of the Optical Recording and/or Reproducing Apparatus)

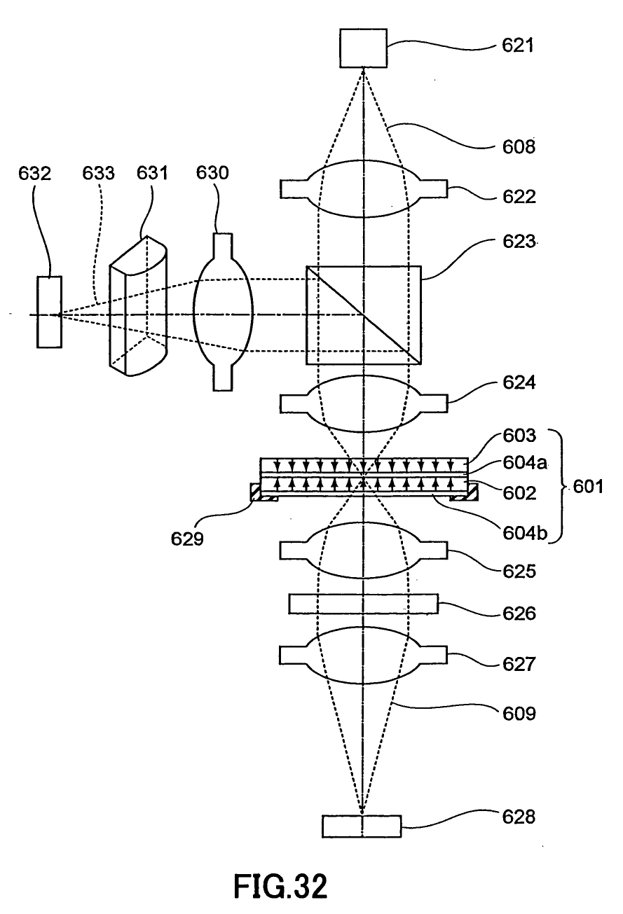

FIG. 32 is a schematic view for illustrating an optical recording and/or reproducing apparatus employing the optical recording and/or reproducing medium of the present invention.

Referring to FIG. 32, a light source 621 is, for example, a semiconductor laser, and radiates a light beam 608 (with a wavelength λ) for optical recording and/or reproduction of the optical recording and/or reproducing medium 601.

A stage 629 is movable as the optical recording and/or reproducing medium 601 is set thereon.

A photodetector 628, detecting the light volume of the incident light beam 609, operates as reproducing means for outputting reproducing signals from the optical recording and/or reproducing medium 601.

A pair of collimator lenses 622, 625 collimate a light beam into a parallel light beam. A pair of converging lenses 624, 627 operate as light converging means for converging the light beam. A light beam 608, emanated from a light source 621, is converged by the converging lens 624 on the optical recording and/or reproducing medium 601. The converging position (focussed position) of this light beam may be suitably swept in a direction perpendicular to and along the surface of the optical recording and/or reproducing medium 601, by a movement mechanism, not shown, causing the movement of the converging lens 617.

An optical path branching optical component 623 is a so-called beam splitter for branching a light beam partially reflected from the surface of the optical recording and/or reproducing medium towards a focal point detecting photodetector 632 to from a light beam 633.

A color separation filter 626 is a filter for absorbing the light of a wavelength λ (fundamental wave) radiated from the light source 621 for separating harmonics with a wavelength of λ/2.

A focal point detecting converging lens 630, a cylindrical lens 631 and the focal point detecting photodetector 632 represent constituent elements of means for detecting the focal point of the converged light on the surface of the optical recording and/or reproducing medium.

The focal point detecting converging lens 623 represents converging means for converging a light beam 645 on the focal point detecting photodetector 625.

The cylindrical lens 631 affords astigmatism to the light beam 633 which has traversed the focal point detecting converging lens 630. This astigmatism is brought about by the cylindrical lens 631 not converging the light along the cylinder axis but only in the direction perpendicular to the cylinder axis. As a result, the shape of the beam 633 incident on the focal point detecting photodetector 632 is elliptical or circular. This shape is changed in dependence upon the converging position of the converging light in the optical recording and/or reproducing medium 601.

The focal point detecting photodetector 632 is a set of for example four photodetector elements. The outputs of these four photodetector elements are processed with summation and subtraction to derive and output a signal which is in keeping with the shape of the light beam 633, that is a focussing error signal corresponding to the focal point position of the optical recording and/or reproducing medium 601.

(Detailed Structure of the Optical Recording and/or Reproducing Medium 601)

Referring to FIG. 27, the optical recording and/or reproducing medium 601 is made up by the recording and/or reproducing member 602 and the reference member 603 exhibiting optically sufficient transmittance with respect to the light beams with wavelengths of λ and λ/2 emanated from the light source 611. The optical materials of the recording and/or reproducing member 602 and the reference member 603 is an electro-optical material, having its refractive index changed on application of an electrical field, a non-linear optical material, producing optical harmonics of the illuminated light, and a ferroelectric material, having the direction of polarization of residual polarization changed on application of an electrical field. Examples of the constituent materials include a thin sheet or a thin film of ferroelectric crystals, such as lithium niobate (LiNbO₃), barium titanate (BaTiO₃) or KTP (KTiOPO₄), films of ferroelectric polymer materials, such as polyvinylidene fluoride (PVDF), vinylidene fluoride (VDF) or triethylene fluoride TrFE), and thin sheets or films of organic non-linear materials, such as methylcyanine complex salts, nitroaniline or nitropyridine based organic crystals or a polymer of an azo dyestuff and a polymer.

Meanwhile, the thicknesses of the reference member 603 and the recording and/or reproducing member 602 are preferably equal to or lesser than the coherence length Lc in order to prevent phase interference of optical harmonics generated in the respective members and in order to maintain the intensity of the optical harmonics.

Moreover, since the reference member 603 and the recording and/or reproducing member 602 are adjacent to each other and passed through by the same converged light in signal reproduction, the optical harmonics generated in the respective members behave in similar fashion against external effects and remain stable against changes in intensity or optical aberrations.

The electrodes for application of an electrical field 604a, 604b are arranged on the front and back sides of the recording and/or reproducing member 602 and a potential is applied across the electrodes to apply an electrical field to the recording and/or reproducing member 602.

The electrodes for application of an electrical field 604a, 604b are formed of a material which is both optically transparent and electrically conductive, such as ITO (Indium Tin Oxide) in a thin film form, for assuring effective utilization of a light beam for detection. The thin films of the transparent electrically conductive material may be formed by for example vapor deposition or sputtering. By providing a dielectric film on the surfaces of the electrodes for application of an electrical field 604a, 604b, it is possible to reduce reflection otherwise produced on the boundary between the electrodes and the reference member 603 or air (anti-reflection film).

(Other Configurations)

(1) In the above-described embodiments, the reflected light beam is used for detecting the focussing error for discriminating or setting the medium layer to be recorded or reproduced, while the transmitted light beam is used for detecting the information signals (reproduction of the information). Alternatively, the reflected light beam may also be used for detecting both the focussing errors and the information signals.

Meanwhile, the layered recording and/or reproducing mediums, explained in the above embodiment, may be an optical disc or an optical card, only by way of illustration.

(2) In the foregoing explanation of the above-described embodiment, the residual polarizations of the reference member and the recording and/or reproducing member prior to signal recording are assumed to be of the same direction. Alternatively, the residual polarizations may be of the opposite directions to each other. As a principle, it is also possible for the recording and/or reproducing member not to exhibit residual polarization prior to recording and to have two recording values, that is positive and negative recording values, on application of an electrical field, by way of so-called multi-valued recording.

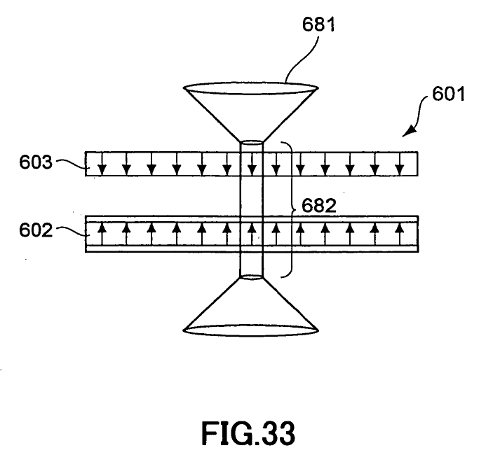

(3) In the above-described embodiment, the reference member and the recording and/or reproducing member are mounted adjacent to each other. It is also possible to arrange the reference member 603 and the recording and/or reproducing member 602 within the depth of focus 682 of the converged light 681 with respect to the optical recording and/or reproducing medium 601, as shown in FIG. 33. The reason is that, if these members are arranged in a region exceeding the depth of focus 682 of the converged light 681, the converged light is incident on these members with different angles of incidence to produce phase mismatching. Moreover, wavefront symmetry of the optical harmonics emanating from the reference member 603 and those emanating from the recording and/or reproducing member 602 is collapsed to produce disturbance (that is offset) in phase comparison.

[Seventh Embodiment]

(Structure of the Optical Recording and/or Reproducing Apparatus)

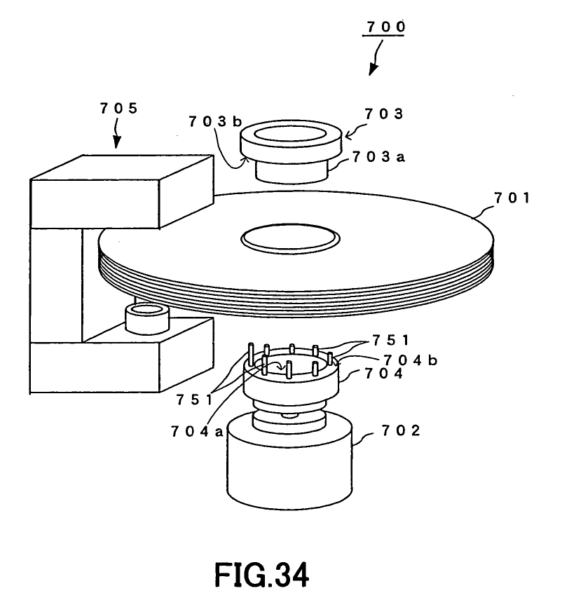

FIG. 34 shows the structure of an optical recording and/or reproducing apparatus embodying the present invention.

As shown therein, an optical recording and/or reproducing apparatus 700 includes a multi-layered recording and/or reproducing medium 701, as a layered medium, a motor 702, as a driving source for moving, for example, rotating, the multi-layered recording and/or reproducing medium 701, a medium holder 704 holding the multi-layered recording and/or reproducing medium 701 between it and a stationary member 703 and which is moved, for example rotated, in unison with the multi-layered recording and/or reproducing medium 701, and an optical recording and/or reproducing unit 705 for recording and/or reproducing the information such as by illuminating the light on an optional layer of the optical recording and/or reproducing medium of the multi-layered recording and/or reproducing medium 701 which is moved, for example rotated along with the medium holder 704.

The optical recording and/or reproducing unit 705 radiates, from a light source, such as a semiconductor laser, a light beam for optical recording and/or reproducing of the multi-layered recording and/or reproducing medium 701 to achieve information recording and/or reproduction for the multi-layered recording and/or reproducing medium 701. If the multi-layered recording and/or reproducing medium 701 is rotating medium, the optical recording and/or reproducing unit 705 includes means movable in a direction along a normal line drawn to the direction of rotation of the multi-layered recording and/or reproducing medium 701.

(Details of the Multi-Layered Recording and/or Reproducing Medium 701)

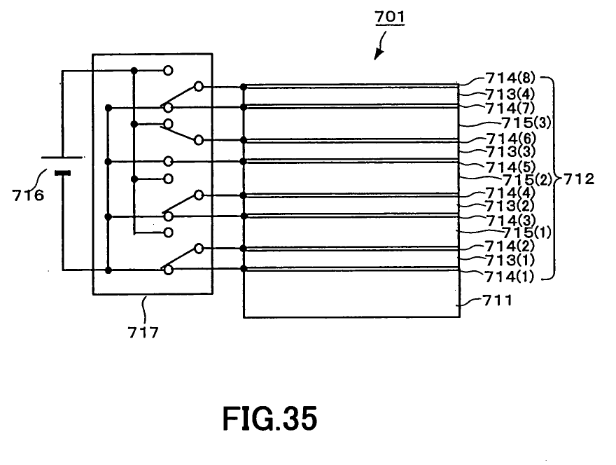

FIG. 35 is a cross-sectional view showing an exemplary structure of the multi-layered recording and/or reproducing medium 701.

As shown therein, the multi-layered recording and/or reproducing medium 701 includes an optically transparent substrate 711 and a layered medium 712 provided on the substrate 711. The layered medium 712, in turn, is made up by plural layers of the optical recording and/or reproducing medium 713(1) to 713(4), referred to below as stacked medium layers, plural electrode layers 714(1) to 714(8) and plural intermediate layers 715(1) to 715(3). The electrode layers 714 are arranged on the front and back surfaces of the stacked medium layers 713. Across the respective electrode layers 714, arranged on both surfaces of the stacked medium layers 713, a voltage (potential difference) is applied from a power supply 716 through a current supply switching unit 717 to apply an electrical field to the stacked medium layers 713.

Each stacked medium layer 713 is formed of an electro-optical material, which has its optical properties, such as refractive index, changed on application of an electrical field. Referring to FIG. 35, a potential difference is applied across the electrode layers 714(5) and 714(6) provided on the front and back surfaces of the medium layer 713(3) to apply an electrical field to the medium layer 713(3), whereby the refractive index of the medium layer 713(3) is changed under the electro-optical effect. The result is that the difference between the refractive index of the medium layer 713(3) and the overlying electrode layer 714(6) and the refractive index of the medium layer 713(3) and the underlying electrode layer 714(5) is changed to vary the light reflectance at the upper and lower boundaries of the medium layer 713(3).

Each stacked medium layer 713 is formed of electro-optical material, having its optical characteristics, such as the refractive index, changed on application of an electrical field, a non-linear optical material, generating second harmonics of the illuminated light, and a ferroelectric material, having its direction of polarization changed on application of an electrical field. Meanwhile, the thickness of each stacked medium layer 713 is equal to or lesser than the coherence length Lc from the perspective of maintaining the intensity of the harmonics.

The electrode layer 714 is formed of a material which is electrically conductive and which is optically transparent at the wavelength of light illuminated from the light source 721. Preferably, the transparent electrically conductive material, used for the electrode layer 714, is approximately equal in refractive index to the stacked medium layer 713 prior to electrical field application. The reason is that a smaller amount of reflection on the layer boundary between the stacked medium layer 713 and the electrode layer 714 is desirable, prior to application of the electrical field, from the perspective of improving the S/N ratio. Consequently, the combination of the constituent materials for the electrode layers 714 and the stacked medium layers 713 is suitably selected so that the refractive index of the electrode layers 714 will be approximately equal to that of the stacked medium layers 713.

By way of illustration of this combination, ITO (indium tin oxide) and lithium niobate (LiNbO₃) may be used as the electrode layers 714 and as the stacked medium layers 713, respectively.

The intermediate layer 715 operates for increasing the distance between the respective stacked medium layers 713 to facilitate discrimination of the respective stacked medium layers 713. For example, the intermediate layer 715 facilitates detection of focussing errors by the astigmatic method and the converging of light on the respective stacked medium layers 713.

Preferably, the intermediate layer 715 is optically transparent and approximately equal in the refractive index to the electrode layer 714 at the wavelength of light illuminated from the light source 721, in order to reduce the reflection at the layer boundary between the intermediate layer 715 and the electrode layer 714 to improve the S/N ratio.

(Details of the Optical Recording and/or Reproducing Unit 705 of the Optical Recording and/or Reproducing Apparatus 700)

A. Structure of the Optical Recording and/or Reproducing Unit 705

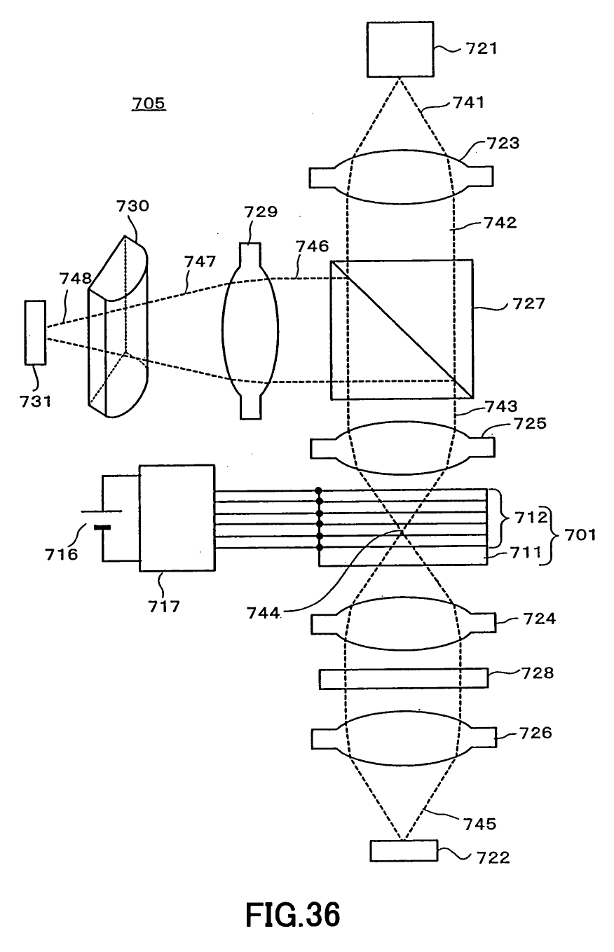

FIG. 36 schematically shows the structure of the optical recording and/or reproducing unit 705 in an optical recording and/or reproducing apparatus 700.

As shown therein, the optical recording and/or reproducing unit 705 is made up by a light source 721, a photodetector 722, collimator lenses 723, 724, converging lenses 725, 726, an optical path branching optical component 727, a color separation filter 728, a focal point detecting converging lens 729, a cylindrical lens 730, a focal point detecting photodetector 731, a power supply 716 and a current supply switching unit 717.

B. Operation of the Optical Recording and/or Reproducing Apparatus 700

The operation of the optical recording and/or reproducing apparatus 700 is now explained.

A light beam 741, radiated from the light source 721, is collimated by the collimator lense 723 to form a parallel light beam 742, which is passed through the optical path branching optical component 727 and converged by the converging lens 725 to reach the current supply switching unit 717.

An electrical field is applied in this case to an optional medium layer 713(i) by the power supply 716 and the current supply switching unit 717. It is now assumed that, in FIG. 35, an electrical field is applied to the medium layer 713(3). By this application of the electrical field, the refractive index of the medium layer 713(3) is changed to produce the difference in the refractive index between the medium layer 713(3) and the electrode layers 714(5), 714(6) arranged on both sides of the medium layer 713(3). By this difference in the refractive index, part of a light beam 744 is reflected at the boundaries between the medium layer 713(3), to which the electrical field has been applied, and the electrode layers 714(5), 714(6).

The light beam, reflected at the boundaries between the medium layer 713(3), to which the electrical field has been applied, and the electrode layers 714(5), 714(6), is returned within the medium layer 713(3) along a path reverse to the forward route, that is in a direction towards the light source 721. The reflected light beam at the boundaries between the medium layer 713(3), to which the electrical field has been applied, and the electrode layers 714(5), 714(6), gets to the focal point detecting converging lens 729, through the converging lens 725 and the optical path branching optical component 727, to form a converged light beam 747. By the cylindrical lens 730, astigmatism is produced in the converged light, with the focal point detecting photodetector 725 outputting a focussing error signal corresponding to the converged position of the converged light beam 744 (detection of the focussing error by the astigmatic method). Using this focussing error signal output, the focal point position may be controlled so that the light beam from the light source 721 will be converged on the medium layer 713(3), to which the electrical field has been applied.

By applying the electrical field to an optional medium layer 713(i), as described above, the medium layer 713(i) may be discriminated and controlled as being a subject of recording or reproduction.

C. The Operation of Reproducing the Information by this Optical Recording and/or Reproducing Apparatus 700

The operation of reproducing the information by this optical recording and/or reproducing apparatus 700 is hereinafter explained.

The information reproduction by the optical recording and/or reproducing apparatus 700 is achieved by employing second harmonics (wavelength: λ) generated from the light beam of the wavelength λ from the light source 721 as a fundamental wave.

The light beam 741, radiated from the light source 721, is converged by the converging lens 725 on an optional medium layer 713(i) of the multi-layered recording and/or reproducing medium 701 by the converging lens 725. In this case, it is assumed that the information has been recorded on each of the stacked medium layers 713 depending on whether the direction of the residual polarization of the ferroelectric material is upward or downward.

As the light is converged on the medium layer 713(i), second harmonics are generated from the medium layer 713(i). The intensity of the second harmonics depends on the light energy density, so that, by sufficiently concentrating the light in the medium layer 713(i), it is possible to discount the generation of the second harmonics from the stacked medium layers other than the medium layer 713(i) being reproduced. The second harmonics differ in phase depending on whether the residual polarization of the converged position is upward or downward. Thus, by detecting the phase of the second harmonics, it is possible to reproduce the information optically recorded on the multi-layered recording and/or reproducing medium 701. The so generated second harmonics are collimated by the collimator 724 to pass through the color separation filter 728. The color separation filter 728 absorbs the fundamental wave (light of the wavelength λ illuminated from the light source 721) to separate the harmonics. As a result, only harmonics are contained in the light beam 74 converged by the converging lens 726 to reach the photodetector 722.

For detecting the phase of the harmonics, it is sufficient to cause the reference wave of the same wavelength as the harmonics to interfere with the harmonics to generate an interference wave and to detect the volume of the interference wave by the photodetector 722. For generating the reference wave, it is sufficient if an element adapted for generating harmonics on incidence of a light beam from the light source 721 is mounted on an optical path from the light source 21 to the color separation filter 728.

D. Information Recording Operation by the Optical Recording and/or Reproducing Apparatus 700

The operation of this optical recording and/or reproducing apparatus 700 is hereinafter explained.

The recording of the information on the multi-layered recording and/or reproducing medium 701 is achieved by illuminating the light and by applying an electrical field.

Before proceeding to record the information, the directions of the residual polarization of the stacked medium layers 713 are aligned. For aligning the directions of the residual polarization in the medium layer 713(3), an electronic voltage is applied to each of the electrode layers 714(5) and 714(6) to apply the electrical field larger than the anti-electric field capable of inverting the residual polarization to the medium layer 713(3).

The result is that there is formed residual polarization aligned in the direction of the applied electrical field. This alignment of the directions of the residual polarization means a sort of initialization of the multi-layered recording and/or reproducing medium 701, and is carried out for each of the stacked medium layers 713 as necessary.

In recording the initialized medium layer 713(3), the light beam of the light source 721 is converged in the desired site of recording (at a preset location in the medium layer 713(3)) as the electrical field in a direction corresponding to the bits desired to be recorded is applied to the medium layer 713(3) being recorded. In this case, an electrical field smaller in magnitude than the anti-electric field is applied. Since the electrical field as applied is smaller than the anti-electric field, the directions of the residual polarization are not inverted in a location where the light beam is not converged. That is, bit inversion in the meaning of the information technology is not produced. Conversely, in the location where the light beam has been concentrated, local temperature rise is produced and the anti-electric field is lowered, so that the direction of the residual polarization is changed.

In this manner, the directions of the residual polarization of the heated location may be determined by carrying out local heating under application of an electrical field smaller in magnitude than the anti-electric field at ambient temperature.

This operation of application of the electrical field and the converging of the light beam are apparently similar to the operation for layer detection. However, these operations are performed for the totally different objectives, so that optimum electrical fields and light beam intensity are selectively used depending on the aim in view. For example, light sources of a wavelength suitable for heating the stacked medium layers 713 may separately be used for recording.

(Contact Structure)

The contact structure for applying an electrical field to the electrode layer 714 in this optical recording and/or reproducing apparatus 700 is hereinafter explained.

Referring to FIG. 34, a plural number of electrode terminals 751 for supplying the current to the respective electrode layers 714 of the multi-layered recording and/or reproducing medium 701 are provided to the medium holder 704, which holds the multi-layered recording and/or reproducing medium 701 between it and the stationary member 703 and which is driven by the motor 702 for movement, for example, rotation, in unison with the multi-layered recording and/or reproducing medium 701.

A center through-hole 752 is bored through the multi-layered recording and/or reproducing medium 701 along the layering direction. By this center through-hole 752, an insertion boss 703a of the stationary member 703 is coupled to a recess 704a in the medium holder 704, whereby both surfaces of the multi-layered recording and/or reproducing medium 701 are sandwiched between a flange 703b of the stationary member 703 and a flange 704b of the medium holder 704. Thus, the multi-layered recording and/or reproducing medium 701 is held by the medium holder 704.

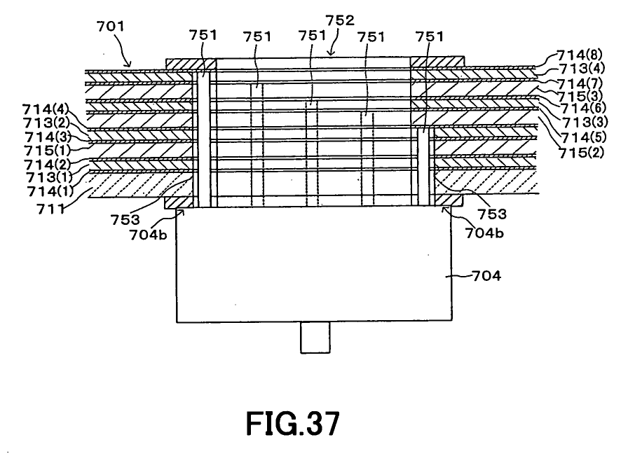

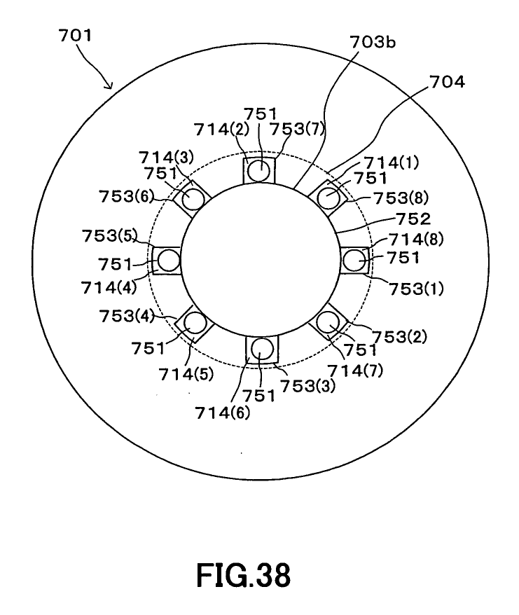

FIG. 37 is a cross-sectional view showing the state in which the multi-layered recording and/or reproducing medium 701 is held by the medium holder 704 and FIG. 38 is a plan view showing the multi-layered recording and/or reproducing medium 701, as held by the medium holder 704, from its one surface, that is from its surface towards the medium holder 704.

As may be seen in these figures, the plural electrode terminals 751, provided to the medium holder 704, are introduced into plural cut-outs 753 formed as one with the center through-hole 752 of the multi-layered recording and/or reproducing medium 701, as the multi-layered recording and/or reproducing medium 701 is held by the medium holder 704.

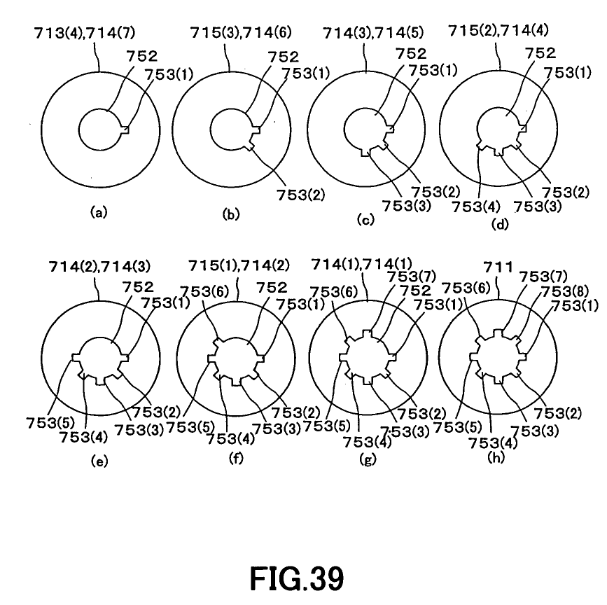

FIG. 39 is a plan view showing a cut-out 753 formed in each layer of the multi-layered recording and/or reproducing medium 701. FIG. 39(a) shows a through-hole 752 and a cut-out 753(1) formed in the uppermost medium layer 713(4) and a subjacent electrode layer 714(7) of the multi-layered recording and/or reproducing medium 701. This cut-out 753(1) is formed through the entire subjacent layers (electrode layers, stacked medium layers, intermediate layers and the substrate). FIG. 39(b) shows a through-hole 752 and cut-outs 753(1) and 753(2), formed in the uppermost intermediate layer 715(3), and a subjacent electrode layer 714(6) of the multi-layered recording and/or reproducing medium 701. In this structure, one cut-out, that is the cut-out 753(2), is added to the structure of FIG. 39a. This cut-out 753(2) is similarly formed through the entire subjacent layers (electrode layers, stacked medium layers, intermediate layers and the substrate). As shown in FIGS. 39(c) to 39(g), an incrementing number of cut-outs are provided for the lower stacked medium layer 713 or lower side intermediate layer 715 and the lower side electrode layers 714, in the descending direction, so that, in the substrate 711, shown in FIG. 39(h), there are formed a number of cut-outs 753(1) to 753(8) equal to the number of the electrode terminals 751.

By stacking the respective layers, thus formed with the cut-outs 753(1) to 753(8), the electrode layers 714(1) to 714(8) may be exposed at the locations of the respective cut-outs 753(1) to 753(8) in one surface of the multi-layered recording and/or reproducing medium 701 (the surface thereof towards the medium holder 704). Into these cut-outs 753(1) to 753(8) are inserted individual electrode terminals 751 provided to the medium holder 704 to cause the foremost parts of the electrode terminals 751 to be contacted with the surfaces of the electrode layers 714(1) to 714(8). The lengths of the electrode terminals 751 are set to optimum values depending on the electrode layers 714(1) to 714(8) with which the electrode terminals 751 are to be contacted.

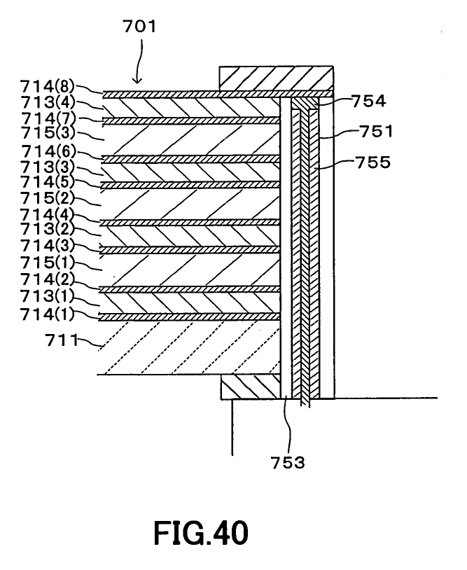

As for the electrode terminals 751, a conductor part 754 may be provided at the distal end of the terminal to be contacted with the electrode layer 714, with the peripheral portion of the electrode terminals 751 being then encircled with an insulating portion 755, for insulation with respect to the other electrode layers 714, as shown in FIG. 40.

Although the cut-out 753 is formed in the present embodiment as one with the through-hole 752, the respective cut-outs 753 may also be provided independently.

With this contact structure, current may be supplied in a simplified configuration to the respective electrode layers 714 of the removable multi-layered recording and/or reproducing medium 701. In addition, since the respective electrode terminals 751 are in facing contact with the electrode layers 714, the contact area may be increased to improve the contact reliability. Moreover, since the respective electrode terminals 751 are provided to the medium holder 704 which holds and rotates the multi-layered recording and/or reproducing medium 701, current may be supplied to the respective electrode layers 714 of the rotating multi-layered recording and/or reproducing medium 701.

(Selective Voltage Application to the Respective Electrode Layers 714 of the Multi-Layered Recording and/or Reproducing Medium 701)

The structure of means for selectively applying the voltage to the respective electrode layers 714 of the multi-layered recording and/or reproducing medium 701 is hereinafter explained.

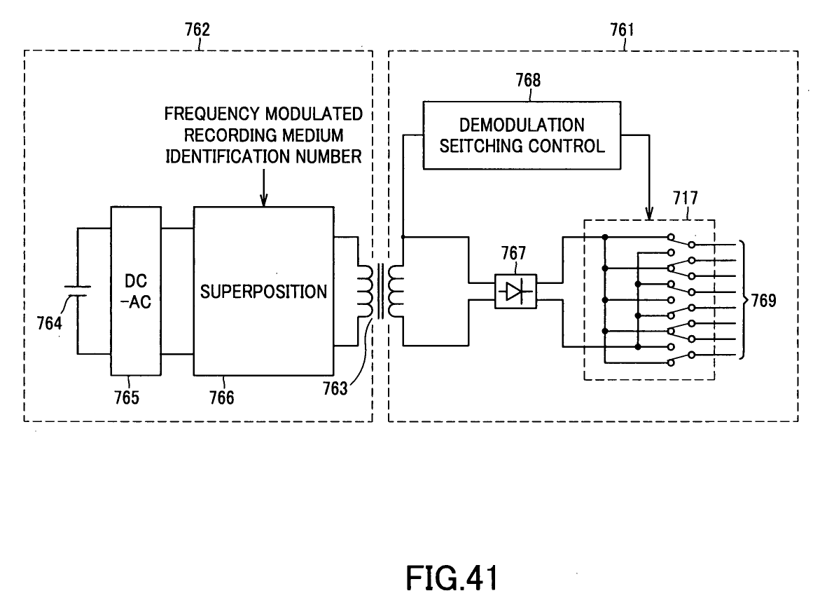

FIG. 41 shows the structure of this voltage application means, where 761 denotes a circuit provided to a section movable in unison with the multi-layered recording and/or reproducing medium 701, that is the medium holder 704, and 762 denotes a circuit outside of the medium holder 704. The circuit 761 of the movable section and the external circuit 762 are interconnected by a non-contact transformer 763, such as a rotary transformer. The external circuit 762 is made up by a DC power supply 764, a DC-AC converter 765 for converting the direct current of the DC power supply 764 into AC and a superposition circuit 766 for superposing a frequency modulated recording medium identification signal as harmonics on the AC generated by the DC-AC converter 765. The AC, on which the frequency modulated recording medium identification signal has been superposed as harmonics, is transmitted to the circuit section 761 of the movable section through the non-contact transformer 763 operating as transmission means. The circuit section 761 of the movable section is made up by a stabilized power supply circuit 767 for rectifying the secondary side output of the non-contact transformer 763 for generating optional DC, a current supply switching unit 717 for switching the electrode layers 714 being supplied with current, and a demodulating switching controlling unit 768 for extracting the recording medium identification signal from the secondary side output of the non-contact transformer 763, demodulating the extracted signal and for controlling the current supply switching unit 717 based on the demodulated recording medium identification signal. The numeral 769 denotes current paths to the respective electrode layers 714.

That is, in order to transmit the power supply in a non-contact fashion from the external circuit 762 to the circuit section 761 of the movable section, the power supply 716 converts the DC of the DC power supply 764 into AC by the DC-AC converter 765 and superposes the frequency modulated recording medium identification signal as harmonics on this AC by a superposition circuit 766 to send the resulting signal to the primary side wiring of the non-contact transformer 763.

The AC transmitted to the secondary side winding of the non-contact transformer 763 is transformed by the stabilized power supply circuit 767 into a constant voltage suited for being applied to the electrode layers 714. Moreover, the demodulating switching controlling unit 768 extracts the frequency modulated recording medium identification signal, as harmonics component, from the AC transmitted to the secondary side winding of the non-contact transformer 763, and demodulates the extracted signal to control the current supply switching unit 717 based on the so demodulated recording medium identification signal. This sets the current supply on/off to the respective current paths 769, associated with the respective electrode layers 714, such as to apply an electrical field to an optional one of the stacked medium layers 713.

By the above structure of the voltage applying means, it becomes possible to supply the power for applying an electrical field from the medium holder 704 rotating in unison with the multi-layered recording and/or reproducing medium 701 to the respective stacked medium layers 713 of the multi-layered recording and/or reproducing medium 701 and to perform switching control of selecting the stacked medium layer 713 to which the electrical field is to be applied.

(Other Configurations)

In the above-described embodiments, one of the stacked medium layers, to which the electrical field has been applied, is discriminated as a subject of recording or reproduction, based on changes in the light reflectance at the upper and lower boundaries of the stacked medium layer in question. It is however also possible to provide a polarization reflecting layer between the stacked medium layer and the subjacent electrode layer, to reflect the polarization component, changed by being transmitted through the stacked medium layer, the refractive index of which has been changed on application of the electrical field, by the polarization reflecting layer, and to discriminate the layer as the subject of recording or reproduction based on the quantity of the reflected light.

In the above-described embodiments, each medium layer is formed of a non-linear optical material generating secondary harmonics of the illuminated light and a ferroelectric material having its direction of polarization changed on application of an electrical field. This, however, is merely illustrative, such that a phosphor light readout type photorefractive material employing dual photon absorption, for example, may also be used.

Moreover, in the multi-layered recording and/or reproducing medium, use of the intermediate layer is not mandatory. The same may be said of the base.

Meanwhile, the layered recording and/or reproducing mediums, explained in the above embodiment, may be an optical disc or an optical card, only by way of illustration.

In the above-described embodiment, the cut-outs are provided in the multi-layered recording and/or reproducing medium in a one-for-one relationship to the electrode layers. Alternatively, upper and lower electrode layers, separated from each other by an intermediate layer, may be electrically coupled to each other by an inter-layer connecting portion, such as a through-hole. In this case, cut-outs may be provided in the respective stacked medium layers so that only one of the electrode layers provided on both surfaces of each medium layer will be exposed on one surface of the multi-layered recording and/or reproducing medium, with the electrode terminals provided on the medium holder being inserted into the cut-outs to supply the current.

[Eighth Embodiment]

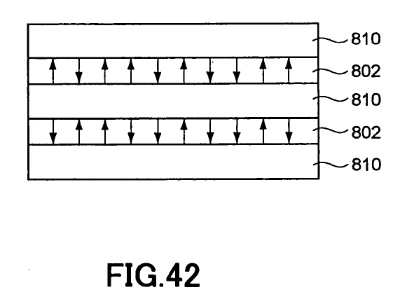

FIG. 42 is a schematic view showing the structure of an optical recording and/or reproducing medium 801 according to a further embodiment of the present invention.

Referring to FIG. 42, the optical recording and/or reproducing medium 801 is made up of plural recording and/or reproducing members 802 and plural intermediate layers 810, alternately layered together. The intermediate layers 810 exhibit sufficiently high transmittance at a wavelength of the light from the light source and at a wavelength of optical harmonics generated in the respective members.

As the recording and/or reproducing member 802, the same member as that described in connection with the above-described embodiment may be used.

However, use of the intermediate layer is not mandatory. While the recording capacity may be enhanced by using the multi-layered optical recording and/or reproducing medium 801, the number of layers can be increased further by eliminating the intermediate layers.

In the present embodiment the multi-layered optical recording and/or reproducing medium 801 may be used as read-only medium.

As the apparatus for reproducing the optical recording and/or reproducing medium 801, the optical recording and/or reproducing apparatus of the above-described embodiments may be used. It should be noted that the recording function may be removed from this apparatus.

In the foregoing explanation, while the second harmonics is used as harmonics generated from the optical recording and/or reproducing medium in the example, the present invention is not limited to the embodiment, and arbitrary harmonics of third or higher degree also can be used.

### INDUSTRIAL APPLICABILITY

As described above, the present invention renders it possible to realize high recording density and highly reliable stable read-out characteristics.

According to the present invention, the applied electrical field can be controlled on the basis of the intensity of the harmonics generated from the layers of the electro-optical layers to achieve coincidence of the refractive index of the fundamental wave from the light source with that of the harmonics of the layer of the electro-optical material to maintain the phase matching state.

According to the present invention, the residual polarization of the respective layers of the ferroelectric recording medium, each being of a thickness not larger than the coherence length, may be alternately reversed to produce harmonics for reproduction of sufficient intensity form the optical recording and/or reproducing medium.

According to the present invention, the layer of the electro-optical layer, having its refractive index changed on application of an electrical field, may be detected to discriminate plural electro-optical layers extremely readily.

According to the present invention, the layers of the electro-optical material, having its refractive index changed by application of an electrical field, may be arranged adjacent to each other, and signals may be detected simultaneously by the same converged light, thereby facilitating the device structure and reducing signal deterioration otherwise caused by optical disturbances.

According to the present invention, current can be supplied to the respective electrodes of the removable multi-layered recording and/or reproducing medium by an extremely simplified structure. Additionally, current can be supplied in stability to the respective electrodes of the moving, e.g., rotating multi-layered recording and/or reproducing medium by a simplified structure.

1. An optical recording and/or reproducing apparatus comprising:
a stage for setting thereon an optical recording and/or reproducing medium, said optical recording and/or reproducing medium including a layer of an electro-optical material in which the polarization can be changed in its direction and remnant on application of an electrical field and which generates optical harmonics on irradiation with light, and electrode layers arranged on front and back surfaces of said layer of the electro-optical material;
a light source for illuminating light on said optical recording and/or reproducing medium set on said stage;
voltage applying means for applying the voltage across said electrode layers of said optical recording and/or reproducing medium set on said stage; and
detection means for detecting a phase of the optical harmonics generated from said optical recording and/or reproducing medium as set on said stage.

2. The optical recording and/or reproducing apparatus according to claim 1 further comprising:
means for outputting reference light, which interferes with the optical harmonics generated from said optical recording and/or reproducing medium, so that said reference light will be superposed on said optical harmonics;
said detection means detecting the intensity of said optical harmonics superposed on said reference light to detect the phase of said optical harmonics.

3. The optical recording and/or reproducing apparatus according to claim 2 wherein the intensity of said reference light is substantially equal to the intensity of the optical harmonics generated from said optical recording and/or reproducing medium.

4. The optical recording and/or reproducing apparatus according to claim 1 wherein said optical recording and/or reproducing medium is made up by at least two layer sets each comprised of said layer of the electro-optical material and said electrode layers.

5. (Amended) The optical recording and/or reproducing apparatus according to claim 1 wherein said detection means outputs an intensity signal corresponding to the intensity of the harmonics generated from said optical recording and/or reproducing medium as set on said stage; said apparatus further comprising:
voltage controlling means for controlling the output voltage of said voltage applying means based on said intensity signals output by said intensity detection means.

6. The optical recording and/or reproducing apparatus according to claim 5 wherein the incident light from said light source to said optical recording and/or reproducing medium is inclined relative to the direction of a normal line drawn to the planar surface of said optical recording and/or reproducing medium.

7. The optical recording and/or reproducing apparatus according to claim 5 wherein said layer of the electro-optical material exhibits ferroelectricity of changing the direction of polarization on application of a preset electrical field.

8. The optical recording and/or reproducing apparatus according to claim 5 wherein said voltage controlling means controls the output voltage of said voltage applying means so that the intensity of said harmonics associated with said intensity signal output from said detection means will be larger than a preset value.

9. (Amended) The optical recording and/or reproducing apparatus according to claim 1 wherein said optical recording and/or reproducing medium includes a plurality of said layers of the electro-optical material;
each layer of the electro-optical material being formed of a ferroelectric non-linear optical material generating optical harmonics on incidence thereon of the light of excitation and being of a thickness not larger than the coherence length (or coherent length) corresponding to phase inversion of the optical harmonics by the difference between the refractive index of the light of excitation and the refractive index of the optical harmonics;
said electrode layers of said optical recording and/or reproducing medium being arranged between the plural layers of the electro-optical material;
said voltage applying means applying an electrical field, alternately inverted in direction, to said layers of the electro-optical material of said optical recording and/or reproducing medium set on said stage.

10. The optical recording and/or reproducing apparatus according to claim 9 further comprising:
reference light generating means for generating the reference light interfering with said optical harmonics from the light illuminated from said light source;
light mixing means for mixing the optical harmonics generated from said optical recording and/or reproducing medium and the reference light to output interference light resulting from interference between said optical harmonics and the reference light; and
detection means for detecting the intensity of said interference light output from said mixing means.

11. The optical recording and/or reproducing apparatus according to claim 1 wherein
said optical recording and/or reproducing medium includes a plurality of said layers of the electro-optical material;
said layers of the electro-optical material having its refractive index changed on application of an electrical field;
said voltage applying means applying an electrical field to an optional one of the layers of the electro-optical material of said optical recording and/or reproducing medium as set on said stage;
said apparatus further comprising:
layer detection means for detecting the layer of the electro-optical material the refractive index of which has been changed by the application of the electrical field by said voltage applying means.

12. The optical recording and/or reproducing apparatus according to claim 11 wherein
the electrode layers of the optical recording and/or reproducing medium are arranged between adjacent ones of said plural layers of the electro-optical material and are of substantially equal refractive index as that of the layers of the electro-optical material at a wavelength of light illuminated from said light source.

13. The optical recording and/or reproducing apparatus according to claim 11 wherein
the electrode layers of the optical recording and/or reproducing medium are paired electrodes arranged between adjacent ones of said plural layers of the electro-optical material and are of substantially equal refractive index as that of the layers of the electro-optical material at a wavelength of light illuminated from said light source;
said apparatus further comprising:
an intermediate layer arranged between said paired electrodes and being of the refractive index substantially equal to the refractive index of the layers of the electro-optical material at a wavelength of the light illuminated from said light source.

14. The optical recording and/or reproducing apparatus according to claim 11 further comprising:
polarization means for polarizing the light incident on said optical recording and/or reproducing medium.

15. The optical recording and/or reproducing apparatus according to claim 14 wherein the optical recording and/or reproducing medium further includes a polarized light reflecting layer arranged between said layers of the electro-optical material for reflecting at least a portion of a preset polarized light component.

16. The optical recording and/or reproducing apparatus according to claim 11 further comprising:
light converging means arranged between said light source and the stage for converging the light radiated from said light source to an optional one of the layers of the electro-optical material.

17. The optical recording and/or reproducing apparatus according to claim 16 wherein the layer detection means includes converged position signal outputting means for outputting a converged position signal corresponding to a converged position along the layering direction of the light converged by said light converging means.

18. The optical recording and/or reproducing apparatus according to claim 16 wherein said optical recording and/or reproducing medium further includes a polarized light reflecting layer arranged between adjacent ones of the layers of the electro-optical material for reflecting at least a portion of the preset polarized light component, said polarized light reflecting layer having a plurality of areas having respective different reflectances;
said apparatus further comprising:
converged position detection means for detecting the in-plane converged position of the light converged on the optical recording and/or reproducing medium based on the difference in reflectance of said plural areas.

19. The optical recording and/or reproducing apparatus according to claim 11 wherein the electro-optical material of said layer of the electro-optical material is a non-linear optical material generating optical harmonics of light radiated from said light source and is also a ferroelectric material the direction of polarization of which is changed by the application of an electrical field.

20. The optical recording and/or reproducing apparatus according to claim 19 further comprising:
reproducing signal outputting means for outputting a reproducing signal which is based on the phase of the optical harmonics generated by the layer of the electro-optical material.

21. The optical recording and/or reproducing apparatus according to claim 20 further comprising:
reference light generating means for generating reference light that can interfere with the optical harmonics generated by said layer of the electro-optical material.

22. The optical recording and/or reproducing apparatus according to claim 1 wherein the optical recording and/or reproducing medium as set on said stage further includes a reference light generating layer arranged together with the layer of the electro-optical material within the depth of focus of light radiated from said light source, the light radiated from said light source falling on said reference light generating layer to generate reference light that can interfere with the optical harmonics generated from said layer of the electro-optical material.

23. The optical recording and/or reproducing apparatus according to claim 22 wherein, in the optical recording and/or reproducing medium, as set on said stage, said reference light generating layer is arranged adjacent to said layer of the electro-optical material.

24. The optical recording and/or reproducing apparatus according to claim 23 wherein, in the optical recording and/or reproducing medium, as set on said stage, the total thickness of said layer of the electro-optical material and the reference light generating layer along the direction of the travel of the light beam is not larger than the coherence length.

25. The optical recording and/or reproducing apparatus according to claim 23 wherein, in the optical recording and/or reproducing medium as set on said stage, the thickness of the layer of the electro-optical material along the direction of travel of the light beam and the thickness of the reference light generating layer along the same direction of travel of the light beam are each substantially equal to the coherence length.

26. The optical recording and/or reproducing apparatus according to claim 23 wherein said optical recording and/or reproducing medium as set on said stage further includes an intermediate layer having a refractive index substantially equal to the refractive index of one of the layer of the electro-optical material and said reference light generating layer at a wavelength of light illuminated between the layer of the electro-optical material and said reference light generating layer.

27. The optical recording and/or reproducing apparatus according to claim 1 wherein
said optical recording and/or reproducing medium set on said stage includes at least two layer sets, each comprised of said layer of the electro-optical material and said reference light generating layer, alternately layered together, and a plurality of cut-outs for exposing said electrode layers at end faces along the layering direction;
said apparatus further comprising:
movement means for causing movement of said stage together with said optical recording and/or reproducing medium; and
a plurality of electrode terminals mounted on said stage and configured for being electrically connected to said plural electrode layers exposed at end faces along the layering direction of said optical recording and/or reproducing medium as set on said stage;
said voltage applying means selectively applying the voltage to said plural electrode terminals.

28. The optical recording and/or reproducing apparatus according to claim 27 wherein
said voltage applying means includes a circuit unit provided on said stage, an external circuit unit, provided outside said stage, and transmission means for non-contact transmission of power from said external circuit unit to said stage circuit unit;
said external circuit unit including means for superposing a layer identification signal to the power to transmit the resulting signal to said stage circuit unit through said transmission means;
said stage circuit unit including means for generating a voltage applied to said electrodes of said optical recording and/or reproducing medium from the power transmitted in a non-contact fashion from said external circuit unit, means for separating said layer identification signal from the power transmitted in a non-contact fashion from said external circuit unit, and means for switching the electrode terminals applying said voltage based on the so separated layer identification signal.

29. (Amended) An optical recording and/or reproducing apparatus comprising:
a stage on which an optical recording and/or reproducing medium, including a plurality of layers of an electro-optical material in which the polarization can be changed in its direction and remnant on application of an electrical field and which generates optical harmonics on irradiation with light, is set;
a light source for illuminating light on said optical recording and/or reproducing medium as set on said stage;
electrical field applying means for applying an electrical field to an optional one of the layers of the electrochemical material of said optical recording and/or reproducing medium as set on said stage; and
layer detection means for detecting the layer of the electro-chemical material the refractive index of which has been changed on application of the electrical field by said electrical field applying means.

30. The optical recording and/or reproducing apparatus according to claim 29 wherein
said optical recording and/or reproducing medium includes electrode layers arranged between adjacent ones of said layers of the electro-chemical material and having a refractive index approximately equal to the refractive index of said layer of the electrochemical material at a wavelength of light radiated from said light source.

31. The optical recording and/or reproducing apparatus according to claim 29 wherein
said optical recording and/or reproducing medium includes a pair of electrode layers arranged between adjacent ones of said layers of the electro-chemical material and having a refractive index approximately equal to the refractive index of said layer of the electro-chemical material at a wavelength of light radiated from said light source; and
an intermediate layer arranged between said paired electrode layers and having a refractive index substantially equal to the refractive index of said optical recording and/or reproducing medium at a wavelength of the light transmitted from said light source.

32. The optical recording and/or reproducing apparatus according to claim 29 further comprising:
polarization means for polarizing the light incident on said optical recording and/or reproducing medium.

33. The optical recording and/or reproducing apparatus according to claim 29 wherein said optical recording and/or reproducing medium further includes a polarization reflecting layer arranged between the layers of the electrochemical material for reflecting at least a portion of a preset polarized light component.

34. The optical recording and/or reproducing apparatus according to claim 29 further comprising:
light converging means arranged between said light source and the stage for converging the light radiated from said light source to an optional one of the layers of the electro-chemical material of the optical recording and/or reproducing medium.

35. The optical recording and/or reproducing apparatus according to claim 34 wherein said layer detection means includes converged position signal outputting means for outputting a converged position signal associated with the converging position along the layering direction of the light converged by said light converging means.

36. The optical recording and/or reproducing apparatus according to claim 34 wherein said optical recording and/or reproducing medium further includes a polarized light reflecting layer arranged between said layers of the electrochemical material adapted for reflecting at least a portion of a preset polarized light component and which are provided with a plurality of areas having respective different reflectances;
said apparatus further comprising:
converging position detecting means for detecting the in-plane converging position of the light converged on said optical recording and/or reproducing medium based on the reflectance differential between said plural areas.

37. The optical recording and/or reproducing apparatus according to claim 29 wherein said electro-chemical material forming said layer of the electro-chemical material is a non-linear optical material generating secondary harmonics of light radiated from said light source and a ferroelectric material the direction of polarization of which is changed by application of an electrical field.

38. The optical recording and/or reproducing apparatus according to claim 37 further comprising:
reproducing signal outputting means for outputting reproducing signals which are based on the phase of secondary harmonics generated by said layer of the electro-chemical material.

39. The optical recording and/or reproducing apparatus according to claim 38 further comprising:
reference light generating means for generating reference light that can interfere with the secondary harmonics generated by said layer of the electro-chemical material.

40. An optical recording and/or reproducing apparatus comprising:
a medium holder for holding an optical recording and/or reproducing medium having a layered medium and a plurality of cut-outs, said layered medium including a plurality of layers of the optical recording and/or reproducing mediums and a plurality of electrodes for applying an electrical field to said layers of the optical recording and/or reproducing mediums, said cut-outs exposing said plural electrodes at an end face of said layered medium along the layering direction;
movement means for causing movement of said medium holder along with said optical recording and/or reproducing medium;
a plurality of electrode terminals provided to said medium holder and electrically connected to said plural electrodes exposed at the end face along the layering direction of said optical recording and/or reproducing medium as held by said medium holder; and
voltage applying means for selectively applying the voltage to said plural electrode terminals.

41. The optical recording and/or reproducing apparatus according to claim 40 wherein said voltage applying means includes a circuit unit provided to said medium holder, a circuit unit provided outside said medium holder, and transmission means for transmitting the power in a non-contact fashion from said external circuit unit to the medium holder circuit unit;
said external circuit unit including means for superposing a layer identification signal to the power to transmit the resulting signal to said medium holder circuit unit through said transmission means;
said medium holder circuit unit including means for generating voltage applied to said electrodes of said layered medium, from the power transmitted in a non-contact fashion from said external circuit unit, means for separating said layer identification signal from the power transmitted in the non-contact fashion from said external circuit unit, and means for switching the electrode terminals, to which the voltage is to be applied, based on the separated layer identification signal.

42. (Amended) An optical reproducing apparatus comprising:
a stage for setting thereon an optical recording and/or reproducing medium including a layer of an electro-optical material in which the polarization is changed in its direction and remnant on application of an electrical field and which generates optical harmonics on irradiation with light;
a light source for illuminating light on said optical recording and/or reproducing medium set on said stage; and
detection means for detecting the phase of optical harmonics generated from said optical recording and/or reproducing medium as set on said stage.

43. The optical reproducing apparatus according to claim 42 further comprising:
means for outputting the reference light, interfering with optical harmonics generated by said optical recording and/or reproducing medium, so that the reference light will be superposed on said optical harmonics;
said detection means detecting the intensity of the optical harmonics, on which said reference light has been superposed, for detecting the phase of said optical harmonics.

44. The optical reproducing apparatus according to claim 43 wherein the intensity of said reference light is substantially equal to the intensity of the optical harmonics generated from said optical recording and/or reproducing medium.

45. The optical reproducing apparatus according to claim 42 wherein said optical recording and/or reproducing medium includes a plurality of said layers of the optical recording and/or reproducing medium layered together.

46. The optical reproducing apparatus according to claim 42 wherein said optical recording and/or reproducing medium set on said stage further includes a reference light generating layer arranged together with said layer of the electro-optical material within the depth of focus of light radiated from said light source for generating reference light interfering with optical harmonics generated from said optical recording and/or reproducing medium on incidence thereon of light radiated from said layer of the electro-optical material.

47. The optical reproducing apparatus according to claim 46 wherein, in said optical recording and/or reproducing medium, set on said stage, said reference light generating layer is arranged in adjacency to said layer of the electro-optical material.

48. The optical reproducing apparatus according to claim 47 wherein, in said optical recording and/or reproducing medium, as set on said stage, the sum of the thicknesses of said layer of the electro-optical material and said reference light generating layer is not larger than the coherence length.

49. The optical reproducing apparatus according to claim 47 wherein, in said optical recording and/or reproducing medium, as set on said stage, the thicknesses of said layer of the electro-optical material and said reference light generating layer along the light beam traversing direction are each substantially equal to the coherence length.

50. (Amended) The optical reproducing apparatus according to claim 47 wherein said optical recording and/or reproducing medium as set on said stage further includes an intermediate layer between the layer of the electro-optical material and said reference light generating layer, said intermediate layer having a refractive index substantially equal to the refractive index of at least one of the layer of the electro-optical material and said reference light generating layer at a wavelength of the illuminated light.

51. (Deleted)

52. (Deleted)

53. (Deleted)

54. (Deleted)

55. (Amended) An optical recording and/or reproducing medium including a layer of an electro-optical material layered together on a plurality of layers in which polarization can be changed in its direction and remnant on application of an electrical field and which generates optical harmonics on irradiation with light,
wherein each layer of the electro-optical material is of a thickness not larger than the coherence length.

56. (Amended) The optical recording and/or reproducing medium according to claim 55 wherein the directions of polarization of the layers of the electro-optical material are alternately inverted along the layering direction of said layers of the electro-optical material.

57. (Deleted)

58. (Amended) The optical recording and/or reproducing medium according to claim 55 further comprising a plurality of layers of the electro-optical material;
each layer of the electro-optical material being a ferroelectric non-linear optical material generating optical harmonics on incidence thereon of the light of excitation, and being of a thickness not larger than the coherence length for which the phase of the optical harmonics is inverted due to the difference between the refractive index of said light of excitation and that of the optical harmonics;
said medium further comprising
a plurality of electrode layers arranged between said plural layers of the ferroelectric non-linear optical material.

59. The optical recording and/or reproducing medium according to claim 58 wherein the directions of polarization of the respective layers of the ferroelectric non-linear optical material are alternately inverted along the layering direction of said plural layers of the ferroelectric non-linear optical material.

60. The optical recording and/or reproducing medium according to claim 58 further comprising an electrical wiring for electrically interconnecting every two electrode layers.

61. The optical recording and/or reproducing medium according to claim 58 wherein a plurality of stacked medium layers, each comprising said layer of the electro-optical material and the electrode layers, are layered together.

62. (Deleted)

63. (Amended) The optical recording and/or reproducing medium according to claim 58 wherein said electrode layer has a refractive index substantially equal to that of the layer of the electro-optical material at a preset light wavelength.

64. (Amended) The optical recording and/or reproducing medium according to claim 58 further comprising:
a pair of electrode layers arranged between said plural layers of the electro-optical material and being of a refractive index substantially equal to the refractive index of said layer of the electro-optical material at a preset light wavelength; and
an intermediate layer arranged between said paired electrode layers and being of a light transmittance and a refractive index substantially equal to the refractive index of the layer of the electro-optical material at said preset light wavelength.

65. The optical recording and/or reproducing medium according to claim 58 further comprising a polarized light reflecting layer arranged between the layers of the electro-optical material and adapted for reflecting at least a portion of a preset polarized light component.

66. The optical recording and/or reproducing medium according to claim 65 wherein said polarized light reflecting layer has plural areas of different light reflectances.

67. (Amended) The optical recording and/or reproducing medium according to claim 55 further comprising a reference light generating layer arranged within the depth of focus of said illuminated light, together with said layer of the electro-optical material, and adapted for generating the reference light interfering with the optical harmonics generated on said light illumination from said layer of the electro-optical material.

68. The optical recording and/or reproducing medium according to claim 67 wherein said reference light generating layer is arranged adjacent to said layer of the electro-optical material.

69. The optical recording and/or reproducing medium according to claim 67 further comprising an electrode layer for applying the voltage to said layer of the electro-optical material.

70. The optical recording and/or reproducing medium according to claim 67 wherein the refractive index of the reference light generating layer with respect to the illuminated light is approximately equal to the refractive index of the layer of the electro-optical material with respect to said illuminated light.

71. The optical recording and/or reproducing medium according to claim 67 wherein the reference light generating layer and said layer of the electro-optical material are approximately equal in refractive index and different in material type.

72. The optical recording and/or reproducing medium according to claim 67 wherein the sum of the thicknesses of said layer of the electro-optical material and the reference light generating layer along the light beam traversing direction is not larger than the coherence length.

73. The optical recording and/or reproducing medium according to claim 67 wherein the thickness of said layer of the electro-optical material and that of the reference light generating layer along the light beam traversing direction are each approximately equal to the coherence length.

74. The optical recording and/or reproducing medium according to claim 67 wherein there are provided a plurality of stacked layers each including said layer of the electro-optical material and the reference light generating layer.

75. The optical recording and/or reproducing medium according to claim 74 further comprising an intermediate layer arranged between said stacked layers and having a refractive index approximately equal to the refractive index of at least one of the electro-optical material and the reference light generating layer at a wavelength of the illuminated light.

76. (Amended) The optical recording and/or reproducing medium according to claim 55 comprising at least two of layered sets each comprised of the electro-optical material and the reference light generating layer and a plurality of cut-outs for exposing said plural electrode layers at end faces along the layering direction.

77. An optical recording and/or reproducing medium comprising a layered medium made up by a plurality of layers of the optical recording and/or reproducing medium and a plurality of electrodes for applying an electrical field to said layer of the optical recording and/or reproducing medium, and a plurality of cut-outs for exposing said plural electrodes at end faces of said layered medium along the layering direction.

78. The optical recording and/or reproducing medium according to claim 77 wherein said plural electrodes for applying an electrical field to said layer of the optical recording and/or reproducing medium are plural electrode layers arranged on both sides of said layer of the optical recording and/or reproducing medium.

79. The optical recording and/or reproducing medium according to claim 77 wherein said layer of the optical recording and/or reproducing medium is formed of an electro-chemical material having its refractive index changed on application of an electrical field.

80. An optical recording and/or reproducing method comprising:
a step of illuminating light on a layer of an electro-chemical material, in which the polarization can be changed in its direction and remnant on application of an electrical field and which generates optical harmonics on illumination of light, as an electrical field is applied to said layer of the electro-chemical material; and
a step of illuminating light on the layer of the electro-optical material to detect the phase of optical harmonics generated from the layer of the electro-optical material.

81. The optical recording and/or reproducing method according to claim 80 wherein said detection step outputs the reference light interfering with light radiated from said optical recording and/or reproducing medium so that the output reference light will be superposed on said optical harmonics, and detects the intensity of the superposed optical harmonics to detect the phase of said optical harmonics.

82. The optical recording and/or reproducing method according to claim 81 wherein the intensity of the reference light is approximately equal to the intensity of the optical harmonics generated from said optical recording and/or reproducing medium.

83. The optical recording and/or reproducing method according to claim 81 wherein said illuminating step illuminates the light as voltage is applied to said layer of the electro-optical material through electrode layers arranged on the front and back sides of said layer of the electro-optical material.

84. An optical recording and/or reproducing method comprising:
an illuminating step of illuminating light on a layer of an electro-optical material, which generates harmonics on illumination of light and which has its refractive index changed by application of an electrical field, as an electrical field is applied to said layer of the electro-optical material;
a detecting step of detecting harmonics generated from said layer of the electro-optical material, by light illumination at said illuminating step to obtain an intensity signal corresponding to the intensity of said harmonics; and
a controlling step of controlling the electrical field applied to said layer of the electro-optical material based on said intensity signal obtained at said detection step.

85. A method for optical recording comprising:
locally heating a plurality of layers of a ferroelectric non-linear optical material, in which the directions of polarization are changed on application of an electrical field and in which optical harmonics are generated on incidence thereon of the light of excitation, each layer being of a thickness not larger than the coherence length corresponding to phase inversion of said optical harmonics by the refractive index differential between said light of excitation and said optical harmonics, under application of an electrical field alternately reversed in direction to said layers.

86. An optical reproducing method comprising:
a step of setting, on a stage, a layer of an electro-optical material in which the polarization can be changed in direction and remnant on application of an electrical field and which generates harmonics on illumination of light; and
a step of illuminating light on the layer of the electro-optical material set on said stage to detect the phase of optical harmonics generated from the layer of the electro-optical material.

87. An optical layer detection method comprising applying an electrical field to one of a plurality of layers of an electro-optical material, the refractive index of which is changed on application of an electrical field, and detecting the layer of the electro-optical material the refractive index of which has been changed.
